(19) United States
(12) Patent Application Publication
(10) Pub. No.: US 2016/0357578 A1
(43) Pub. Date: Dec. 8, 2016

(54) METHOD AND DEVICE FOR PROVIDING MAKEUP MIRROR

(71) Applicant: Samsung Electronics Co., Ltd., Suwon-si (KR)

(72) Inventors: Ji-yun KIM, Suwon-si (KR); Joo-young SON, Yongin-si (KR); Tae-hwa HONG, Seoul (KR)

(21) Appl. No.: 15/169,005

(22) Filed: May 31, 2016

(30) Foreign Application Priority Data
Jun. 3, 2015 (KR) 10-2015-0078776
Sep. 9, 2015 (KR) 10-2015-0127710

(51) Int. Cl. G06F 9/44; G06T 11/00; H04N 5/225; G06T 3/40; G06T 7/00; G06F 3/0484; G06F 3/0482; G06F 3/01

(52) U.S. Cl. CPC G06F 9/4446; G06F 3/0482; G06T 11/001; G06F 3/012; G06T 3/40; G06T 7/0002; G06T 7/0022; G06F 3/04842; H04N 5/225; G06T 2207/30201

(57) ABSTRACT

A makeup guide information that matches facial features of a user and a device thereof are provided. The device includes a display and a controller configured to display a face image of a user in real-time, and execute a makeup mirror so as to display the makeup guide information on the face image of the user, according to a makeup guide request.

### CROSS-REFERENCE TO RELATED APPLICATION(S)

This application claims the benefit under 35 U.S.C. §119(a) of a Korean patent application filed on Jun. 3, 2015 in the Korean Intellectual Property Office and assigned Serial number 10-2015-0078776, and of a Korean patent application filed on Sep. 9, 2015 in the Korean Intellectual Property Office and assigned Serial number 10-2015-0127710, the entire disclosure of each of which is hereby incorporated by reference.

### TECHNICAL FIELD

The present disclosure relates to methods and devices for providing a makeup mirror. More particularly, the present disclosure relates to a method and device for providing a makeup mirror so as to provide information related to makeup and/or information related to skin based on a face image of a user.

### BACKGROUND

Applying makeup is an artistic act of compensating for inferior features of a face and emphasizing superior features of the face. For example, smoky makeup may make small eyes look big. Eye shadow makeup for a single eyelid may highlight Asian eyes. Concealer makeup may cover facial blemishes or dark circles.

In this manner, a variety of styles may be expressed according to which type of makeup is applied to a face, and thus, various makeup guide information may be provided. For example, the various makeup guide information may include makeup guide information for a vivacious look, and seasonal makeup guide information.

However, a person who refers to a plurality of pieces of currently-provided makeup guide information has to determine his/her own facial features. Therefore, it may be difficult for the person to use makeup guide information that matches with his/her own facial features.

In addition, it may be difficult for the person to check his/her makeup history information or information about his/her skin condition a change in skin condition).

Therefore, a need exists for a technique to effectively provide makeup guide information that matches facial features of each person, makeup history information, and/or information about skin condition of each person.

### SUMMARY

Aspects of the present disclosure are to address at least the above-mentioned problems and/or disadvantages and to provide at least the advantages described below. Accordingly, an aspect of the present disclosure is to provide makeup guide information that matches facial features of a user

Another aspect of the present disclosure is to provide makeup guide information for a user, based on a face image of the user.

Another aspect of the present disclosure is to provide information before and after a user applies makeup, based on a face image of the user.

Another aspect of the present disclosure is to make post-makeup care of a user effective, based on a face image of the user.

Another aspect of the present disclosure is to provide makeup history information of a user, based on a face image of the user.

Another aspect of the present disclosure is to provide information about a change in skin condition of a user, based on a face image of the user.

Another aspect of the present disclosure is to effectively display blemishes on a face image of a user.

Another aspect of the present disclosure is to perform skin-condition analysis, based on a face image of the user.

In accordance with an aspect of the present disclosure, a device providing a makeup mirror is provided. The device includes a display configured to display a face image of a user and a controller configured to display the face image of the user in real-time, and execute the makeup mirror so as to display makeup guide information on the face image of the user, according to a makeup guide request.

The display is further configured to display a plurality of virtual makeup images, the device further comprises a user input unit configured to receive a user input for selecting one of the plurality of virtual makeup images, and the controller is further configured to display makeup guide information based on the selected virtual makeup image on the face image of the user, according to the user input.

The plurality of virtual makeup images comprise at least one of color-based virtual makeup images and theme-based virtual makeup images.

The display is further configured to display a plurality of pieces of theme information, the device further comprises a user input unit configured to receive a user input for selecting one of the plurality of pieces of theme information, and the controller is further configured to display makeup guide information based on the selected theme information on the face image of the user, according to the user input.

The display is further configured to display bilateral-symmetry makeup guide information on the face image of the user, and the controller is further configured to: delete, when application of makeup to one side of a face of the user is started, makeup guide information displayed on the other side in the face image of the user, detect, when the application of the makeup to the one side of the face of the user is completed, a makeup result with respect to the one side of the face of the user, and display makeup guide information based on the makeup result on the other side in the face image of the user.

The device further comprises a user input unit configured to receive a user input of the makeup guide request, the controller is further configured to display, on the face image of the user, makeup guide information comprising makeup step information, according to the user input.

The device further comprises a user input unit configured to receive a user input for selecting the makeup guide information, the controller is further configured to display, on the display, detailed makeup guide information of the makeup guide information selected according to the user input.

The controller is further configured to detect an area of interest from the face image of the user, and automatically magnify the area of interest and display the magnified area of interest on the display.

The controller is further configured to detect a cover-target area from the face image of the user, and display makeup guide information for the cover-target area on the face image of the user.

The controller is further configured to detect an illuminance value, and display, when the illuminance value is determined to be low illuminance, edge areas of the display, as a white level.

The device further comprises a user input unit configured to receive a comparison image request requesting comparison between a before-makeup face image of the user and a current face image of the user, wherein the controller is further configured to display the before-makeup face image of the user and the current face image of the user in a comparison form on the display, according to the comparison image request.

The device further comprises a user input unit configured to receive a comparison image request requesting comparison between a virtual-makeup face image of the user and a current face image of the user, the controller is further configured to display the virtual-makeup face image of the user and the current face image of the user in a comparison form on the display, according to the comparison image request.

The device further comprises a user input unit configured to receive a user input of a makeup history information request, the controller is further configured to display, on the display, makeup history information based on the face image of the user, according to the user input.

The device further comprises a user input unit configured to receive a user input of a skin condition care information request, the controller is further configured to display, on the display, skin condition analysis information with respect to the user during a particular period based on the face image of the user, according to the user input.

The device further comprises a user input unit configured to receive a user input of a skin analysis request, the controller is further configured to analyze skin based on a current face image of the user, according to the user input, compare a skin analysis result based on a before-makeup face image of the user with a skin analysis result based on the current face image of the user, and display a result of the comparison on the display.

The controller is further configured to perform facial feature matching processing and/or pixel-unit matching processing on a plurality of face images of the user which are to be displayed on the display.

The device further comprises a camera configured to capture the face image of the user, the controller is further configured to periodically obtain a face image of the user by using the camera, check a makeup state with respect to the obtained face image of the user, and provide notification to the user via the display when the controller determines that the notification is required as a result of the checking.

The controller is further configured to: detect a makeup area from the face image of the user, and display, on the display, makeup guide information and makeup product information which are about the makeup area, based on the face image of the user.

The device further comprises a user input unit configured to receive a user input for selecting a makeup tool, the controller is further configured to: determine the makeup tool, according to the user input, and display, on the face image of the user, makeup guide information based on the makeup tool.

The device further comprises a camera configured to capture the face image of the user, the controller is further configured to: detect movement of a face of the user in a left direction or a right direction, based on the face image of the user which is obtained by using the camera, obtain, when the movement of the face of the user in the left direction or the right direction is detected, a profile face image of the user, and display the profile face image of the user on the display.

The device further comprises a user input unit configured to receive a user input with respect to a makeup product of the user, the controller is further configured to: register information about the makeup product, according to the user input, and display, on the face image of the user, the makeup guide information based on the registered information about the makeup product of the user.

The device further comprises a camera configured to capture a face image of the user in real-time, the controller is further configured to: detect, when the makeup guide information is displayed on the face image of the user which is obtained by using the camera, movement information from the obtained face image of the user, and change the displayed makeup guide information, according to the movement information.

The device further comprises a user input unit configured to receive a user input indicating a blemish detection level or a beauty face level, when the user input indicates the blemish detection level, the controller is further configured to emphasize and display, by controlling the display, blemishes detected from the face image of the user according to the blemish detection level, and when the user input indicates the beauty face level, the controller is further configured to blur and display, by controlling the display, the blemishes detected from the face image of the user according to the beauty face level.

The controller is further configured to: obtain a plurality of blur images with respect to the face image of the user, obtain a difference value with respect to a difference between the plurality of blur images, and detect the blemishes from the face image of the user by comparing the difference value with a threshold value, the threshold value is a pixel-unit threshold value corresponding to the blemish detection level or the beauty face level.

The device further comprises a user input unit configured to receive a user input of a request for skin analysis with respect to an area of the face image of the user, the controller is further configured to analyze a skin condition of the area, according to the user input, and display a result of the analysis on the face image of the user.

The display is further configured to be controlled by the controller so as to display a skin analysis window on the area, and wherein the controller is further configured to: control the display to display the skin analysis window on the area, according to the user input, analyze the skin condition of the area comprised in the skin analysis window, and display the result of the analysis on the skin analysis window.

The the skin analysis window comprises a magnification window.

The user input unit is further configured to receive: a user input instructing to magnify a size of the skin analysis window, a user input instructing to reduce the size of the skin analysis window, or a user input instructing to move a display position of the skin analysis window to another position, and according to the user input, the controller is further configured to: magnify the size of the skin analysis window displayed on the display, reduce the size of the skin analysis window, or move the display position of the skin analysis window to the other position.

The user input unit comprises a touch-based input for specifying the area of the face image of the user.

In accordance with another aspect of the present disclosure, a method, performed by a device, of providing a makeup mirror is provided. The method includes displaying in real-time a face image of a user on a display, receiving a user input for requesting a makeup guide, and displaying makeup guide information on the face image of the user, according to the user input.

In accordance with another aspect of the present disclosure, a non-transitory computer-readable recording medium is provided. The non-transitory computer-readable recording medium has recorded thereon a program which, when executed by a computer, performs the method of the second aspect of the present disclosure.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIGS. 1A and 1B illustrate a makeup mirror of a device, which displays makeup guide information on a face image of a user according to various embodiments of the present disclosure;

FIG. 2 illustrates an eyebrow makeup guide information table based on a face shape according to various embodiments of the present disclosure;

FIG. 3 is a flowchart of a method of providing a makeup mirror for displaying makeup guide information on a face image of a user, the method being performed by the device according to various embodiments of the present disclosure;

FIG. 4 illustrates a makeup mirror of a device, which displays makeup guide information including a plurality of pieces of makeup step information according to various embodiments of the present disclosure;

FIGS. 5A to 5C illustrate a makeup mirror of a device, which provides detailed eyebrow makeup guide information in a form of an image according to various embodiments of the present disclosure;

FIGS. 6A to 6C illustrate a makeup mirror of a device, which displays makeup guide information based on a face image of a user after left eyebrow makeup of the user has been completed according to various embodiments of the present disclosure;

FIGS. 7A and 7B illustrate a makeup mirror of a device, which edits detailed eyebrow makeup guide information according to various embodiments of the present disclosure;

FIG. 8 illustrates a makeup mirror that provides text-type detailed eyebrow makeup guide information provided by device according to various embodiments of the present disclosure;

FIGS. 9A to 9E illustrate a makeup mirror of a device, which changes makeup guide information according to a makeup progress according to various embodiments of the present disclosure;

FIGS. 10A and 10B illustrate a makeup mirror of a device, which changes makeup steps according to various embodiments of the present disclosure;

FIG. 10C illustrates a makeup mirror of a device, which displays makeup guide information on a face image of a user received from another device according to various embodiments of the present disclosure;

FIG. 11 is a flowchart of a method of providing a makeup mirror for providing makeup guide information by recommending a plurality of virtual makeup images based on a face image of a user, the method being performed by the device according to various embodiments of the present disclosure;

FIGS. 12A and 12B illustrate a makeup mirror of a device, which recommends a plurality of virtual makeup images based on colours according to various embodiments of the present disclosure;

FIGS. 13A and 13B illustrate a makeup mirror of a device, which provides a color-based virtual makeup image based on menu information according to various embodiments of the present disclosure;

FIGS. 14A and 14B illustrate a makeup mirror of a device, which provides four color-based virtual makeup images in a split-screen form according to various embodiments of the present disclosure;

FIGS. 15A and 15B illustrate a makeup minor of a device, which provides information about a theme-based virtual makeup image type according to various embodiments of the present disclosure;

FIGS. 16A and 16B illustrate a makeup minor of a device, which provides a plurality of theme-based virtual makeup image types according to various embodiments of the present disclosure;

FIGS. 17A and 17B illustrate a makeup minor of a device, which provides text-type information about a theme-based virtual makeup image type according to various embodiments of the present disclosure;

FIG. 18 illustrates a makeup mirror of a device, provides a plurality of pieces of information about theme-based virtual makeup image types according to various embodiments of the present disclosure;

FIGS. 19A and 19B illustrate a makeup mirror of a device, which provides information about a selected theme-based virtual makeup image type according to various embodiments of the present disclosure;

FIG. 20 is a flowchart of a method of providing a makeup mirror that displays makeup guide information on a face image of a user based on a facial feature of the user and environment information, the method being performed by the device according to various embodiments of the present disclosure;

FIGS. 21A to 21C illustrate a makeup mirror of a device, which provides makeup guide information based on a color-based makeup image according to various embodiments of the present disclosure;

FIGS. 22A to 22C illustrate a makeup mirror of a device, which provides makeup guide information based on a theme-based virtual makeup image according to various embodiments of the present disclosure;

FIG. 23 is a flowchart of a method of providing a makeup mirror that displays makeup guide information on a face image of a user based on a facial feature of the user and user information, the method being performed by the device according to various embodiments of the present disclosure;

FIGS. 24A to 24C illustrate a makeup mirror of a device, which provides a theme-based virtual makeup image according to various embodiments of the present disclosure;

FIG. 25 is a flowchart of a method of providing a makeup mirror that displays makeup guide information on a face image of a user based on a facial feature of the user, environment information, and user information, the method being performed by the device according to various embodiments of the present disclosure;

FIG. 26 is a flowchart of a method of providing a makeup mirror that displays theme-based makeup guide information, the method being performed by the device according to various embodiments of the present disclosure;

FIGS. 27A and 27B illustrate a makeup mirror of a device, which provides makeup guide information based on selected theme information according to various embodiments of the present disclosure;

FIGS. 28A and 28B illustrate a makeup mirror of a device, which provides theme information based on a theme tray according to various embodiments of the present disclosure;

FIG. 29 is a flowchart of a method of providing a makeup mirror that displays makeup guide information based on a theme-based virtual makeup image, the method being performed by the device according to various embodiments of the present disclosure;

FIG. 30 is a flowchart of a method of providing a makeup mirror that displays bilateral-symmetry makeup guide information with respect to a face image of a user, the method being performed by the device according to various embodiments of the present disclosure;

FIGS. 31A to 31C illustrate a makeup mirror of a device, which displays a plurality of pieces of bilateral-symmetry makeup guide information based on a bilateral symmetry reference line according to various embodiments of the present disclosure;

FIG. 32 is a flowchart of a method of providing a makeup mirror that detects an area of interest from a face image of the user and magnifies the area of interest, the method being performed by the device according to various embodiments of the present disclosure;

FIGS. 33A and 33B illustrate a makeup mirror of a device, which magnifies an area of interest from a face image of a user according to various embodiments of the present disclosure;

FIGS. 33C and 33D illustrate a makeup mirror of a device, which magnifies an area of interest from a face image of a user according to various embodiments of the present disclosure;

FIG. 34 is a flowchart of a method of providing a makeup mirror that displays makeup guide information with respect to a cover-target area of a face image of a user, the method being performed by the device according to various embodiments of the present disclosure;

FIGS. 35A and 35B illustrate a makeup mirror of a device, which displays makeup guide information for a cover-target area on a face image of a user according to various embodiments of the present disclosure;

FIGS. 36A and 36B illustrate a makeup mirror of a device, which displays a makeup result based on detailed makeup guide information for a cover-target area on a face image of a user according to various embodiments of the present disclosure;

FIG. 37 is a flowchart of a method of providing a makeup mirror for compensating for a low illuminance environment, the method being performed by the device according to various embodiments of the present disclosure;

FIGS. 38A and 38B illustrate a makeup mirror of a device, which displays, as a white level, edge areas of a display according to various embodiments of the present disclosure;

FIGS. 39A to 39H illustrate a makeup mirror of a device, which adjusts a white level display area on edge areas of a display according to various embodiments of the present disclosure;

FIG. 40 is a flowchart of a method of providing a makeup mirror for displaying a comparison between a before-makeup face image of a user and a current face image of the user, the method being performed by the device according to various embodiments of the present disclosure;

FIGS. 41A to 41E illustrate a makeup mirror of a device, which displays a comparison between a before-makeup face image of a user and a current face image of the user according to various embodiments of the present disclosure;

FIG. 42 is a flowchart of a method of providing a makeup mirror for displaying a comparison between a current face image of a user and a virtual makeup image, the method being performed by the device according to various embodiments of the present disclosure;

FIG. 43 illustrates a makeup mirror of a device, which displays a comparison between a current face image of a user and a virtual makeup image according to various embodiments of the present disclosure;

FIG. 44 is a flowchart of a method of providing a makeup mirror for providing a skin analysis result, the method being performed by the device according to various embodiments of the present disclosure;

FIGS. 45A and 45B illustrate skin comparison analysis result information displayed by a device according to various embodiments of the present disclosure;

FIG. 46 is a flowchart of a method of providing a makeup mirror for managing a makeup state of a user while the user is unaware of the management, the method being performed by the device according to various embodiments of the present disclosure;

FIGS. 47A to 47D illustrate a makeup minor of a device, which checks a makeup state of a user while the user is unaware of the checking, and provides makeup guide information according to various embodiments of the present disclosure;

FIG. 48A is a flowchart of a method of providing a makeup mirror that provides makeup history information of a user, the method being performed by a device according to various embodiments of the present disclosure;

FIG. 48B is a flowchart of a method of providing a makeup mirror that provides other makeup history information of a user, the method being performed by a device according to various embodiments of the present disclosure;

FIGS. 48C to 48E illustrate a makeup mirror of a device, which provides makeup history information of a user according to various embodiments of the present disclosure;

FIG. 49 is a flowchart of a method of providing a makeup mirror that provides makeup guide information and product information, based on a makeup area of a user, the method being performed by the device according to various embodiments of the present disclosure;

FIG. 50 illustrates a makeup mirror of a device, which provides a plurality of pieces of makeup guide information and makeup product information which are about a makeup area according to various embodiments of the present disclosure;

FIG. 51 is a flowchart of a method of providing a makeup mirror that provides makeup guide information according to determination of a makeup tool, the method being performed by the device according to various embodiments of the present disclosure;

FIGS. 52A and 52B illustrate a makeup mirror of a device, which provides makeup guide information according to determination of a makeup tool according to various embodiments of the present disclosure;

FIG. 53 is a flowchart of a method of providing a makeup mirror that provides a profile face image of a user which the user cannot see, the method being performed by the device according to various embodiments of the present disclosure;

FIGS. 54A and 54B illustrate a makeup mirror of a device, which provides a profile face image of a user which the user cannot see according to various embodiments of the present disclosure;

FIG. 55 is a flowchart of a method of providing a makeup mirror that provides a rear-view image of a user, the method being performed by the device according to various embodiments of the present disclosure;

FIGS. 56A and 56B illustrate a makeup mirror of a device, which provides a rear-view image of a user according to various embodiments of the present disclosure;

FIG. 57 is a flowchart of a method of providing a makeup mirror that provides makeup guide information based on a makeup product registered by a user, the method being performed by the device according to various embodiments of the present disclosure;

FIGS. 58A to 58C illustrate a makeup mirror of a device, which provides a process of registering user makeup product information according to various embodiments of the present disclosure;

FIG. 59 is a flowchart of a method of providing a makeup mirror that provides user skin condition care information, the method being performed by the device according to various embodiments of the present disclosure;

FIGS. 60A to 60E illustrate a makeup mirror of a device, which provides a plurality of pieces of user skin condition care information according to various embodiments of the present disclosure;

FIG. 61 is a flowchart of a method of providing a makeup mirror that changes makeup guide information according to movement in an obtained face image of a user, the method being performed by the device, according to various embodiments of the present disclosure;

FIG. 62 illustrates a makeup mirror of a device, which changes makeup guide information according to movement information detected from a face image of a user according to various embodiments of the present disclosure;

FIG. 63 is a flowchart of a method of providing a makeup mirror that displays blemishes on a face image of a user according to a user input according to various embodiments of the present disclosure;

FIG. 64 illustrates a makeup mirror corresponding to a blemish detection level and a beauty face level set in a device according to various embodiments of the present disclosure;

FIGS. 65A to 65D illustrate a device expressing a blemish detection level and/or a beauty face level according to various embodiments of the present disclosure;

FIG. 66 is a flowchart of a method of detecting blemishes, the method being performed by a device according to various embodiments of the present disclosure;

FIG. 67 illustrates a relation by which a device detects blemishes based on a difference between a face image of a user and a blur image according to various embodiments of the present disclosure;

FIG. 68 is a flowchart of a device providing a skin analysis result with respect to an area of a face image of a user according to various embodiments of the present disclosure;

FIGS. 69A to 69D illustrate a makeup mirror of a device, which displays a magnification window according to various embodiments of the present disclosure;

FIG. 70 illustrates a makeup mirror of a device, which displays a skin analysis target area according to various embodiments of the present disclosure;

FIG. 71 illustrates a software configuration of a makeup mirror application according to embodiments of the present disclosure;

FIG. 72 illustrates a configuration of a system including a device according to various embodiments of the present disclosure; and

FIGS. 73 and 74 illustrate a block diagram of a device according to various embodiments of the present disclosure.

Throughout the drawings, like reference numerals will be understood to refer to like parts, components, and structures,

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Throughout the specification, it will also be understood that when an element is referred to as being “connected to” or “coupled with” another element, it can be directly connected to or coupled with the other element, or it can be electrically connected to or coupled with the other element by having an intervening element interposed therebetween. In addition, when a part “includes” or “comprises” an element, unless there is a particular description contrary thereto, the part can further include other elements, not excluding the other elements.

In the present disclosure, a makeup mirror indicates a user interface (UI) capable of providing various makeup guide information based on a face image of a user. In the present disclosure, the makeup mirror indicates the UI capable of providing makeup history information based on the face image of the user. In the present disclosure, the makeup mirror indicates the capable of providing information about a skin condition of the user (e.g., a change in the skin condition), based on the face image of the user. Since the makeup mirror provides the aforementioned various types of information, the makeup mirror of the present disclosure may be called a smart makeup mirror.

In the present disclosure, the makeup mirror may display the face image of the user. In the present disclosure, the makeup mirror may be provided by using an entire screen or a portion of a screen of a display included in a device.

In the present disclosure, the makeup guide information may be displayed on the face image of the user before the user applies makeup to his/her face, in the middle of the makeup, or after the makeup. In the present disclosure, the makeup guide information may be displayed near the face image of the user. In the present disclosure, the makeup guide information may be changed according to a progress of the makeup on the user. In the present disclosure, the makeup guide information may be provided so that the user can make up while the user views the makeup guide information displayed on the face image of the user.

In the present disclosure, the makeup guide information may include information indicating a makeup area. In the present disclosure, the makeup guide information may include information indicating makeup steps. In the present disclosure, the makeup guide information may include information about makeup tools (e.g., a sponge, a pencil, an eyebrow brush, an eye shadow brush, an eyeliner brush, a lip brush, a powder brush, a puff, a cosmetic knife, cosmetic scissors, or an eyelash curler).

In the present disclosure, the makeup guide information may include information that is different from each other with respect to a same makeup area according to a makeup tool. For example, eye-makeup guide information according to an eye shadow brush may be different from eye-makeup guide information according to a tip brush.

In the present disclosure, according to changing the face image of the user which is obtained in real-time, a display form of the makeup guide information may be changed.

In the present disclosure, the makeup guide information may be provided in the form of at least one of an image, a text, and audio. In the present disclosure, the makeup guide information may be displayed in a menu form. In the present disclosure, the makeup guide information may include information indicating a makeup direction (e.g., a direction of cheek blushing, a touch direction of an eye shadow brush, and the like).

In the present disclosure, user skin analysis information may include information about a change in a skin condition of the user. In the present disclosure, the information about the change in the skin condition of the user may be referred to as user skin history information. In the present disclosure, the user skin analysis information may include information about blemishes. In the present disclosure, the user skin analysis information may include information obtained by analyzing a skin condition of an area of the face image of the user.

In the present disclosure, information related to makeup may include the makeup guide information and/or the makeup history information. In the present disclosure, information related to a skin may include the skin analysis information and/or the information about the change in the skin condition.

As used herein, the term “and/or” includes any and all combinations of one or more of the associated listed items. Expressions, such as “at least one of,” when preceding a list of elements, modify the entire list of elements and do not modify the individual elements of the list.

Hereinafter, the present disclosure will now be described with reference to the accompanying drawings.

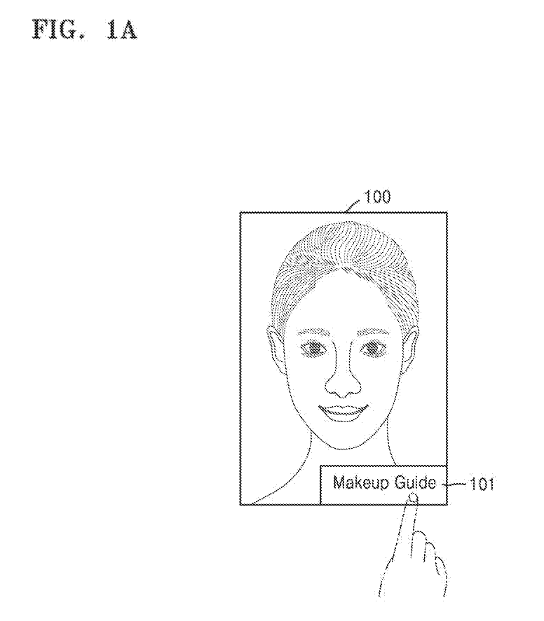

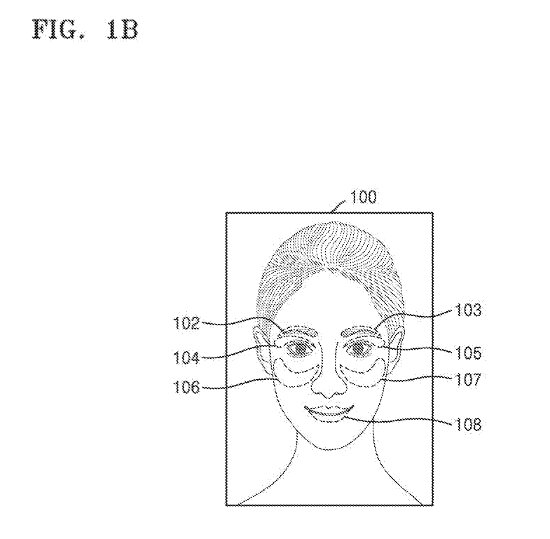

FIGS. 1A and 1B illustrate a makeup mirror according to various embodiments of the present disclosure.

Referring to FIG. 1A, the makeup mirror of a device 100 shown in FIG. 1A displays a face image of a user. The makeup mirror of the device 100 shown in FIG. 1B displays the face image of the user and makeup guide information.

Referring to FIG. 1A, the device 100 may display the face image of the user. The face image of the user may be obtained in real-time by using a camera included in the device 100 but is not limited thereto. For example, the face image of the user may be obtained by using a digital camera connected to the device 100, a wearable device (e.g., a smart watch), a smart mirror, an internee of things (IoT) network-based device (hereinafter, an IoT device), and the like. The wearable device, the smart mirror, and the IoT device may have a camera function and a communication function.

Referring to FIG. 1A, the device 100 may provide both a makeup guide button 101 and the face image of the user. When a user input for selecting the makeup guide button 101 is received, as illustrated in FIG. 1B, the device 100 may display a plurality of pieces of makeup guide information 102 through 108 on the displayed face image of the user. Accordingly, the user may view makeup guide information based on the face image of the user. The makeup guide button 101 may correspond to a UI that may receive a user input for requesting the plurality of pieces of makeup guide information 102 through 108. Throughout the specification, the plurality of pieces of makeup guide information 102 through 108 may include two pieces of eyebrow makeup guide information 102 and 103, two pieces of eye makeup guide information 104 and 105, two pieces of cheek makeup guide information 106 and 107, and lips makeup guide information 108, and may be collectively referred to as the makeup guide information 102 through 108.

The device 100 may display the makeup guide information 102 through 108 on the face image of the user, based on a voice signal of the user. The device 100 may receive the voice signal of the user by using a voice recognition function.

The device 100 may display the makeup guide information 102 through 108 on the face image of the user, based on a user input with respect to an object area or a background area in FIG. 1A. In FIG. 1A, the object area may include an area where the face image of the user is displayed. In FIG. 1A, the background area may include areas except for the face image of the user. The user input may include a touch-based user input. The touch-based user input may include a user input generated by long-touching one point and then dragging the point toward at least one direction (e.g., a straight direction, a clamp-shape direction, a zigzag direction, and the like) but is not limited thereto.

When the makeup guide information 102 through 108 is displayed based on the voice signal of the user or the touch-based user input, in FIG. 1A, the device 100 may not display the makeup guide button 101.

In a case where the makeup guide button 101 is displayed and the voice signal of the user or the touch-based user input is receivable, when the voice signal of the user or the touch-based user input is received, the device 100 may highlight the displayed makeup guide button 101 in FIG. 1A. Accordingly, the user may know that the device 100 has received a users request with respect to the makeup guide information 102 through 108.

Referring to FIG. 1B, the makeup guide information 102 through 108 may indicate makeup areas based on the face image of the user. In FIG. 1B, the makeup areas may correspond to makeup products application-target areas. The makeup products application-target areas may include makeup modification areas.

Referring to FIG. 1B, the makeup guide information 102 through 108 may be provided based on information about the face image of the user and reference makeup guide information, and are not limited thereto.

For example, the makeup guide information 102 through 108 shown in FIG. 1B may be provided based on the information about the face image of the user and preset condition information. For example, the preset condition information may include condition information based on IF statement.

The reference makeup guide information may be based on a reference face image. For example, the reference face image may include a face image that is not related to the face image of the user. For example, the reference face image may be an oval-shape face image, but in the present disclosure, the reference face image is not limited thereto.

For example, the reference face image may be an inverted triangle-shape face image, a square-shape face image, or a round-shape face image. The reference face image may be set as a default in the device 100. The reference face image that is set as the default in the device 100 may be changed by the user. In the present disclosure, the reference face image may be expressed as an illustration image.

As illustrated in FIG. 1B, when the makeup guide information 102 through 108 about eyebrows, eyes, cheeks, and lips are provided, the reference makeup guide information may include, but is not limited to, reference makeup guide information about eyebrows, eyes, cheeks, and lips included in the reference face image.

For example, in the present disclosure, the reference makeup guide information may include makeup guide information about a nose included in the reference face image. In the present disclosure, the reference makeup guide information may include makeup guide information about a jaw included in the reference face image. In the present disclosure, the reference makeup guide information may include makeup guide information about a forehead included in the reference face image.

The reference makeup guide information about eyebrows, eyes, cheeks, and lips may indicate a reference makeup area about each of the eyebrows, the eyes, the cheeks, and the lips included in the reference face image. The reference makeup area indicates a reference area to which a makeup product is to be applied. The reference makeup guide information about eyebrows, eyes, cheeks, and lips may be expressed in the form of two-dimensional (2D) coordinates information. The reference makeup guide information about eyebrows, eyes, cheeks, and lips may correspond to reference makeup guide parameters about the eyebrows, the eyes, the cheeks, and the lips included in the reference face image.

The reference makeup guide information about eyebrows, eyes, cheeks, and lips may be determined, based on 2D-coordinates information about a face shape of the reference face image, 2D-coordinates information about a shape of the eyebrows included in the reference face image, 2D-coordinates information about a shape of the eyes included in the reference face image, 2D-coordinates information about a shape of the cheeks (or a shape of cheekbones) included in the reference face image, and/or 2D-coordinates information about a shape of the lips included in the reference face image. In the present disclosure, the reference makeup guide information about eyebrows, eyes, cheeks, and lips is not limited to the aforementioned descriptions.

In the present disclosure, the reference makeup guide information may be provided from an external device connected with the device 100. For example, the external device may include a server that provides a makeup guide service. However, in the present disclosure, the external device is not limited to the aforementioned descriptions.

When the face image of the user is displayed, the device 100 may detect information about the displayed face image of the user by using a face recognition algorithm.

As illustrated in FIG. 1B, when the makeup guide information 102 through 108 about eyebrows, eyes, cheeks, and lips are provided, the information about the face image of the user which is detected by the device 100 may include 2D-coordinates information about a face shape of the user, 2D-coordinates information about a shape of eyebrows included in the face image of the user, 2D-coordinates information about a shape of eyes of the user, 2D-coordinates information about a shape of cheeks (or a shape of cheekbones) included in the face image of the user, and 2D-coordinates information about a shape of lips included in the face image of the user, but in the present disclosure, the information about the face image of the user is not limited to the aforementioned descriptions.

For example, in the present disclosure, the information about the face image of the user may include 2D-coordinates information about a shape of a nose included in the face image of the user. The information about the face image of the user may include 2D-coordinates information about a shape of a jaw included in the face image of the user. The information about the face image of the user may include 2D-coordinates information about a shape of a forehead included in the face image of the user. In the present disclosure, the information about the face image of the user may correspond to a parameter with respect to the face image of the user.

In order to provide the makeup guide information 102 through 108 shown in FIG. 1B, the device 100 may compare the detected information about the face image of the user with the reference makeup guide information.

By comparing the information about the face image of the user with the reference makeup guide information, the device 100 may detect a difference value with respect to a difference between the reference face image and the face image of the user. The difference value may be detected from each of parts included in the face images. For example, the difference value may include a difference value with respect to jawlines. The difference value may include a difference value with respect to eyebrows. The difference value may include a difference value with respect to eyes. The difference value may include a difference value with respect to noses. The difference value may include a difference value with respect to lips. The difference value may include a difference value with respect to cheeks. In the present disclosure, the difference value is not limited to the aforementioned descriptions.

When the difference value with respect to the difference between the reference face image and the face image of the user is detected, the device 100 may generate makeup guide information by applying the detected difference value to the reference makeup guide information.

For example, the device 100 may generate the makeup guide information by applying the detected difference value to 2D-coordinates information of a reference makeup area of each part included in the reference makeup guide information. Accordingly, the provided makeup guide information 102 through 108 shown in FIG. 1B may be the reference makeup guide information that is adjusted or changed based on the face image of the user.

As shown in FIG. 1B, the device 100 may display the generated makeup guide information 102 through 108 on the displayed face image of the user. The device 100 may display the makeup guide information 102 through 108 on the face image of the user by using an image overlapping algorithm. Therefore, the makeup guide information 102 through 108 may overlap with the face image of the user.

In the present disclosure, makeup guide information is not limited to what are shown in FIG. 1B. For example, in the present disclosure, the makeup guide information may include makeup guide information about a forehead. In the present disclosure, the makeup guide information may include makeup guide information about a bridge of a nose In the present disclosure, the makeup guide information may include makeup guide information about a jawline

Referring to FIG. 1B, the device 100 may display the makeup guide information 102 through 108 so that the makeup guide information 102 through 108 does not obstruct the displayed face image of the user. The device 100 may display the makeup guide information 102 through 108 in the form of a dotted line as shown in FIG. 1B, but a display form of makeup guide information in the present disclosure is not limited to the aforementioned descriptions. For example, the device 100 may display, on the face image of the user, the makeup guide information 102 through 108 formed of solid lines or dotted lines with various colours (e.g., a red color, a blue color, a yellow color, and the like).

The condition information that may be used so as to generate the makeup guide information 102 through 108 of FIG. 1B may include information for determining the face shape of the face image of the user. The condition information may include information for determining a shape of an eyebrow. The condition information may include information for determining a shape of an eye. The condition information may include information for determining a shape of lips. The condition information may include information for determining a position of a cheekbone. In the present disclosure, the condition information is not limited to the aforementioned descriptions.

The device 100 may compare 2D-coordinates information about the face shape of the face image of the user with the condition information. As a result of the comparison, when the device 100 determines that the face shape of the face image of the user is an inverted triangle-shape, the device 100 may obtain makeup guide information about an eyebrow shape by using an inverted triangle-shape face as a keyword.

The device 100 may obtain the makeup guide information about the eyebrow shape from stored makeup guide information stored in the device 100, but in the present disclosure, the obtainment of the makeup guide information is not limited to the aforementioned descriptions. For example, the device 100 may obtain the makeup guide information about the eyebrow shape from an external device. The external device may include a makeup guide information providing server, a wearable device, a smart mirror, an IoT device, and the like, but in the present disclosure, the external device is not limited to the aforementioned descriptions. The external device may be connected with the device 100, and may store makeup guide information.

An eyebrow makeup guide information table stored in the device 100 and an eyebrow makeup guide information table stored in the external device may include same information. In this case, the device 100 may select, according to priority orders of the device 100 and the external device, one of the eyebrow makeup guide information table stored in the device 100 and the eyebrow makeup guide information table stored in the external device and may use the selected one. For example, when the external device has a priority order higher than a priority order of the device 100, the device 100 may use the eyebrow makeup guide information table stored in the external device. When the device 100 has a priority order higher than a priority order of the external device, the device 100 may use the eyebrow makeup guide information table stored in the device 100.

The eyebrow makeup guide information table stored in the device 100 and the eyebrow makeup guide information table stored in the external device may include a plurality of pieces of information that are different from each other. In this case, the device 100 may use both the eyebrow makeup guide information table stored in the device 100 and the eyebrow makeup guide information table stored in the external device.

The eyebrow makeup guide information table stored in the device 100 and the eyebrow makeup guide information table stored in the external device may include a plurality of pieces of information that are partially same. In this case, the device 100 may select, according to the priority orders of the device 100 and the external device, one of the eyebrow makeup guide information table stored in the device 100 and the eyebrow makeup guide information table stored in the external device and may use the selected one, or may use both the eyebrow makeup guide information table stored in the device 100 and the eyebrow makeup guide information table stored in the external device.

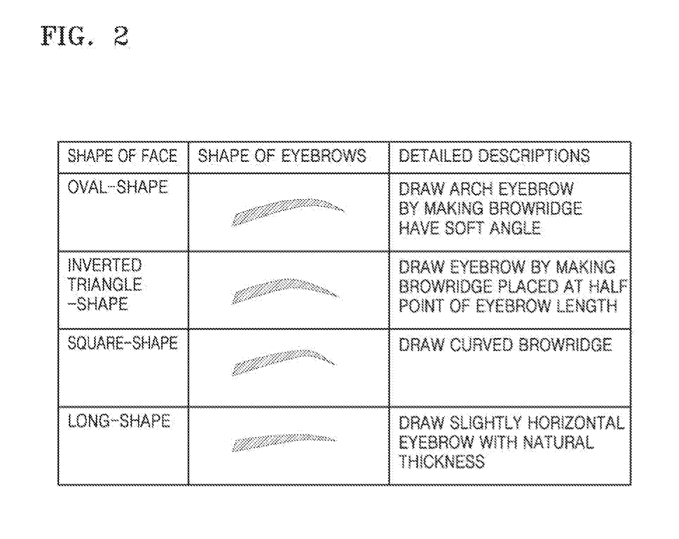

FIG. 2 illustrates an eyebrow makeup guide information table based on a face shape according to various embodiments of the present disclosure.

Referring to FIG. 2, when the device 100 determines that a face shape of a user is an inverted triangle-shape, and the eyebrow makeup guide information table based on the face shape is as shown in FIG. 2, the device 100 may obtain eyebrow makeup guide information corresponding to an inverted triangle-shape from the eyebrow makeup guide information table of FIG. 2. The device 100 and/or at least one external device connected with the device 100 may store the eyebrow makeup guide information table.

When the eyebrow makeup guide information is obtained, as shown in FIG. 1B, the device 100 may display two pieces of obtained eyebrow makeup guide information 102 and 103 on eyebrows included in the face image of the user.

In order to display the two pieces of eyebrow makeup guide information 102 and 103 on the eyebrows included in the face image of the user, the device 100 may use 2D-coordinates information with respect to the eyebrows included in the face image of the user, but a type of information for displaying the two pieces of eyebrow makeup guide information 102 and 103 is not limited to the aforementioned descriptions.

The device 100 may obtain two pieces of eye makeup guide information 104 and 105 shown in FIG. 1B with the two pieces of eyebrow makeup guide information 102 and 103 and may display them on the face image of the user. The device 100 and/or the at least one external device connected with the device 100 may More an eye makeup guide information table.

The eye makeup guide information table stored in the device 100 and the eye makeup guide information table stored in the at least one external device may include same information. In this case, the device 100 may select, according to priority orders of the device 100 and the at least one external device, one of the eye makeup guide information table stored in the device 100 and the eye makeup guide information table stored in the at least one external device and may use the selected one.

For example, when the at least one external device has a priority order higher than that of the device 100, the device 100 may use the eye makeup guide information table stored in the at least one external device. When the device 100 has a priority order higher than that of the at least one external device, the device 100 may use the eye makeup guide information table stored in the device 100.

The eye makeup guide information table stored in the device 100 and the eye makeup guide information table stored in the at least one external device may include a plurality of pieces of information that are different from each other. In this case, the device 100 may use both the eye makeup guide information table stored in the device 100 and the eye makeup guide information table stored in the at least one external device.

The eye makeup guide information table stored in the device 100 and the eye makeup guide information table stored in the at least one external device may include a plurality of pieces of information that are partially same. In this case, the device 100 may select, according to the priority orders of the device 100 and the at least one external device, one of the eye makeup guide information table stored in the device 100 and the eye makeup guide information table stored in the at least one external device and may use the selected one, or may use both the eye makeup guide information table stored in the device 100 and the eye makeup guide information table stored in the at least one external device.

In the present disclosure, the eye makeup guide information table may include eye makeup guide information based on an eye shape (e.g., a double eyelid, a hidden double eyelid, and/or a single eyelid). The eye makeup guide information may include a plurality of pieces of information according to eye makeup steps. For example, the eye makeup guide information may include a shadow base process, an eye-line process, an under-eye process, and a mascara process. In the present disclosure, information included in the eye makeup guide information is not limited to the aforementioned descriptions.

In order to display the two pieces of eye makeup guide information 104 and 105 on eyes included in the face image of the user, the device 100 may use 2D-coordinates information with respect to the eyes included in the face image of the user, but in the present disclosure, a type of information for displaying the two pieces of eye makeup guide information 104 and 105 is not limited to the aforementioned descriptions.

The device 100 may obtain two pieces of cheek makeup guide information 106 and 107 shown in FIG. 1B with the two pieces of eyebrow makeup guide information 102 and 103 and may display them on the face image of the user. The device 100 and/or the at least one external device connected with the device 100 may store a cheek makeup guide information table.

The cheek makeup guide information table stored in the device 100 and the cheek makeup guide information table stored in the at least one external device may include same information. In this case, the device 100 may select, according to priority orders of the device 100 and the at least one external device, one of the cheek makeup guide information table stored in the device 100 and the cheek makeup guide information table stored in the at least one external device and may use the selected one.

The cheek makeup guide information table stored in the device 100 and the cheek makeup guide information table stored in the at least one external device may include a plurality of pieces of information that are different from each other. In this case, the device 100 may use both the cheek makeup guide information table stored in the device 100 and the cheek makeup guide information table stored in the at least one external device.

The cheek makeup guide information table stored in the device 100 and the cheek makeup guide information table stored in the at least one external device may include a plurality of pieces of information that are partially same. In this case, the device 100 may select, according to the priority orders of the device 100 and the at least one external device, one of the cheek makeup guide information table stored in the device 100 and the cheek makeup guide information table stored in the at least one external device and may use the selected one, or may use both the cheek makeup guide information table stored in the device 100 and the cheek makeup guide information table stored in the at least one external device.

The cheek makeup guide information table may include a face-shape shading process, a highlighter process, and a cheek blusher process. In the present disclosure, information included in the cheek makeup guide information is not limited to the aforementioned descriptions.

In order to display the two pieces of cheek makeup guide information 106 and 107 on cheeks included in the face image of the user, the device 100 may use 2D-coordinates information with respect to the cheeks included in the face image of the user, but in the present disclosure, a type of information for displaying the two pieces of cheek makeup guide information 106 and 107 is not limited to the aforementioned descriptions.

The device 100 may obtain lips makeup guide information 108 shown in FIG. 1B with the two pieces of eyebrow makeup guide information 102 and 103 and may display them on the face image of the user. The device 100 and/or the at least one external device connected with the device 100 may store a lips makeup guide information table.

The lips makeup guide information table stored in the device 100 and the lips makeup guide information table stored in the at least one external device may include same information, in this case, the device 100 may select, according to priority orders of the device 100 and the at least one external device, one of the lips makeup guide information table stored in the device 100 and the lips makeup guide information table stored in the at least one external device and may use the selected one.

The lips makeup guide information table stored in the device 100 and the lips makeup guide information table stored in the at least one external device may include a plurality of pieces of information that are different from each other. In this case, the device 100 may use both the lips makeup guide information table stored in the device 100 and the lips makeup guide information table stored in the at least one external device.

The lips makeup guide information table stored in the device 100 and the lips makeup guide information table stored in the at least one external device may include a plurality of pieces of information that are partially same. In this case, the device 100 may select, according to the priority orders of the device 100 and the at least one external device, one of the lips makeup guide information table stored in the device 100 and the lips makeup guide information table stored in the at least one external device and may use the selected one, or may use both the lips makeup guide information table stored in the device 100 and the lips makeup guide information table stored in the at least one external device.

The lips makeup guide information table may include a face shape and lip-lining process, a lip product applying process, and a lip brush process. In the present disclosure, information included in the lips makeup guide information is not limited to the aforementioned descriptions.

In order to display the lips makeup guide information 108 on lips included in the face image of the user, the device 100 may use 2D-coordinates information with respect to the lips included in the face image of the user, but in the present disclosure, a type of information for displaying the lips makeup guide information 108 is not limited to the aforementioned descriptions.

The device 100 may display the makeup guide information 102 through 108 on the face image of the user, according to a preset display type. For example, when the display type is set as a dotted line, as shown in FIG. 1B, the device 100 may display the makeup guide information 102 through 108 on the face image of the user by using a dotted line. When the display type is set as a red solid line, in FIG. 1B, the device 100 may display the makeup guide information 102 through 108 on the face image of the user by using a red solid line.

The display type for the makeup guide information 102 through 108 may be set as a default in the device 100, but the present disclosure is not limited thereto. For example, the display type for the makeup guide information 102 through 108 may be set or changed by a user of the device 100.

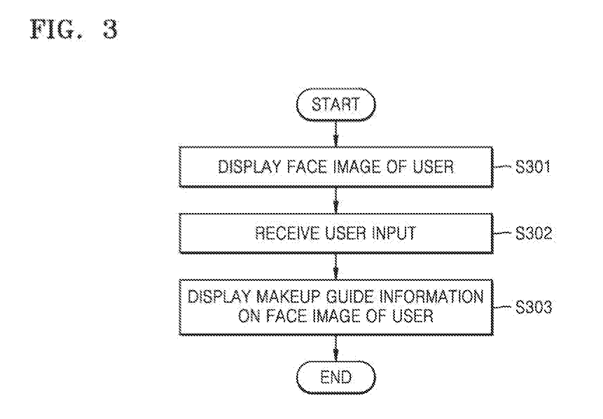

FIG. 3 is a flowchart of a method of providing a makeup mirror for displaying makeup guide information on a face image of a user, the method being performed by a device according to various embodiments of the present disclosure. The method may be implemented by a computer program. For example, the method may be performed by using a makeup mirror application installed in the device 100. The computer program may operate in an operation system (OS) installed in the device 100. The device 100 may write the computer program to a storage medium, and may use the computer program by reading the computer program from the storage medium.

Referring to FIG. 3, in operation S301, the device 100 displays the face image of the user. Accordingly, the user may view the face image of the user via the device 100. The device 100 may display in real-time the face image of the user. The device 100 may obtain the face image of the user by executing a camera application included in the device 100, and may display the obtained face image of the user. In the present disclosure, a method of obtaining the face image of the user is not limited to the aforementioned descriptions.

For example, the device 100 may establish a communication channel with an external device (e.g., a wearable device, such as a smart watch, a smart mirror, a smartphone, a digital camera, an IoT device (e.g., a smart television (smart TV), a smart oven, etc.), and the like) that has a camera function. The device 100 may activate the camera function of the external device by using the established communication channel. The device 100 may receive the face image of the user which is obtained by using the camera function activated in the external device. The device 100 may display the received face image of the user. In this case, the user may view both the face images of the user simultaneously via the device 100 and the external device.

Before the user wears makeup, the face image of the user which is displayed on the device 100 as shown in FIGS. 1A and 1B may be the face image of the user which is selected by the user. The user may select one of face images of the user which are stored in the device 100. The user may select one image from among face images of the user which are stored in at least one external device connected with the device 100. The external device may be referred to as another device.

When the device 100 obtains the face image of the user, the device 100 may perform operation S301. When the device 100 receives the face image of the user, the device 100 may perform operation S301.

For example, when the device 100 in a lock state receives the face image of the user from the other device, the device 100 may unlock the lock state and may perform operation S301. The lock state of the device 100 indicates a function lock state of the device 100. For example, the lock state of the device 100 may include a screen lock state of the device 100.

When the face image of the user is selected in the device 100, the device 100 may perform operation S301. In various embodiments of the present disclosure, when the device 100 executes the makeup mirror application, the device 100 may obtain the face image of the user or may receive the face image of the user. The makeup mirror application indicates an application that provides a makeup mirror described in embodiments of the present disclosure.

In operation S302, the device 100 receives a user input for requesting a makeup guide with respect to the displayed face image of the user. The user input may be received based on the makeup guide button 101 that is displayed with the face image of the user as described with reference to FIG. 1A. As described with reference to FIG. 1A, the user input may be received based on the voice signal of the user. As described with reference to FIG. 1A, the user input may be received based on the touch.

The user input for requesting the makeup guide may be based on an operation related to the device 100. The operation related to the device 100 may include that, for example, the device 100 is placed on a makeup stand. For example, when the device 100 is placed on the makeup stand, the device 100 may recognize that the user input for requesting the makeup guide has been received. The device 100 may detect an operation of placing the device 100 on the makeup stand, by using a sensor included in the device 100, but the present disclosure is not limited to the aforementioned descriptions. The operation of placing the device 100 on the makeup stand may be expressed as an operation of attaching the device 100 to the makeup stand.

In addition, a makeup guide request may be based on a user input performed by using an external device (e.g., a wearable device, such as a smart watch, and the like) connected with the device 100.

In operation S303, the device 100 may display makeup guide information on the face image of the user. As shown in FIG. 1B, the device 100 may display the makeup guide information in a dotted-line form on the face image of the user. Therefore, the user may view the makeup guide information while the user views the face image of the user which is not obstructed by the makeup guide information.

In operation S303, the device 100 may generate the makeup guide information as described with reference to FIG. 113.

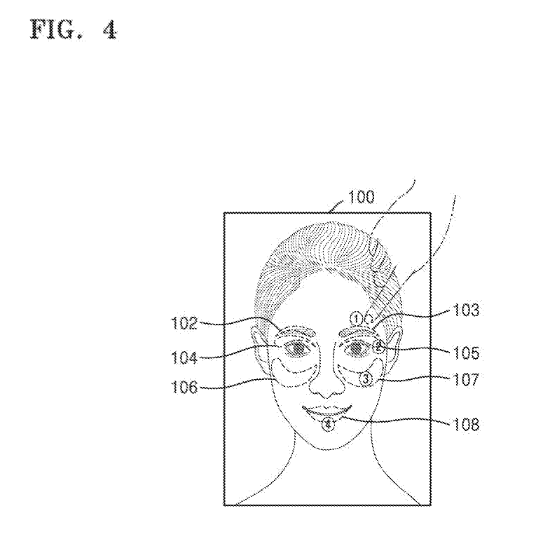

FIG. 4 illustrates a makeup mirror of a device, which displays makeup guide information including a plurality of pieces of makeup step information according to various embodiments of the present disclosure.

Referring to FIG. 4, the makeup mirror of the device 100 displays makeup guide information including a plurality of pieces of makeup step information \textcircled{1}, \textcircled{2}, \textcircled{3}, and \textcircled{4} on a face image of a user which is displayed on the device 100.

When a user input of a makeup guide request as described with reference to FIG. 1A is received, the device 100 may display makeup guide information including the plurality of pieces of makeup step information \textcircled{1}, \textcircled{2}, \textcircled{3}, and \textcircled{4} on the face image of the user as shown in FIG. 4. Accordingly, the user may view makeup steps and makeup areas based on the face image of the user.

Referring to FIG. 4, when a user input for selecting the makeup step information \textcircled{1} is received, the device 100 may provide detailed eyebrow makeup guide information.

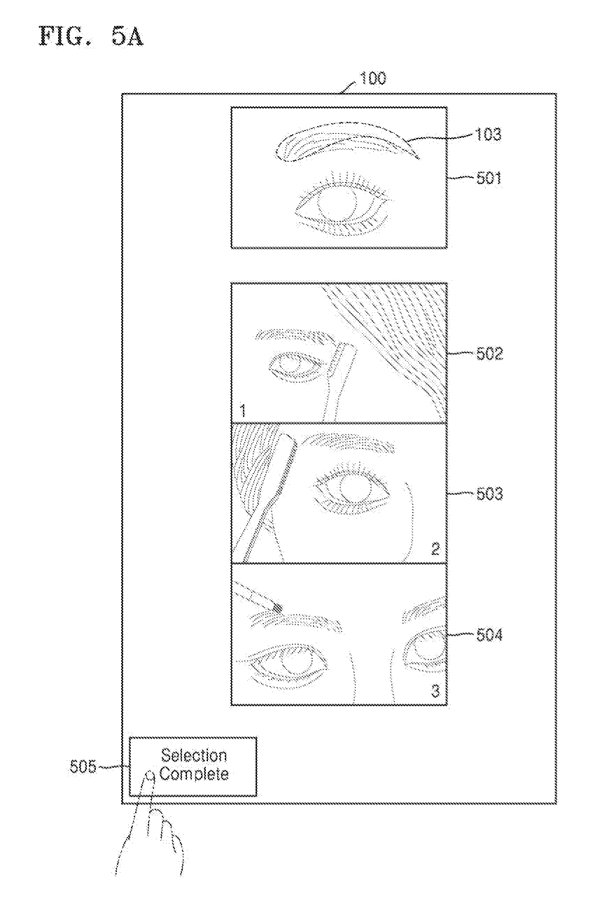

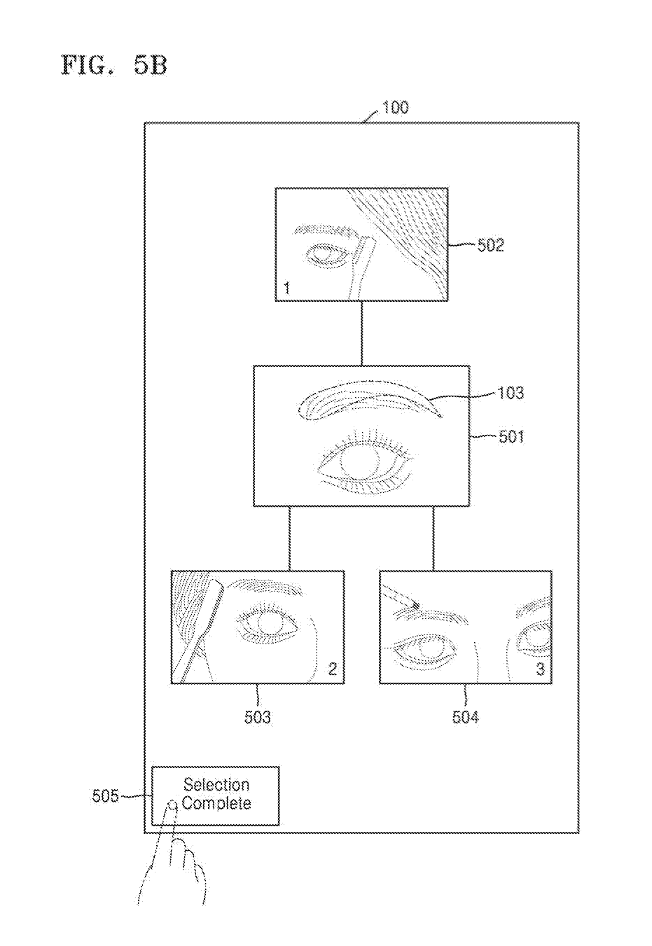

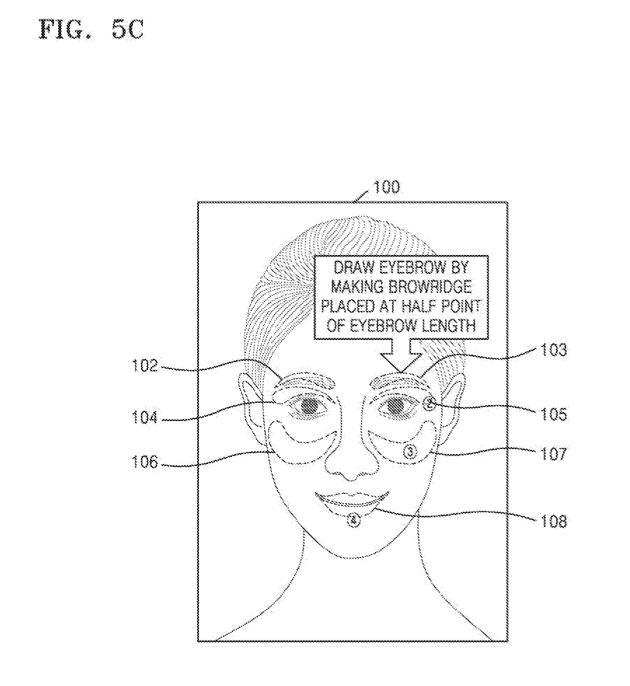

FIGS. 5A to 5C illustrate a makeup mirror according to various embodiments of the present disclosure.

Referring to FIGS. 5A to 5C, the makeup mirror of the device 100 provides detailed eyebrow makeup guide information in the form of an image.

When the user input for selecting the makeup step information \textcircled{1} of FIG. 4 is received, the device 100 may provide the detailed eyebrow makeup guide information as shown in FIG. 5A, but the present disclosure is not limited thereto. For example, the device 100 may provide eyebrow makeup guide information that is further or less detailed than that is shown in FIG. 5A.

For example, when the user input for selecting the makeup step information \textcircled{1} of FIG. 4 is received, the device 100 may display detailed information included in the eyebrow makeup guide information table of FIG. 2 at a position adjacent to an eyebrow of the user as shown in FIG. 5C. Referring to FIG. 5C, the device 100 may provide the detailed information in the form of a pop-up window. However, in the present disclosure, a form of the provided detailed information is not limited to that shown in FIG. 5C.

When the user input for selecting the makeup step information \textcircled{1} of FIG. 4 is received, the device 100 may skip a process of providing the detailed eyebrow makeup guide information shown in FIG. 5A, and may provide detailed eyebrow makeup guide information according to preset steps, based on a face image of the user.

Referring to FIG. 5A, the device 100 may provide an image 501 with respect to the provided eyebrow makeup guide information 103 of FIG. 4, and images 502, 503, and 504 with respect to detailed eyebrow makeup guide information corresponding to the image 501. The images 502, 503, and 504 with respect to the detailed eyebrow makeup guide information may be arranged based on makeup steps, but in the present disclosure, the arrangement of the images 502, 503, and 504 is not limited to the makeup steps.

For example, the images 502, 503, and 504 with respect to the detailed eyebrow makeup guide information shown in FIG. 5A may be randomly arranged as shown in FIG. 5B, regardless of the makeup steps. When the images 502, 503, and 504 with respect to the detailed eyebrow makeup guide information are randomly arranged as shown in FIG. 5B, the user may recognize the makeup steps based on a plurality of pieces of makeup step information (e.g., 1, 2, and 3) included in the images 502, 503, and 504 with respect to the detailed eyebrow makeup guide information.

Referring to FIGS. 5A and 5B, the images 502, 503, and 504 with respect to the detailed eyebrow makeup guide information may include the plurality of pieces of makeup step information (e.g., 1, 2, and 3) and representative images, respectively, but in the present disclosure, information included in each of the images 502, 503, and 504 with respect to the detailed eyebrow makeup guide information is not limited to the aforementioned descriptions.

The representative image may include an image indicating a makeup procedure. For example, the image 502 may include an image indicating trimming an eyebrow by using an eyebrow knife. The image 503 may include an image indicating grooming an eyebrow by using an eyebrow comb. The image 504 may include an image indicating drawing an eyebrow by using an eyebrow brush.

The user may view the representative image and may easily recognize the makeup procedure. The representative image may include an image that is irrelevant to the face image of the user. In the present disclosure, the representative image is not limited to the aforementioned descriptions. For example, the image indicating trimming an eyebrow by using an eyebrow knife may be replaced with an image indicating trimming an eyebrow by using an eyebrow scissors.

The image 501 may be obtained by capturing an area based on an eyebrow on the face image of the user shown in FIG. 4, but in the present disclosure, the image 501 is not limited to the aforementioned descriptions. For example, the image 501 may include an image irrelevant to the face image of the user. For example, the image 501 may be formed of makeup guide information displayed on the eyebrow on the face image of the user shown in FIG. 4.

When the detailed eyebrow makeup guide information shown in FIG. 5A is provided, if a user input for selecting a selection complete button 505 in FIG. 5A is received, the device 100 may sequentially display, on the face image of the user, a plurality of pieces of detailed makeup guide information with respect to eyebrows, according to detailed eyebrow makeup steps shown in FIG. 5A.

For example, when the user input for selecting the selection complete button 505 is received, the device 100 may provide the detailed eyebrow makeup guide information based on the image 502, according to the face image of the user. When an eyebrow makeup process based on the image 502 is completed, the device 100 may provide the detailed eyebrow makeup guide information based on the image 503, according to the face image of the user. When an eyebrow makeup process based on the image 503 is completed, the device 100 may provide the detailed eyebrow makeup guide information based on the image 504, according to the face image of the user. When an eyebrow makeup process based on the image 504 is completed, the device 100 may recognize that the eyebrow makeup procedure of the user is completed.

In addition, when a user input for selecting one of the makeup guide information 102 through 108 shown in FIG. 1B is received, the device 100 may provide the detailed makeup guide information described with reference to FIG. 5A, 5B, or 5C.

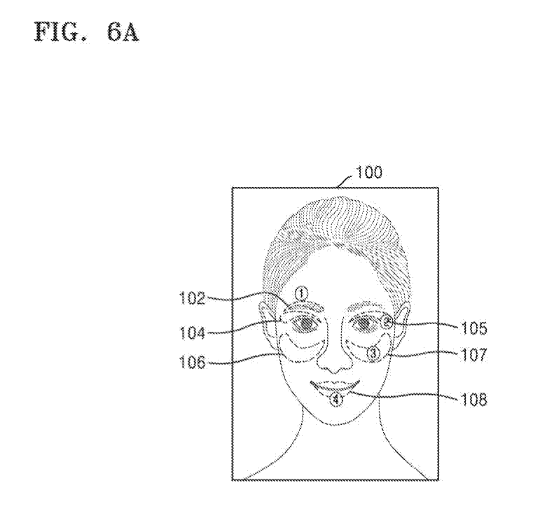

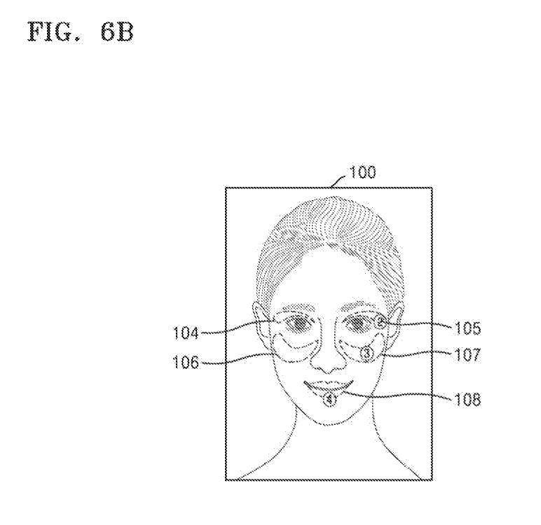

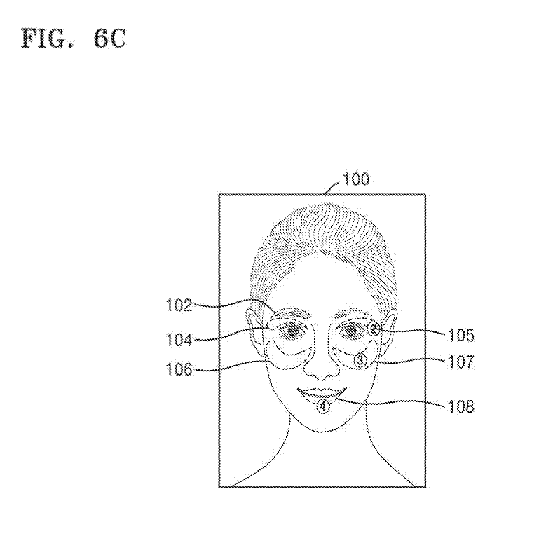

FIGS. 6A to 6C illustrate a makeup mirror of a device, which displays makeup guide information based on a face image of a user after left eyebrow makeup of the user has been completed according to various embodiments of the present disclosure.

When the device 100 recognizes that the left eyebrow makeup of the user has been completed, the device 100 may provide again a screen of FIG. 4, but the present disclosure is not limited thereto.

For example, when the left eyebrow makeup of the user has been completed based on FIG. 5A or 5B, the device 100 may display, on the face image of the user, makeup guide information from which makeup guide information with respect to a left eyebrow has been deleted as shown in FIG. 6A, 6B, or 6C.

Referring to FIG. 6A, when the left eyebrow makeup has been completed, the device 100 may delete the makeup guide information with respect to the left eyebrow and may display the makeup step information \textcircled{1}, which was allocated to the makeup guide information with respect to the left eyebrow, on makeup guide information with respect to a right eyebrow. Accordingly, the user may apply makeup to the right eyebrow as a next makeup step.

Referring to FIG. 6B, when the device 100 deletes the makeup guide information with respect to the left eyebrow from the face image of the user, the device 100 may also delete the makeup guide information with respect to the right eyebrow. Accordingly, the user may apply makeup to a left eye as a next makeup step while the user does not apply the makeup to the right eyebrow.

Referring to FIG. 6C, when the device 100 deletes the makeup guide information with respect to the left eyebrow from the face image of the user, the device 100 may delete the makeup step information \textcircled{1} which was allocated to the makeup guide information with respect to the left eyebrow, and may maintain the makeup guide information with respect to the right eyebrow which is displayed on the face image of the user. Accordingly, the user may recognize that the makeup on the left eyebrow has been completed but makeup on the right eyebrow is not complete, and thus may apply the makeup to the right eyebrow as a next makeup step.

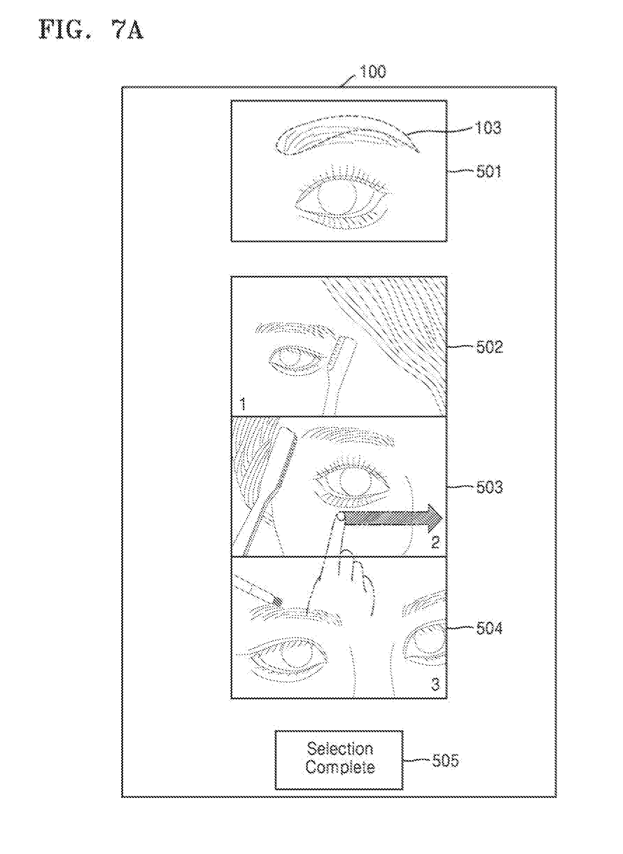

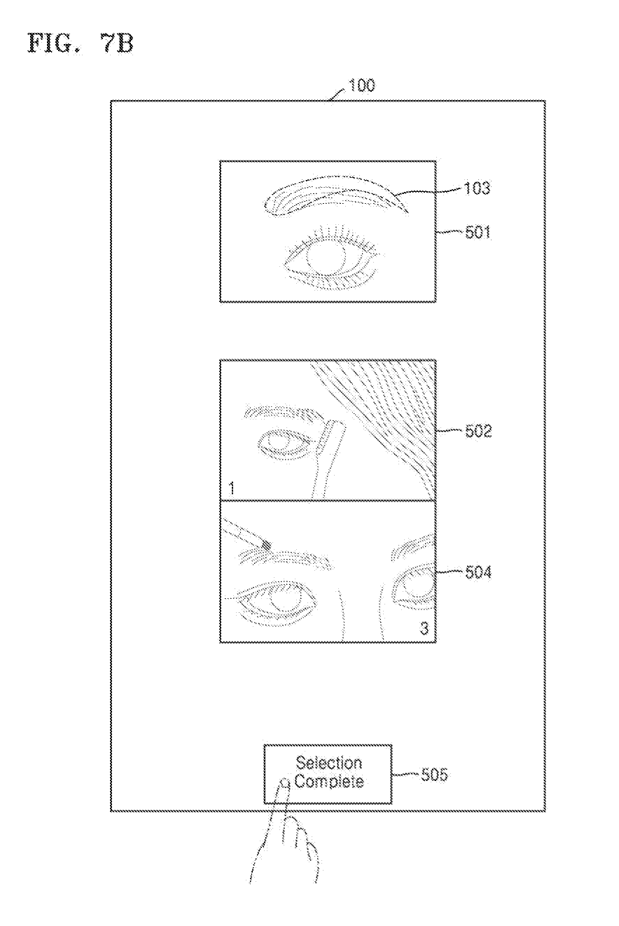

FIGS. 7A and 7B illustrate a makeup mirror of a device, which edits a detailed eyebrow makeup guide information provided with reference to FIG. 5A according to various embodiments of the present disclosure.

Referring to FIG. 7A, when a user input for deleting at least one image 503 from among the images 502, 503, and 504 is received, the device 100 may delete the image 503 as shown in FIG. 713. The user input for deleting at least one image 503 may include a touch-based input for touching an area of the image 503 and dragging the touch leftward or rightward, and is not limited thereto.

For example, the user input for deleting at least one image 503 may include a touch-based input for long-touching the area of the image 503. In addition, the user input for deleting at least one image 503 may be based on identification information included in the images 502, 503, and 504. The images 502,503, and 504 may be expressed as detailed eyebrow makeup guide items.

Referring to FIG. 7A, when the user input for deleting the image 503 is received, the device 100 may provide two pieces of detailed eyebrow makeup guide information that correspond to the image 502 and the image 504 as shown in FIG. 7B. When a user views a screen shown in FIG. 713, the user may predict that two pieces of detailed eyebrow makeup guide information that correspond to the image 502 and the image 504 are provided.

Referring to FIG. 7B, when a user input for selecting the selection complete button 505 is received, the device 100 may display, on the face image of the user, a plurality of pieces of detailed eyebrow makeup guide information corresponding to the image 502 and the image 504.

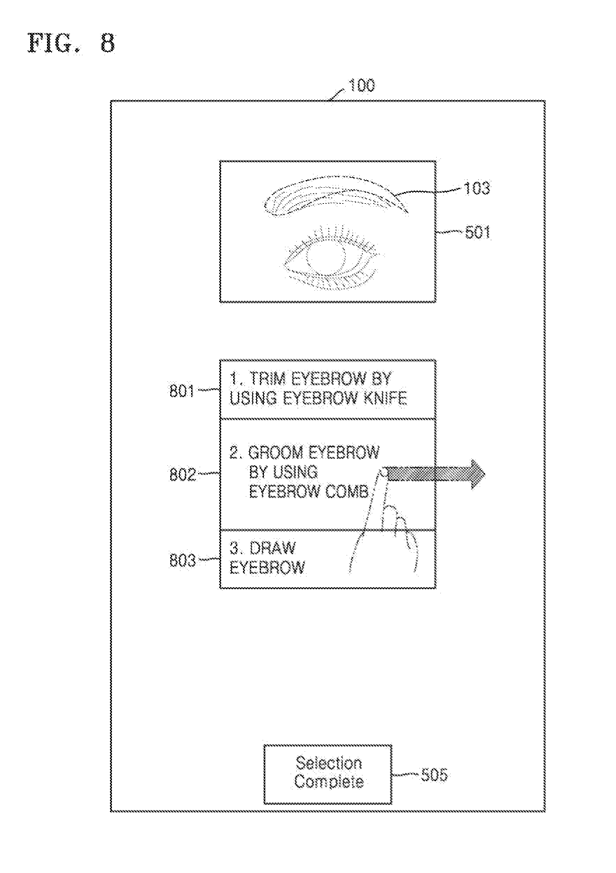

FIG. 8 illustrates a makeup mirror that provides text-type detailed eyebrow makeup guide information provided by a device according to various embodiments of the present disclosure.

Referring to FIG. 8, when a user input for selecting the eyebrow makeup guide information or the makeup step information \textcircled{1} of the eyebrow makeup guide information shown in FIG. 4 is received, the device 100 may provide a plurality of pieces of text-type detailed eyebrow makeup guide information 801, 802, and 803 as shown in FIG. 8.

When a user input for deleting the detailed eyebrow makeup guide information 802 from among the plurality of pieces of text-type detailed eyebrow makeup guide information 801, 802, and 803 of FIG. 8 is received, and a user input for selecting the selection complete button 505 is received, the device 100 may display, on the face image of the user, a plurality of pieces of detailed eyebrow makeup guide information based on an item of trimming an eyebrow by using an eyebrow knife and an item of drawing an eyebrow,

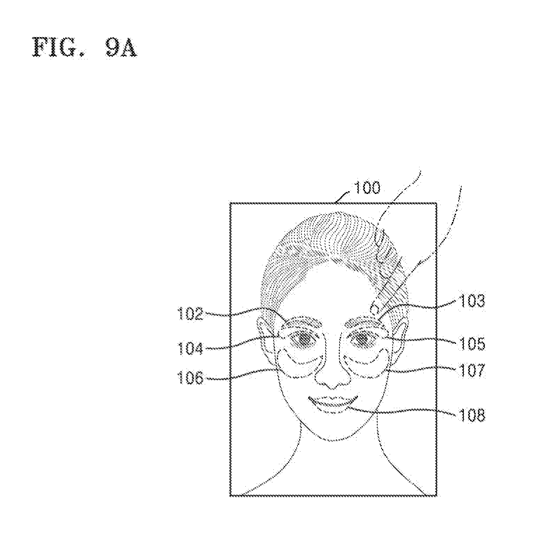

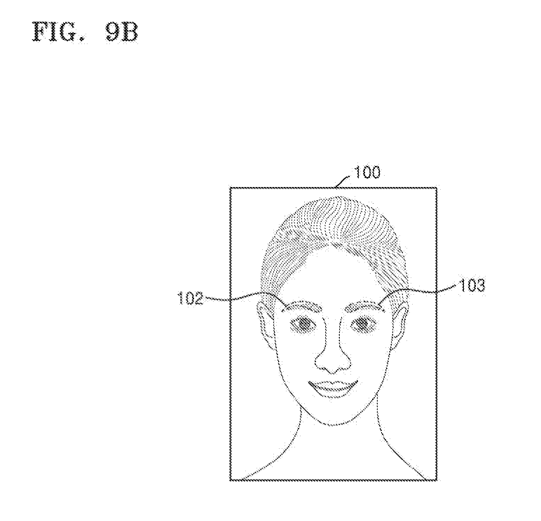

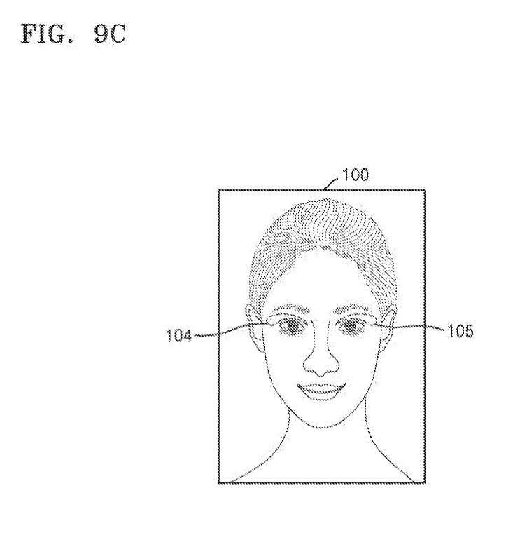

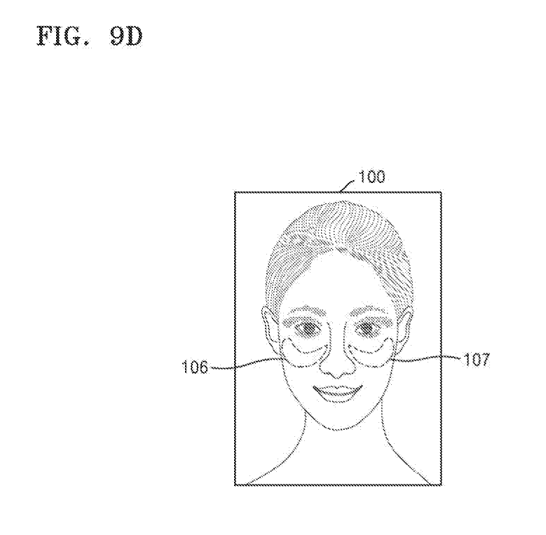

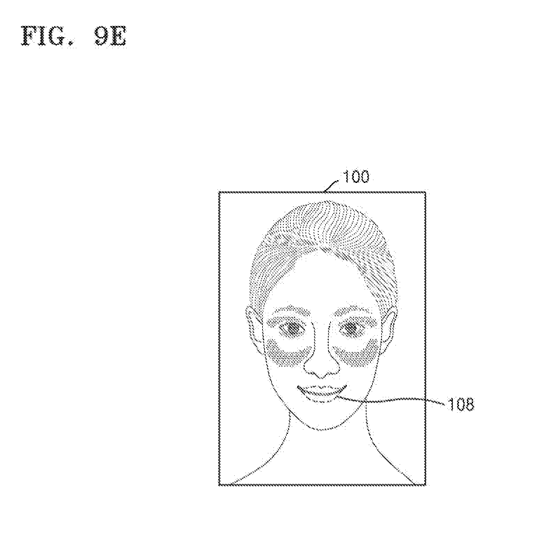

FIGS. 9A to 9E illustrate a makeup mirror of a device, which changes makeup guide information according to a makeup progress according to various embodiments of the present disclosure.

Referring to FIG. 9A, in a case where the makeup guide information 102 through 108 is displayed on a face image of a user, when a user input for selecting eyebrows is received, the device 100 may display, as shown in FIG. 9B, only the eyebrow makeup guide information 102 and 103 on the face image of the user. Accordingly, the user may apply makeup to eyebrows, based on the eyebrow makeup guide information 102 and 103.

When the makeup on the eyebrows is completed, the device 100 may display the eye makeup guide information 104 and 105 on the face image of the user, as shown in FIG. 9C. Accordingly, the user may apply makeup to eyes, based on the eye makeup guide information 104 and 105.

When the makeup on the eyes is completed, the device 100 may display the cheek makeup guide information 106 and 107 on the face image of the user, as shown in FIG. 9D. Accordingly, the user may apply makeup to cheeks, based on the cheek makeup guide information 106 and 107.

When the makeup on the cheeks is completed, the device 100 may display the lips makeup guide information 108 on the face image of the user, as shown in FIG. 9E. Accordingly, the user may apply makeup to lips, based on the lips makeup guide information 108.

The device 100 may determine, by using a makeup tracking function, whether the makeup on each of the eyebrows, the eyes, the cheeks, and the lips has been completed. The makeup tracking function may detect in real-time a makeup status of the face image of the user. The makeup tracking function may obtain in real-time a face image of the user, may compare a previous face image of the user with a current face image of the user, and thus may detect the makeup status of the face image of the user, and in the present disclosure, the makeup tracking function is not limited to the aforementioned descriptions. For example, the device 100 may perform the makeup tracking function by using a movement detecting algorithm based on the face image of the user. The movement detecting algorithm may detect movement of a position of a makeup tool on the face image of the user.

When the device 100 receives a user input for informing completion of each makeup process, the device 100 may determine whether the makeup on each of the eyebrows, the eyes, the cheeks, and the lips has been completed.

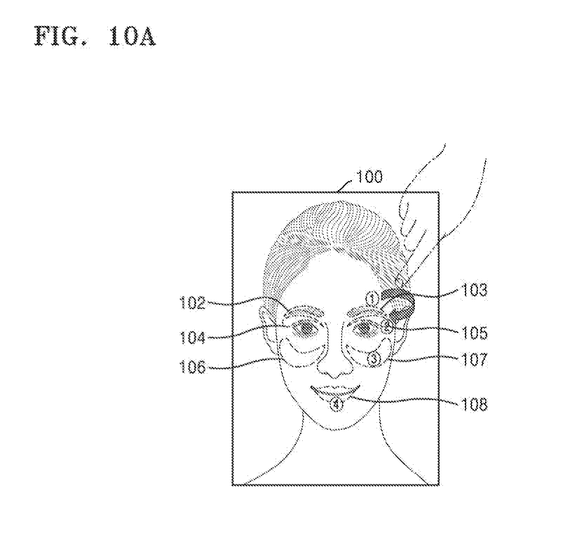

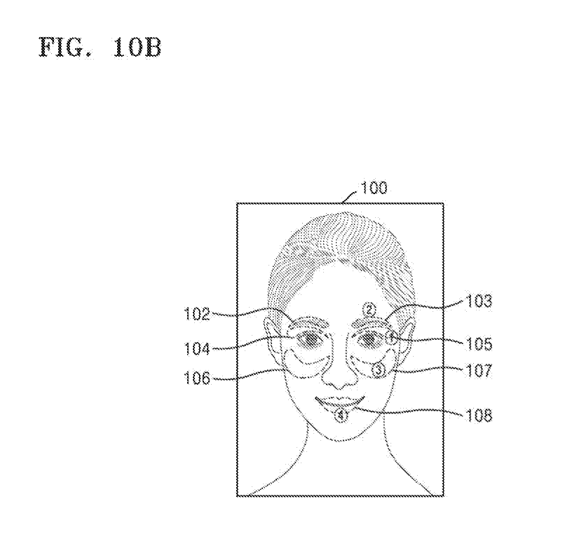

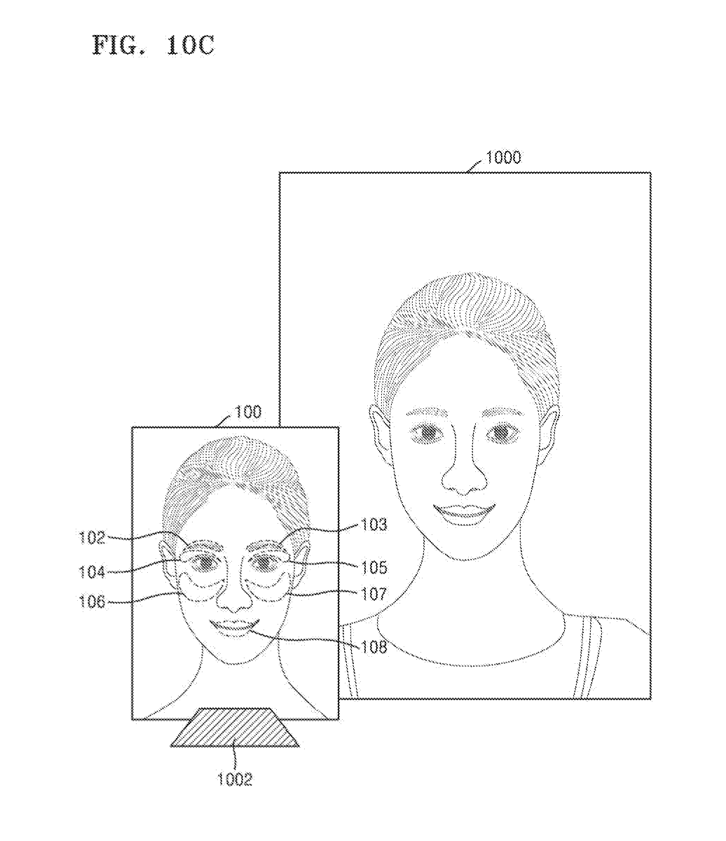

FIGS. 10A and 10B illustrate a makeup mirror of a device, which changes makeup steps according to various embodiments of the present disclosure.

Referring to FIGS. 10A and 10B, when the device 100 displays the makeup guide information 102 through 108 including a plurality of pieces of makeup step information \textcircled{1}, \textcircled{2}, \textcircled{3}, and \textcircled{4} on a face image of a user, if a user input for touching the makeup step information \textcircled{1} and dragging the makeup step information \textcircled{1} to a point where the makeup step information \textcircled{2} is displayed is received, the device 100 may change a makeup step with respect to eyes and a makeup step with respect to eyebrows as shown in FIG. 10B.

Accordingly, the device 100 may provide makeup guide information in order of eyes→eyebrows→cheeks→lips, based on the face image of the user. In the present disclosure, the user input for changing makeup steps is not limited to the aforementioned descriptions.

FIG. 10C illustrates a makeup mirror of a device, which displays makeup guide information on a face image of a user received from another device according to various embodiments of the present disclosure.

Referring to FIG. 1.0C, the device 100 may receive the face image of the user from the other device 1000. The other device 1000 may be connected with the device 100. Connection between the other device 1000 and the device 100 may be established in a wireless or wired manner.

For example, the other device 1000 shown in FIG. 10C may be a smart mirror. The other device 1000 may be an IoT device (e.g., a smart TV) having a smart mirror function. The other device 1000 may have a camera function.

After a communication channel is established between the device 100 and the other device 1000, the other device 1000 may transmit the obtained face image of the user to the device 100 while the other device 1000 displays the face image.

When the device 100 receives the face image of the user from the other device 1000, the device 100 may display the received face image of the user. Accordingly, the user may view the face image of the user via both the device 100 and the other device 1000.

After the device 100 displays the face image of the user, when the device 100 is placed on a makeup stand 1002, as illustrated in FIG. 10C, the device 100 may display makeup guide information on the face image of the user.

The makeup stand 1002 may be formed in a similar manner to a mobile phone stand. For example, when the makeup stand 1002 is formed based on a magnet ball, the device 100 may determine whether the device 100 is placed on the makeup stand 1002 by using a magnet detachment-attachment detecting sensor. When the makeup stand 1002 is formed as a charger stand, the device 100 may determine whether the device 100 is placed on the makeup stand 1002 according to whether a connector of the device is connected to a charging terminal of the makeup stand 1002.

The device 100 may transmit, to the other device 1000, makeup guide information displayed on the face image of the user. Therefore, the other device 1000 may also display the makeup guide information on the face image of the user, as in the device 100. The device 100 may transmit, to the other device 1000, information that is obtained when makeup is processed. The other device 1000 may obtain in real-time a face image of the user, and may transmit the obtained result to the device 100.

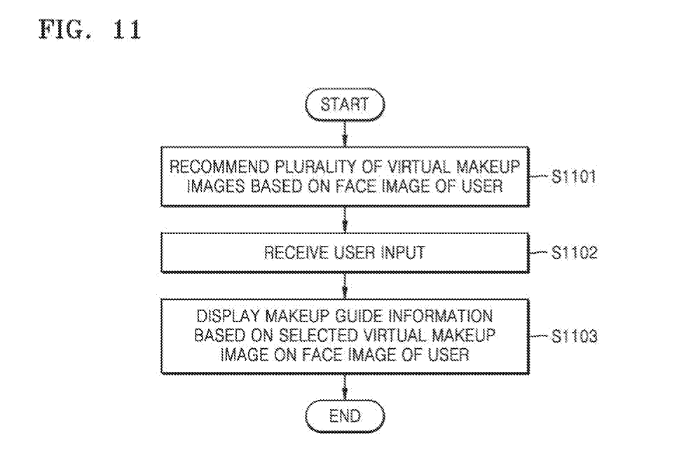

FIG. 11 is a flowchart of a method of providing a makeup mirror for providing makeup guide information by recommending a plurality of virtual makeup images based on a face image of a user, the method being performed by a device according to various embodiments of the present disclosure.

Referring to FIG. 11, the method may be implemented by a computer program. For example, the method may be performed by using a makeup mirror application installed in the device 100. The computer program may operate in an OS installed in the device 100. The device 100 may write the computer program to a storage medium, and may use the computer program by reading the computer program from the storage medium.

In operation S1101, the device 100 recommends the plurality of virtual makeup images based on the face image of the user. The face image of the user may be obtained as described with reference to FIG. 1A. A virtual makeup image indicates a face image of the user on which makeup is virtually completed. The plurality of recommended virtual makeup images may be based on a color makeup but are not limited thereto. For example, the plurality of recommended virtual makeup images may be based on a theme.

A plurality of makeup images based on a color makeup may include makeup images of a pink color, a brown color, a blue color, a green color, a violet color, and the like but are not limited thereto.

A plurality of theme-based makeup images may include a makeup image based on a season (e.g., spring, summer, fall, and/or winter). The plurality of theme-based makeup images may include makeup images based on popularities (e.g., a user's preference, an acquaintance's preference, currently-trendy makeup, makeup of a currently popular blog, and the like).

The plurality of theme-based makeup images may include makeup images based on celebrities. The plurality of theme-based makeup images may include makeup images based on jobs. The plurality of theme-based makeup images may include makeup images based on going on dates. The plurality of theme-based makeup images may include makeup images based on parties.

The plurality of theme-based makeup images may include makeup images based on travel destinations (e.g., seas, mountains, historic sites, and the like). The plurality of theme-based makeup images may include makeup images based on newness (or most recentness). The plurality of theme-based makeup images may include makeup images based on physiognomies to promote good fortune (e.g., fortune in wealth, fortune in job promotion, fortune in being popular, fortune in getting a job, fortune in passing a test, fortune in marriage, and the like).

The plurality of theme-based makeup images may include a natural-look makeup images. The plurality of theme-based makeup images may include a sophisticated-look makeup images. The plurality of theme-based makeup images may include makeup images based on points (e.g., eyes, a nose, lips, and/or cheeks). The plurality of theme-based makeup images may include makeup images based on dramas.

The plurality of theme-based makeup images may include makeup images based on movies. The plurality of theme-based makeup images may include makeup images based on plastic surgeries (e.g., an eye plastic surgery, a chin plastic surgery, a lips plastic surgery, a nose plastic surgery, a cheek plastic surgery, and the like). In the present disclosure, the plurality of theme-based makeup images are not limited to the aforementioned descriptions.

The device 100 may generate the plurality of virtual makeup images by using information about the face image of the user and a plurality of pieces of virtual makeup guide information.

The device 100 may store the plurality of pieces of virtual makeup guide information, but the present disclosure is not limited thereto. For example, at least one external device connected to the device 100 may store the plurality of pieces of virtual makeup guide information.

When the plurality of pieces of virtual makeup guide information are stored in the external device, the external device may provide the plurality of pieces of stored virtual makeup guide information, according to a request from the device 100.

When the device 100 receives the plurality of pieces of virtual makeup guide information from the external device, the device 100 may transmit information indicating a virtual makeup guide information request to the external device. Accordingly, the external device may provide all of the plurality of pieces of stored virtual makeup guide information to the device 100.

The device 100 may request the external device for virtual makeup guide information. In this case, the device 100 may transmit, to the external device, information indicating reception-target virtual makeup guide information (e.g., a blue color). Accordingly, the external device may provide, to the device 100, blue color-based virtual makeup guide information from among the plurality of pieces of stored virtual makeup guide information.

The virtual makeup guide information may include makeup information of a target-face image (e.g., a face image of a celebrity “A”). The device 100 may detect the makeup information from the target-face image by using a face recognition algorithm. The target-face image may include a face image of the user. The virtual makeup guide information may include information similar to the aforementioned makeup guide information.

Each of the device 100 and the external device may store a plurality of pieces of virtual makeup guide information. The plurality of pieces of virtual makeup guide information stored in the device 100 and the plurality of pieces of virtual makeup guide information stored in the external device may be equal to each other. Some of the plurality of pieces of virtual makeup guide information stored in the device 100 and some of the plurality of pieces of virtual makeup guide information stored in the external device may be equal to each other. The plurality of pieces of virtual makeup guide information stored in the device 100 and the plurality of pieces of virtual makeup guide information stored in the external device may be different from each other.

In operation S1102, the device 100 may receive a user input for selecting one virtual makeup image from among the plurality of virtual makeup images. The user input may include a touch-based user input, a user's voice signal-based user input, or a user input received from the external device (e.g., a wearable device) connected to the device 100), but in the present disclosure, the user input is not limited to the aforementioned descriptions. For example, the user input may include a gesture by the user.

In operation S1103, the device 100 may display makeup guide information based on the selected virtual makeup image on the face image of the user. In this regard, the displayed makeup guide information may be similar to makeup guide information displayed in operation S303 in the flowchart of FIG. 3. Accordingly, the user may view the makeup guide information based on a user-desired makeup image, based on the face image of the user.

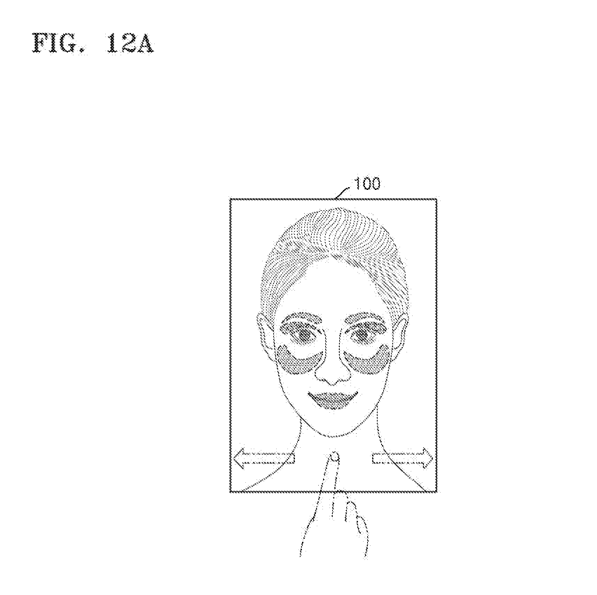

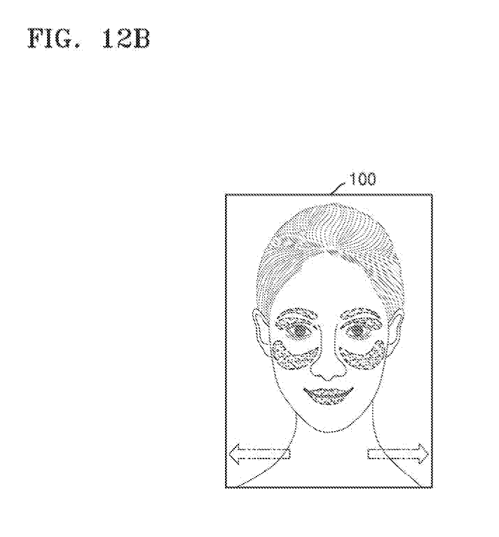

FIGS. 12A and 12B illustrate a makeup mirror of a device, which recommends a plurality of virtual makeup images based on colours according to various embodiments of the present disclosure.

Referring to FIG. 12A, the device 100 displays a violet color-based virtual makeup image on a face image of a user. With reference to FIG. 12A, the device 100 may receive a user input for touching a point on a screen of the device 100 and dragging the touch rightward or leftward.

With reference to FIG. 12A, when the user input is received, the device 100 may display a different color-based virtual makeup image as shown in FIG. 12B. The different color-based virtual makeup image displayed with reference to FIG. 12B may be a pink color-based virtual makeup image, but in the present disclosure, a different color-based virtual makeup image that may be displayed is not limited to the pink color-based virtual makeup image.

With reference to FIG. 12B, the device 100 may receive a user input for touching a point on the screen of the device 100 and dragging the touch leftward or rightward.

With reference to FIG. 12B, when the user input is received, the device 100 may display a virtual makeup image based on a color different from that of the color-based virtual makeup image shown in FIG. 12B.

In a case where a color-based virtual image provided by the device 100 corresponds to two images as shown in FIGS. 12A and 12B, when a user input for touching a point on the screen of the device 100 and dragging the touch rightward is received with reference to FIG. 12A, the device 100 may display the color-based virtual makeup image as shown in FIG. 12B. In addition, when a user input for touching a point on the screen of the device 100 and dragging the touch leftward is received with reference to FIG. 12A, the device 100 may display the color-based virtual makeup image as shown in FIG. 12B.

In a case where the color-based virtual image provided by the device 100 corresponds to the two images as shown in FIGS. 12A and 12B, when a user input for touching a point on the screen of the device 100 and dragging the touch leftward is received with reference to FIG. 12B, the device 100 may display the color-based virtual makeup image as shown in FIG. 12A. In addition, when a user input for touching a point on the screen of the device 100 and dragging the touch rightward is received with reference to FIG. 12B, the device 100 may display the color-based virtual makeup image as shown in FIG. 12A.

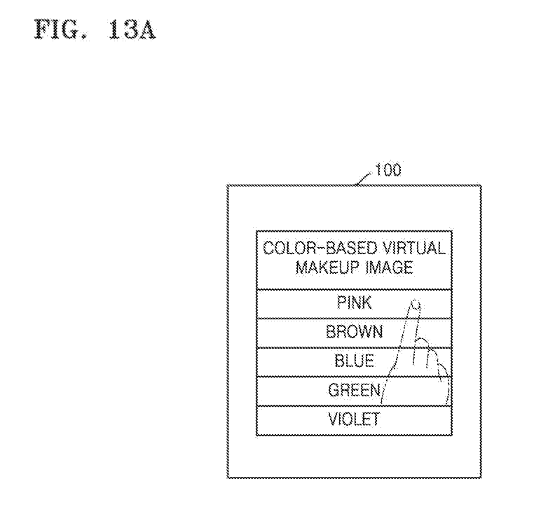

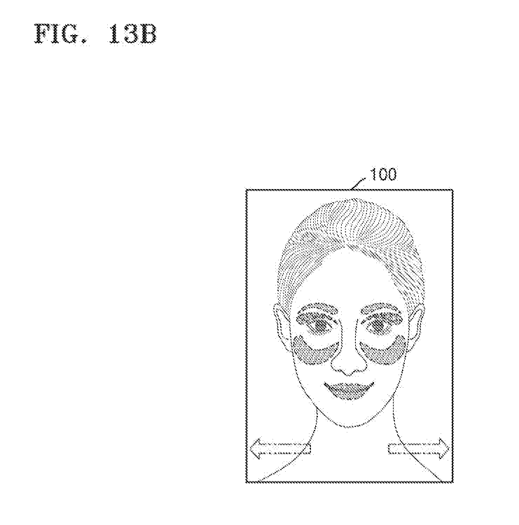

FIGS. 13A and 13B illustrate a makeup mirror of a device, which provides a color-based virtual makeup image, based on menu information according to various embodiments of the present disclosure.

Referring to FIG. 13A, the device 100 provides menu information about a color-based virtual makeup image that may be provided by the device 100. With reference to FIG. 13A, when a user input for selecting a pink item is received, the device 100 may provide a pink color-based virtual makeup image as shown in FIG. 13B.

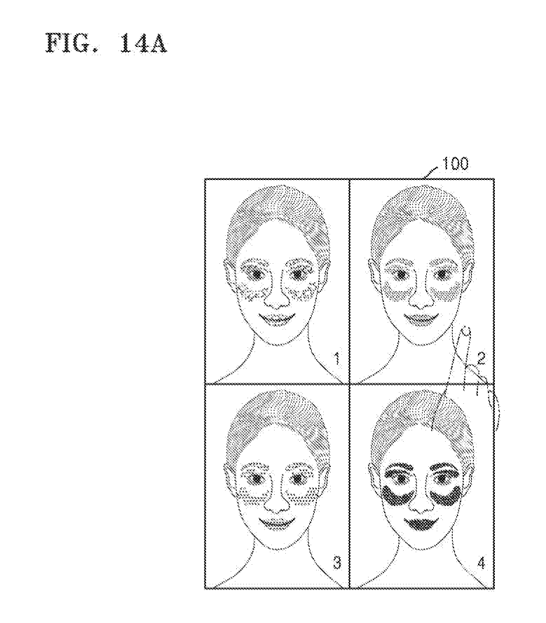

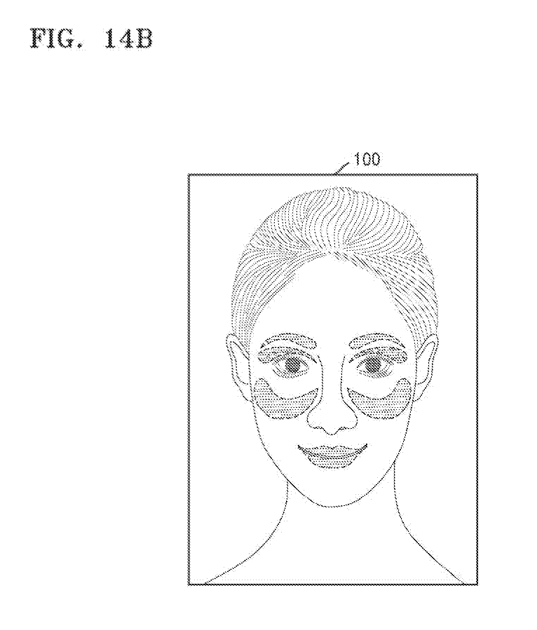

FIGS. 14A and 14B illustrate a makeup mirror of a device, which provides four color-based virtual makeup images in a split-screen form according to various embodiments of the present disclosure.

Referring to FIG. 14A, the device 100 provides the four color-based virtual makeup images. Referring to FIG. 14A, each of the four color-based virtual makeup images includes identification information (e.g., 1, 2, 3, or 4), but is not limited thereto. For example, each of the four color-based virtual makeup images may not include the identification information. The identification information with respect to each of the four color-based virtual makeup images is not limited to the aforementioned descriptions. For example, the identification information with respect to each of the four color-based virtual makeup images may be expressed as a symbol word (e.g., brown, pink, violet, blue, and the like) that symbolizes each of the four color-based virtual makeup images.

With reference to FIG. 14A, when a user input for touching a virtual makeup image (e.g., a virtual makeup image to which an identification number “2” is allocated) is received, the device 100 may magnify the selected virtual makeup image and may provide it on one screen as shown in FIG. 14B.

The virtual makeup images provided with reference to FIG. 14A may include an image irrelevant to a face image of a user. The virtual makeup image provided with reference to FIG. 14B is based on the face image of the user. Accordingly, before makeup, the user may check the face image of the user to which a user-selected color based virtual makeup is applied.

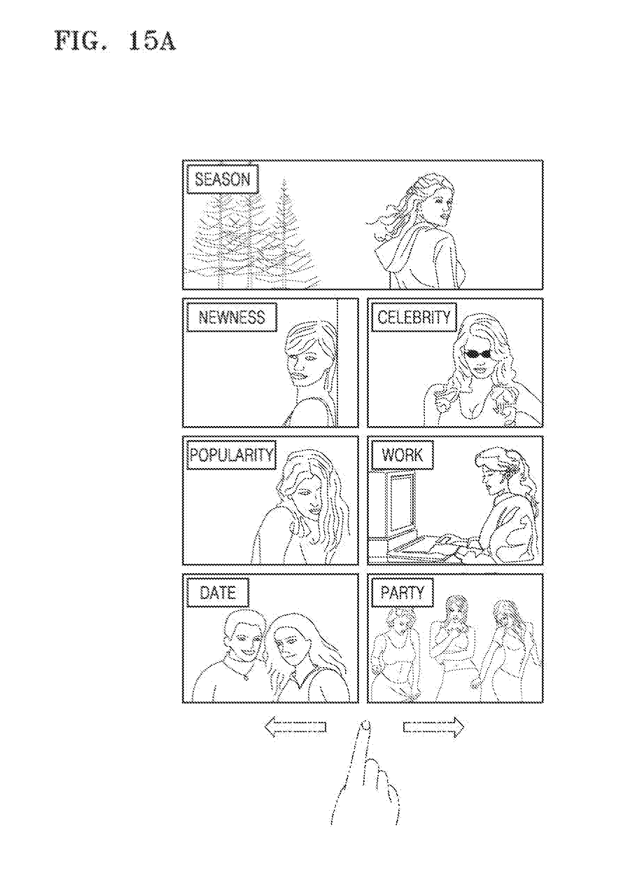

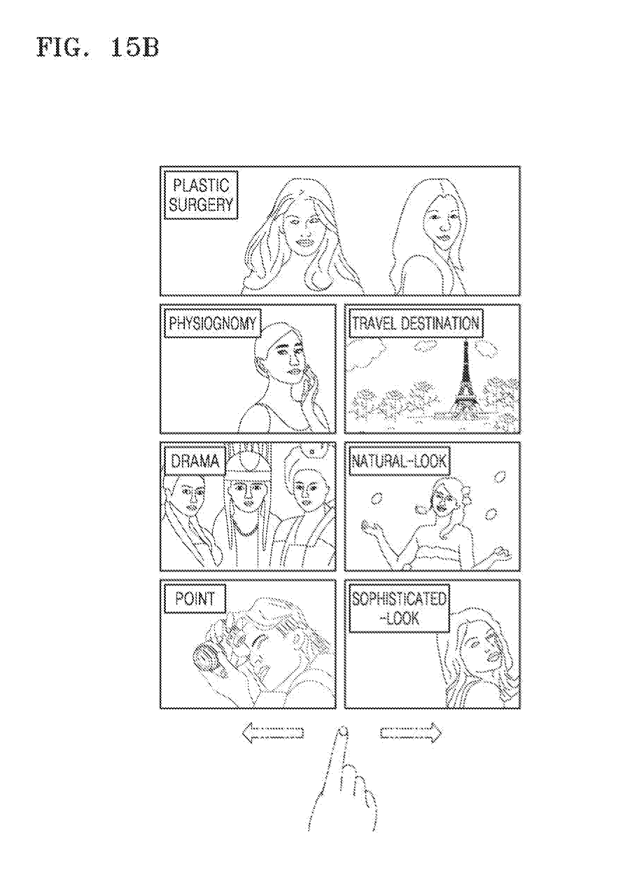

FIGS. 15A and 15B illustrate a makeup mirror of a device, which provides information about a theme-based virtual makeup image type according to various embodiments of the present disclosure.

Referring to FIG. 15A, the theme-based virtual makeup image type includes a season, newness, a celebrity, popularity, a work, a date, and a party.

With reference to FIG. 15A, when a user input for turning a page is received, the device 100 may provide information about another theme-based virtual makeup image type as shown in FIG. 15B. Referring to FIG. 15B, the information about the other theme-based virtual makeup image type includes themes, such as a plastic surgery, a physiognomy, a travel destination, a drama, a natural-look, and a sophisticated-look.

With reference to FIG. 15B, when a user input for turning a page is received, the device 100 may provide information about another theme-based virtual makeup image type.

The user input for turning a page may correspond to a request for information about another theme-based virtual makeup image type. In the present disclosure, a user input of the request for the information about another theme-based virtual makeup image type is not limited to the aforementioned user input for turning the page. For example, the user input of the request for the information about the other theme-based virtual makeup image type may include a device-based gesture, such as shaking the device 100.

The user input for turning a page may include a touch-based user input for touching one point and then dragging the touch toward one direction, but in the present disclosure, the user input for turning a page is not limited to the aforementioned descriptions.

With reference to FIG. 15A or 15B, when a user input for selecting a theme-based virtual makeup image type is received, the device 100 may provide makeup guide information based on the selected theme-based virtual makeup image type.

The selected theme-based virtual makeup image type (e.g., a season) may include a plurality of theme-based virtual makeup image types (e.g., spring, summer, fall, and winter) in a lower hierarchy.

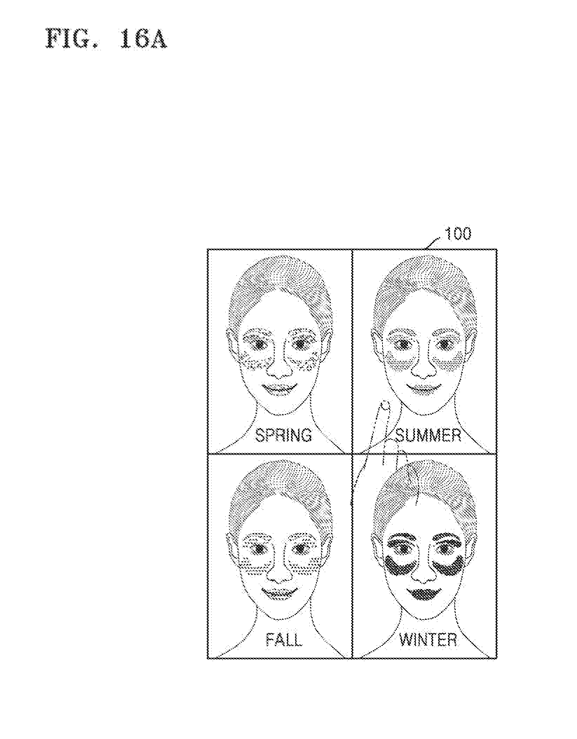

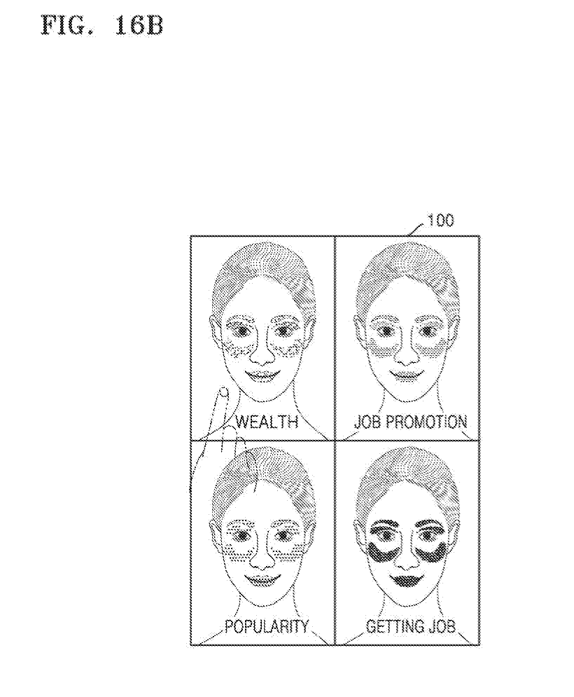

FIGS. 16A and 16B illustrate a makeup mirror of a device, which provides a plurality of theme-based virtual makeup image types that are registered in a lower hierarchy of a selected theme-based virtual makeup image type according to various embodiments of the present disclosure.

With reference to FIG. 15A, when a user input for selecting a season item is received, the device 100 may provide a plurality of virtual makeup image types as shown in FIG. 16A. With reference to FIG. 16A, the device 100 provides virtual makeup image types about spring, summer, fall, and winter in a split-screen form.

Referring to FIG. 16A, when the device 100 receives a user input for selecting a summer item, the device 100 may provide a virtual makeup image based on a face image of a user as shown in FIG. 1413. The user input for selecting a summer item may include a long-touch with respect to an area where the virtual makeup image of the summer item is displayed, but in the present disclosure, the user input for selecting a summer item is not limited to the aforementioned descriptions.

With reference to FIG. 15B, when a user input for selecting a physiognomy item is received, the device 100 may provide a plurality of virtual makeup image types as shown in FIG. 16B. Referring to FIG. 16B, the device 100 provides virtual makeup image types about wealth, job promotion, popularity, and getting a job in a split-screen form.

Referring to FIG. 16B, when a user input for selecting a wealth item is received, the device 100 may provide a virtual makeup image based on a face image of a user as shown in FIG. 14B. The user input for selecting a wealth item may include a long-touch with respect to an area where the virtual makeup image of the wealth item is displayed, but in the present disclosure, the user input is not limited to the aforementioned descriptions.

Referring to FIGS. 16A and 16B, the device 100 may provide a virtual makeup image type based on an image irrelevant to the face image of the user, but in the present disclosure, a method of providing the virtual makeup image type is not limited to the aforementioned descriptions. For example, with reference to FIGS. 16A and 1613, the device 100 may provide an image based on the face image of the user. In this regard, the provided image may include a face image of the user which is obtained in real-time, but the image provided in the present disclosure is not limited to the aforementioned descriptions. For example, the image provided in the present disclosure may include a pre-stored face image of the user.

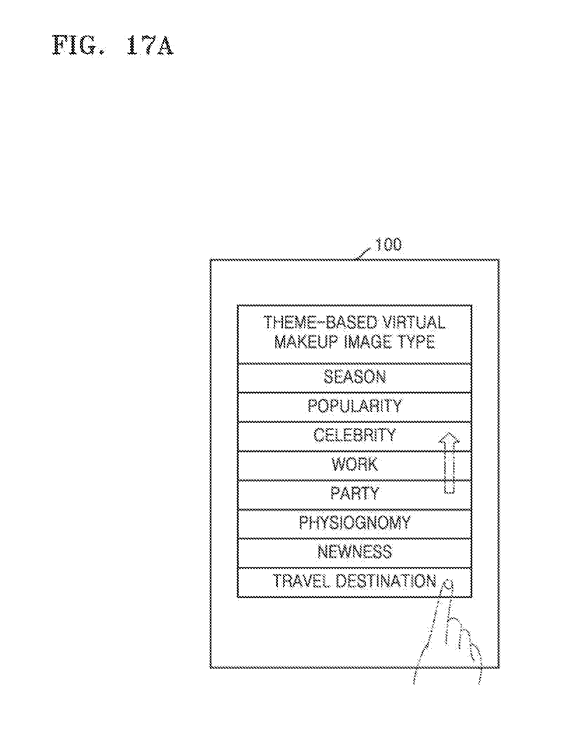

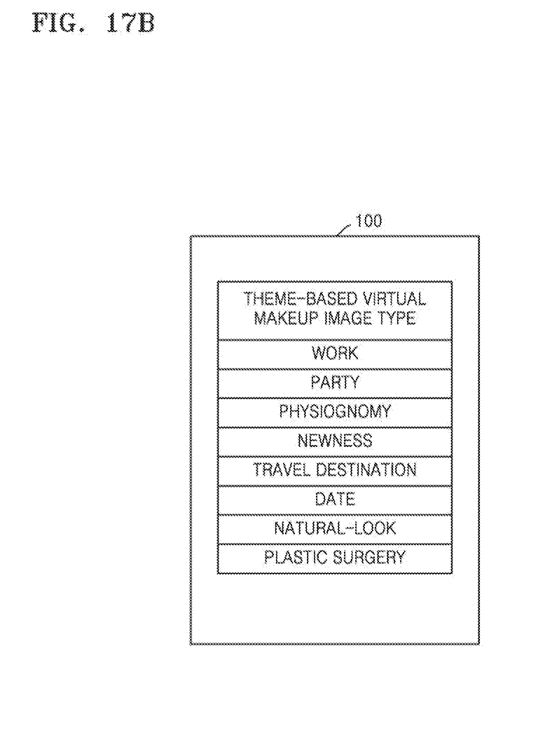

FIGS. 17A and 17B illustrate a makeup mirror of a device, which provides text-type (or list-type or menu-type) information about a theme-based virtual makeup image type according to various embodiments of the present disclosure.

Referring to FIG. 17A, when a user input for a scroll-up based on a list is received, the device 100 may change information about a theme-based virtual makeup image type and may provide the changed information as shown in FIG. 17B.

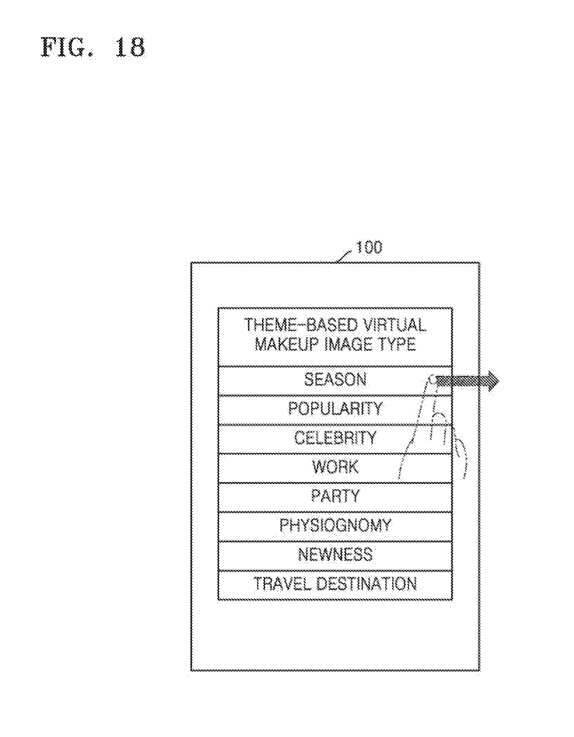

FIG. 18 illustrates a makeup mirror of a device, which provides a plurality of pieces of information about theme-based virtual makeup image types registered in a lower hierarchy since information about a theme-based virtual makeup image type is selected according to various embodiments of the present disclosure.

Referring to FIG. 18, the device 100 receives a user input for selecting a season item. The user input may include a touch and drag input with respect to an area where the season item is displayed, but in the present disclosure, the user input for selecting the season item is not limited to the aforementioned descriptions. When the user input for selecting the season item is received, the device 100 may provide, as shown in FIG. 16A, information about the plurality of theme-based virtual makeup image types (e.g., spring, summer, fall, and winter) registered in the lower hierarchy.

With reference to FIG. 16A, when a user input for selecting a summer item is received, the device 100 may provide a summer-based virtual makeup image. The virtual makeup image types provided with reference to FIG. 16A may include an image irrelevant to a face image of a user. The virtual makeup image types provided with reference to FIG. 16A may include the face image of the user. Since the user input for selecting a summer item is received with reference to FIG. 16A, the summer-based virtual makeup image provided by the device 100 may be based on the face image of the user.

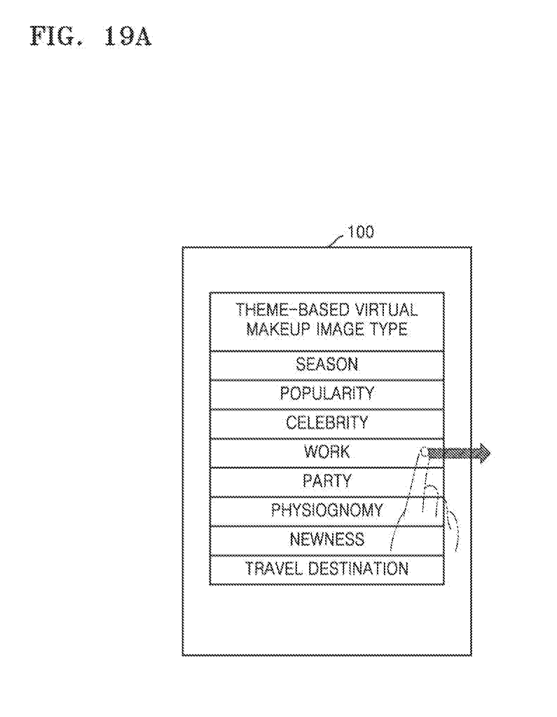

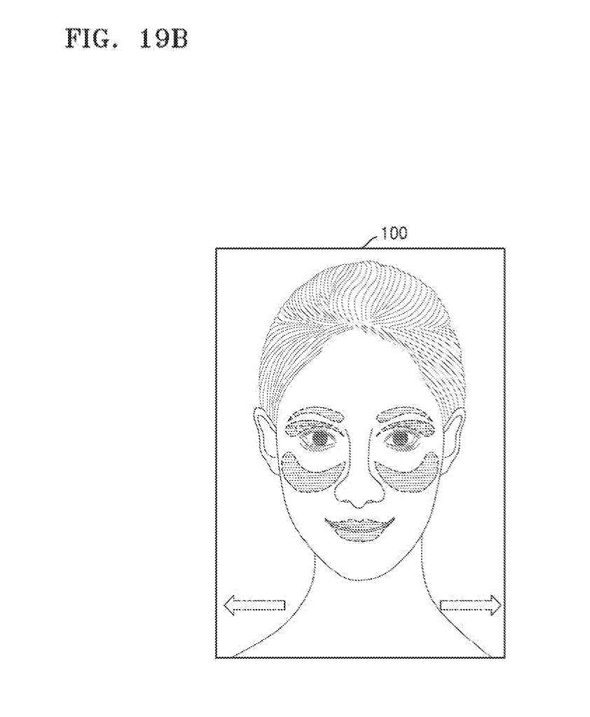

FIGS. 19A and 19B illustrate a makeup mirror of a device, which provides information about a theme-based virtual makeup image type selected when the information about a theme-based virtual makeup image type is selected according to various embodiments of the present disclosure.

Referring to FIG. 19A, when a user input for selecting a work item is received, the device 100 may provide a work-based virtual makeup image as shown in FIG. 19B.

Referring to FIG. 19B, the device 100 may provide the work-based virtual makeup image based on a face image of a user.

FIG. 19A corresponds to a case in which a plurality of theme-based virtual makeup image types about the work item are not registered in a lower hierarchy, but in the present disclosure, the lower hierarchy of the work item is not limited to the aforementioned descriptions. For example, in the present disclosure, the plurality of theme-based virtual makeup image types about the work item may be registered in the lower hierarchy of the work item. For example, a plurality of assigned tasks (e.g., an office work, a sales work, and the like) may be registered in the lower hierarchy of the work item.

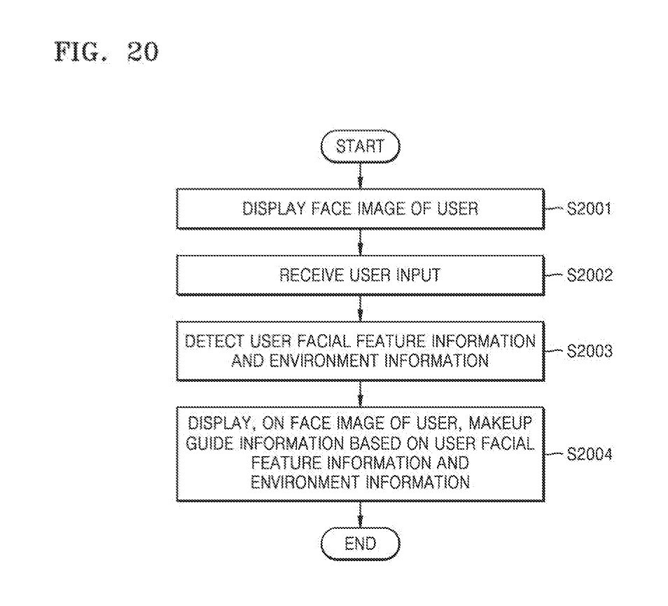

FIG. 20 is a flowchart of a method of providing a makeup mirror that displays makeup guide information on a face image of a user based on a facial feature of the user and environment information, the method being performed by a device according to various embodiments of the present disclosure.

Referring to FIG. 20, the method may be implemented by a computer program. For example, the method may be performed by using a makeup mirror application installed in the device 100. The computer program may operate in an OS installed in the device 100. The device 100 may write the computer program to a storage medium, and may use the computer program by reading the computer program from the storage medium.

In operation S2001 the device 100 may display a face image of a user. Accordingly, the user may view the face image of the user by using the device 100. The device 100 may display the obtained face image of the user in real-time. The device 100 may obtain the face image of the user by executing a camera application included in the device 100, and may display the obtained face image of the user.

In addition, the device 100 may establish a communication channel with an external device (e.g., a wearable device, such as a smart watch, a smart minor, a smartphone, a digital camera, an IoT device (e.g., a smart TV, a smart oven, etc.), and the like) that has a camera function. The device 100 may activate the camera function of the external device by using the established communication channel. The device 100 may receive the face image of the user which is obtained by using the camera function activated in the external device. The device 100 may display the received face image of the user. In this case, the user may view both the face images of the user simultaneously via the device 100 and the external device.

Before the user wears makeup, the face image of the user which is displayed on the device 100 as shown in FIGS. 1A and 1B may be the face image of the user which is selected by the user. The user may select one of face images of the user which are stored in the device 100. The user may select an image from among face images of the user which are stored in at least one external device connected with the device 100. The external device may be referred to as another device.

When the device 100 obtains the face image of the user, the device 100 may perform operation S2001. When the device 100 receives the face image of the user, the device 100 may perform operation S2001. For example, when the device 100 in a lock state receives the face image of the user from the other device, the device 100 may unlock the lock state and may perform operation S2001.

When the face image of the user is selected in the device 100, the device 100 may perform operation S2001. Since the device 100 according to various embodiments executes the makeup mirror application, the device 100 may obtain or receive the face image of the user.

In operation S2002, the device 100 may receive a user input for requesting a makeup guide with respect to the displayed face image of the user. The user input may be received based on the makeup guide button 101 that is displayed with the face image of the user as described with reference to FIG. 1A. As described with reference to FIG. 1A, the user input may be received based on the voice signal of the user. As described with reference to FIG. 1A, the user input may be received based on the touch.

The user input for requesting the makeup guide may be based on an operation related to the device 100. The operation related to the device 100 may include that, for example, the device 100 is placed on the makeup stand 1002. For example, when the device 100 is placed on the makeup stand 1002., the device 100 may recognize that the user input for requesting the makeup guide has been received.

In addition, a makeup guide request may be based on a user input performed by using an external device (e.g., a wearable device, such as a smart watch) connected with the device 100.

In operation S2003, the device 100 may detect user facial feature information based on the face image of the user. The device 100 may detect the user facial feature information by using a face recognition algorithm based on the face image. The device 100 may detect the user facial feature information by using a skin analysis algorithm.

The detected user facial feature information may include information about a face shape of the user. The detected user facial feature information may include information about an eyebrow shape of the user. The detected user facial feature information may include information about an eye shape of the user.

The detected user facial feature information may include information about a nose shape of the user. The detected user facial feature information may include information about a lips shape of the user. The detected user facial feature information may include information about a cheek shape of the user. The detected user facial feature information may include information about a forehead shape of the user.

The detected user facial feature information in the present disclosure is not limited to the aforementioned descriptions. For example, the detected user facial feature information may include user skip type information (e.g., a dry skin type, a normal skin type, and/or an oily skin type). The detected user facial feature information may include user skin condition information (e.g., information about a skin tone, pores, acne, skin pigmentation, dark circles, wrinkles, and the like).

In the present disclosure, the environment information may include season information. The environment information may include weather information (e.g., a sunny weather, a cloudy weather, a rainy weather, and/or a snowy weather). The environment information may include temperature information. The environment information may include humidity information (or dryness information). The environment information may include precipitation information. The environment information may include wind speed information.

The environment information may be provided via an environment information application installed in the device 100, but in the present disclosure, the environment information is not limited to the aforementioned descriptions. In the present disclosure, the environment information may be provided by an external device connected to the device 100. The external device may include an environment information providing server, a wearable device, an IoT device, or an appcessory, but in the present disclosure, the external device is not limited to the aforementioned descriptions. Here, the appcessory indicates a device (e.g., a moisture meter) capable of executing and controlling an application installed in the device 100.

In operation S2004, the device 100 may display, on the face image of the user, makeup guide information based on the user facial feature information and the environment information. As shown in FIG. 113, the device 100 may display the makeup guide information in a dotted-line form on the face image of the user. Therefore, the user may view the makeup guide information while the user views the face image of the user which is not obstructed by the makeup guide information.

In operation S2004, the device 100 may generate makeup guide information based on the user facial feature information, the environment information, and the reference makeup guide information described with reference to FIG. 1A.

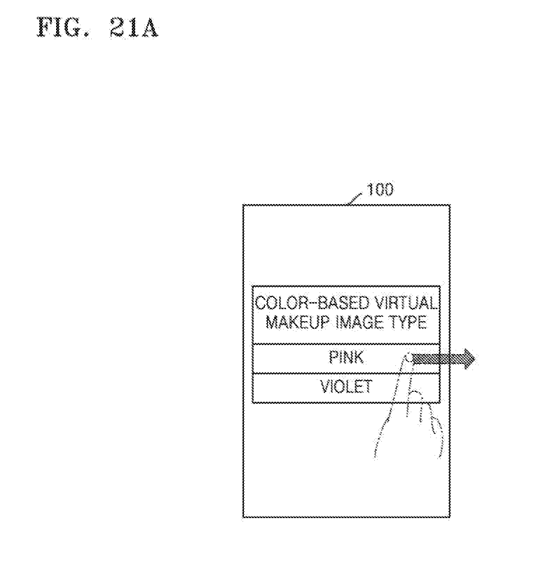

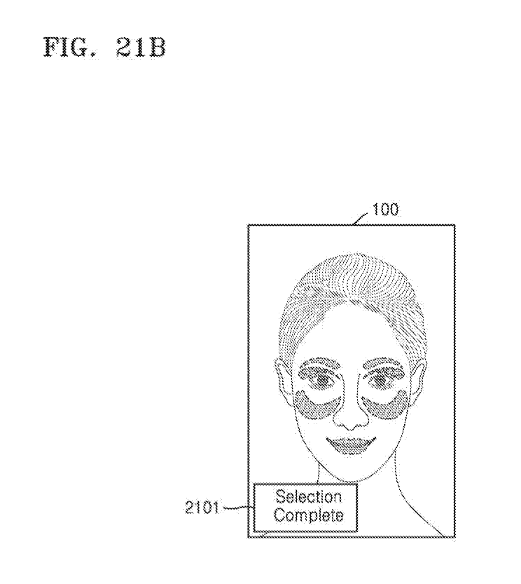

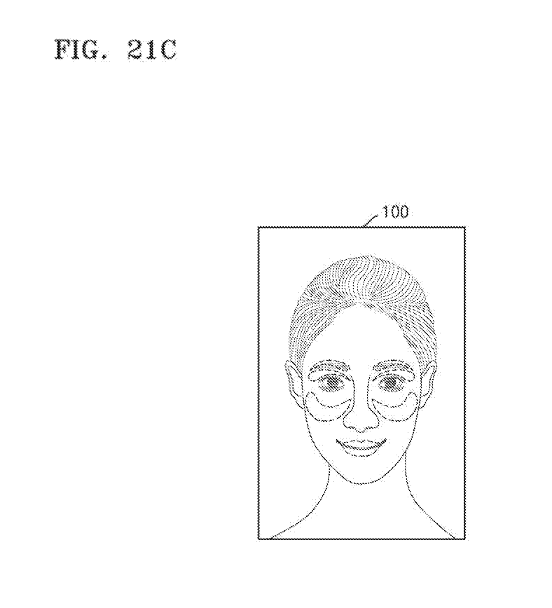

FIGS. 21A to 21C illustrate a makeup mirror of a device, which provides makeup guide information based on a color-based makeup image when environment information indicates spring according to various embodiments of the present disclosure.

Referring to FIG. 21A, since the environment information indicates spring, the device 100 provides a menu (or a list) of color-based virtual makeup image types related to spring. With reference to FIG. 21A, when a user input for selecting a pink item is received, the device 100 may provide a pink color-based virtual makeup image based on a face image of a user, as shown in FIG. 21B.

With reference to FIG. 21B, when a user input for selecting a selection complete button 2101 is received, the device 100 may display makeup guide information based on the virtual makeup image provided with reference to FIG. 21B, as shown in FIG. 21C.

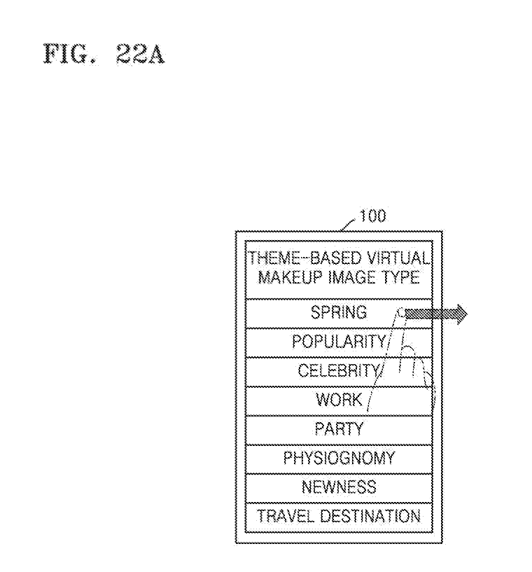

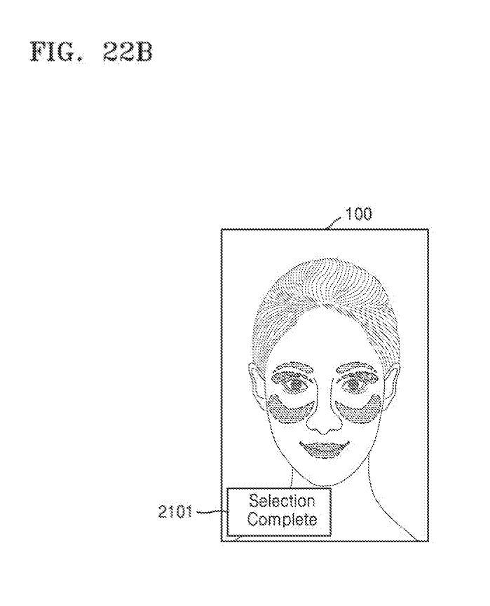

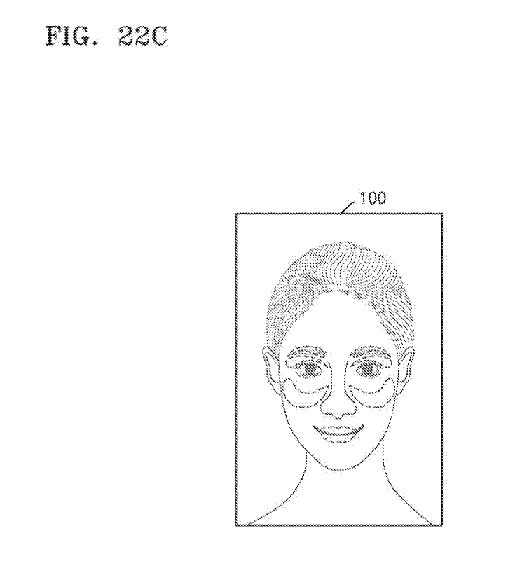

FIGS. 22A to 22C illustrate a makeup mirror of a device, which provides makeup guide information based on a theme-based virtual makeup image when environment information indicates spring according to various embodiments of the present disclosure.

Referring to FIG. 22A, since the environment information indicates spring, the device 100 provides a menu (or a list) of theme-based virtual makeup image types related to spring. With reference to FIG. 22A, when a user input for selecting a spring item is received, the device 100 may display a pink color-based virtual makeup image on a face image of a user as shown in FIG. 22B. The device 100 may provide, between FIGS. 22A and 22B, information about a color-based makeup image type as shown in FIG. 21A.

Referring to FIGS. 2213 and 22C, when a user input for selecting a selection complete button 2101 is received, the device 100 may display, as shown in FIG. 22C, makeup guide information based on the virtual makeup image provided with reference to FIG. 2213 on the face image of the user.

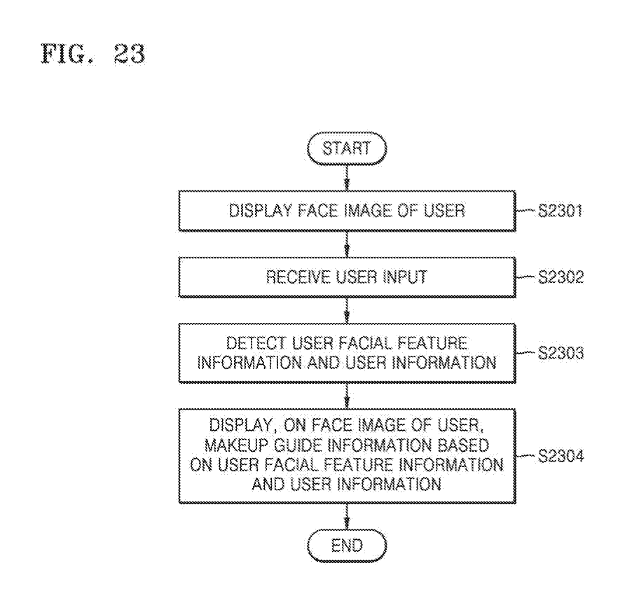

FIG. 23 is a flowchart of a method of providing a makeup mirror that displays makeup guide information on a face image of a user based on a facial feature of the user and user information, the method being performed by a device according to various embodiments of the present disclosure.

Referring to FIG. 23, the method may be implemented by a computer program. For example, the method may be performed by using a makeup mirror application installed in the device 100. The computer program may operate in an OS installed in the device 100. The device 100 may write the computer program to a storage medium, and may use the computer program by reading the computer program from the storage medium.

In operation S2301, the device 100 may display a face image of a user Accordingly, the user may view the face image of the user by using the device 100. The device 100 may display the obtained face image of the user in real-time.

The device 100 may obtain the face image of the user by executing a camera application included in the device 100, and may display the obtained face image of the user. In the present disclosure, a method of obtaining the face image of the user is not limited to the aforementioned descriptions.

For example, the device 100 may establish a communication channel with an external device (e.g., a wearable device, such as a smart watch, a smart mirror, a smartphone, a digital camera, an IoT device (e.g., a smart TV, a smart oven, etc. and the like) that has a camera function. The device 100 may activate the camera function of the external device by using the established communication channel. The device 100 may receive the face image of the user which is obtained by using the camera function activated in the external device. The device 100 may display the received face image of the user. In this case, the user may view both the face images of the user simultaneously via the device 100 and the external device.

Before the user wears makeup, the face image of the user which is displayed on the device 100 as shown in FIGS. 1A and 1B may be the face image of the user which is selected by the user. The user may select one of face images of the user which are stored in the device 100. The user may select an image from among face images of the user which are stored in at least one external device connected with the device 100. The external device may be referred to as another device.

When the device 100 obtains the face image of the user, the device 100 may perform operation S2301. When the device 100 receives the face image of the user, the device 100 may perform operation S2301. For example, when the device 100 in a lock state receives the face image of the user from the other device, the device 100 may unlock the lock state and may perform operation S2301.

When the face image of the user is selected in the device 100, the device 100 may perform operation S2301. Since the device 100 according to various embodiments of the present disclosure executes the makeup mirror application, the device 100 may obtain or receive the face image of the user.

In operation S2302, the device 100 may receive a user input for requesting a makeup guide with respect to the displayed face image of the user. The user input may be received by using the makeup guide button 101 that is displayed with the face image of the user as described with reference to FIG. 1A. As described with reference to FIG. 1A, the user input may be received by using the voice signal of the user. As described with reference to FIG. 1A, the user input may be received by using the touch.

The user input for requesting the makeup guide may be based on an operation related to the device 100. The operation related to the device 100 may include that, for example, the device 100 is placed on the makeup stand 1002. For example, when the device 100 is placed on the makeup stand 1002, the device 100 may recognize that the user input for requesting the makeup guide has been received.

In addition, a makeup guide request may be based on a user input performed by using an external device (e.g., a wearable device, such as a smart watch) connected with the device 100.

In operation S2303, the device 100 detects user facial feature information based on the face image of the user. The device 100 may detect the user facial feature information by using a face recognition algorithm based on the face image. The device 100 may detect the user facial feature information by using a skin analysis algorithm.

The detected user facial feature information may include information about a face shape of the user. The detected user facial feature information may include information about an eyebrow shape of the user. The detected user facial feature information may include information about an eye shape of the user.

The detected user facial feature information may include information about a nose shape of the user. The detected user facial feature information may include information about a lips shape of the user. The detected user facial feature information may include information about a cheek shape of the user. The detected user facial feature information may include information about a forehead shape of the user.

The detected user facial feature information in the present disclosure is not limited to the aforementioned descriptions. For example, the detected user facial feature information may include the user skip type information (e.g., a dry skin type, a normal skin type, and/or an oily skin type). The detected user facial feature information may include user skin condition information (e.g., information about a skin tone, pores, acne, skin pigmentation, dark circles, wrinkles, and the like).

In the present disclosure, the user information may include age information of the user. The user information may include gender information of the user. The user information may include race information of the user. The user information may include user skin information input by the user. The user information may include hobby information of the user.

In the present disclosure, the user information may include preference information of the user. The user information may include job information of the user. The user information may include schedule information of the user. The schedule information of the user may include exercise time information of the user. The schedule information of the user may include information about a user's visit time for dermatology and treatment details in the dermatology. In the present disclosure, the schedule information of the user is not limited to the aforementioned descriptions,

In the present disclosure, the user information may be provided via a user information managing application installed in the device 100, but in the present disclosure, a method of providing the user information is not limited to the aforementioned descriptions. The user information managing application may include a life log application. The user information managing application may include an application corresponding to a personal information management system (HMS). The user information managing application is not limited to the aforementioned descriptions.

In the present disclosure, the user information may be provided by an external device connected to the device 100. The external device may include a user information managing server, a wearable device, an IoT device, or an appcessory, but in the present disclosure, the external device is not limited to the aforementioned descriptions.

In operation S2304, the device 100 may display, on the face image of the user, makeup guide information based on the user facial feature information and the user information. As shown in FIG. 1B, the device 100 may display the makeup guide information in a dotted-line form on the face image of the user. Therefore, the user may view the makeup guide information while the user views the face image of the user which is not obstructed by the makeup guide information.

In operation S2304, the device 100 may generate makeup guide information based on the user facial feature information, the user information, and the reference makeup guide information described with reference to FIG. 1A,

In operation S2304, the device 100 may provide makeup guide information differing in a case where the user is a man and a case where the user is a woman. When the user is the man, the device 100 may display skin improvement-based makeup guide information on the face image of the user.

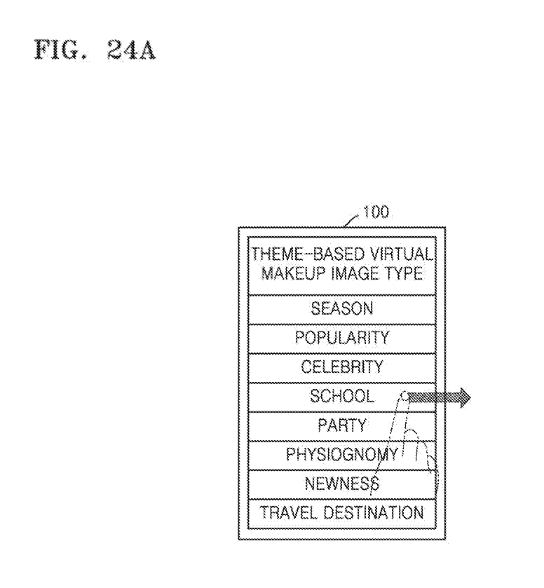

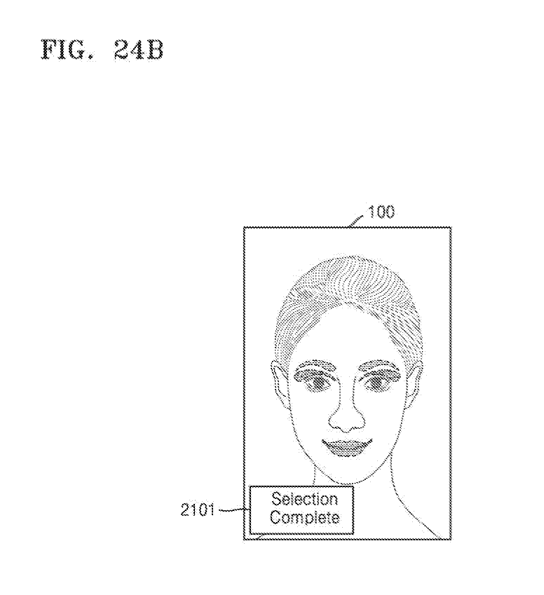

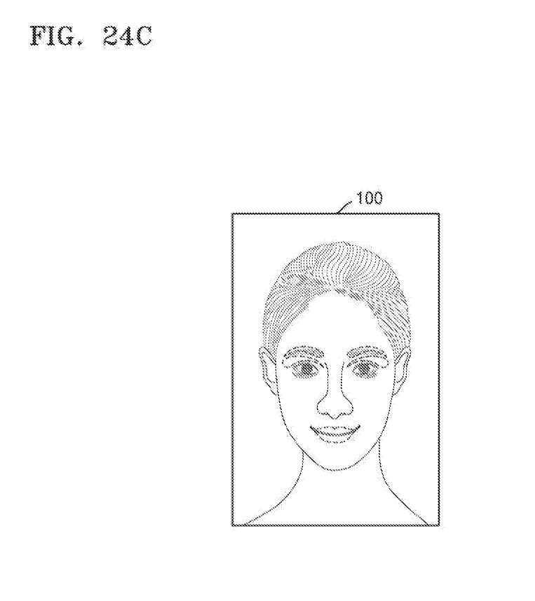

FIGS. 24A to 4C illustrate a makeup mirror of a device, which provides a theme-based virtual makeup image when a user is a student according to various embodiments of the present disclosure.

Referring to FIG. 24A, since an occupation of the user is the student, the device 100 may provide menu information about theme-based virtual makeup image types including a school item instead of a work item.

Referring to FIG. 24A, when a user input for selecting the school item is received, the device 100 may provide a virtual makeup image with a less makeup to a face image of the user as shown in FIG. 24B. With reference to FIG. 24B, the device 100 may provide a skin improvement makeup image.

Referring to FIGS. 24B and 24C, when a user input for selecting the selection complete button 2101 is received, the device 100 may display, on the face image of the user as shown in FIG. 24C, makeup guide information based on the virtual makeup image provided with reference to FIG. 24B.

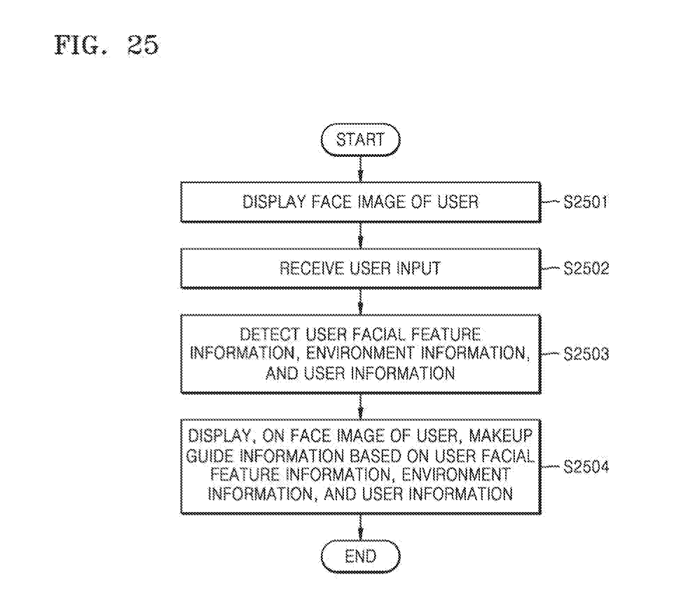

FIG. 25 is a flowchart of a method of providing a makeup mirror that displays makeup guide information on a face image of a user based on a facial feature of the user, environment information, and user information, the method being performed by a device according to various embodiments of the present disclosure.

Referring to FIG. 25, the method may be implemented by a computer program. For example, the method may be performed by using a makeup mirror application installed in the device 100. The computer program may operate in an OS installed in the device 100. The device 100 may write the computer program to a storage medium, and may use the computer program by reading the computer program from the storage medium.

In operation S2501, the device 100 may display a face image of a user. Accordingly, the user may view the face image of the user by using the device 100. The device 100 may display the obtained face image of the user in real-time. The device 100 may obtain the face image of the user by executing a camera application included in the device 100, and may display the obtained face image of the user. In the present disclosure, a method of obtaining the face image of the user is not limited to the aforementioned descriptions.

For example, the device 100 may establish a communication channel with an external device (e.g., a wearable device, such as a smart watch, a smart mirror, a smartphone, a digital camera, an IoT device (e.g., a smart TV, a smart oven, etc.), and the like) that has a camera function. The device 100 may activate the camera function of the external device by using the established communication channel. The device 100 may receive the face image of the user which is obtained by using the camera function activated in the external device. The device 100 may display the received face image of the user. In this case, the user may view both the face images of the user simultaneously via the device 100 and the external device.

Before the user wears makeup, the face image of the user which is displayed on the device 100 as shown in FIGS. 1A and 1B may be the face image of the user which is selected by the user. The user may select one of face images of the user which are stored in the device 100. The user may select an image from among face images of the user which are stored in at least one external device connected with the device 100. The external device may be referred to as another device.

When the device 100 obtains the face image of the user, the device 100 may perform operation S2501. When the device 100 receives the face image of the user, the device 100 may perform operation S2501. For example, when the device 100 in a lock state receives the face image of the user from the other device, the device 100 may unlock the lock state and may perform operation S2501.

When the face image of the user is selected in the device 100, the device 100 may perform operation S2501. Since the device 100 according to various embodiments executes the makeup mirror application, the device 100 may obtain or receive the face image of the user.

In operation S2502, the device 100 may receive a user input for requesting a makeup guide with respect to the displayed face image of the user. The user input may be received based on the makeup guide button 101 that is displayed with the face image of the user as described with reference to FIG. 1A. As described with reference to FIG. 1A, the user input may be received based on the voice signal of the user. As described with reference to FIG. 1A, the user input may be received based on the touch.

The user input for requesting the makeup guide may be based on an operation related to the device 100 The operation related to the device 100 may include that, for example, the device 100 is placed on the makeup stand 1002. For example, when the device 100 is placed on the makeup stand 1002, the device 100 may recognize that the user input for requesting the makeup guide has been received.

In addition, a makeup guide request may be based on a user input performed by using an external device (e.g., a wearable device, such as a smart watch) connected with the device 100.

In operation S2503, the device 100 detects user facial feature information based on the face image of the user. The device 100 may detect the user facial feature information by using a face recognition algorithm based on the face image.

The detected user facial feature information may include information about a face shape of the user. The detected user facial feature information may include information about an eyebrow shape of the user. The detected user facial feature information may include information about an eye shape of the user.

The detected user facial feature information may include information about a nose shape of the user. The detected user facial feature information may include information about a lips shape of the user. The detected user facial feature information may include information about a cheek shape of the user. The detected user facial feature information may include information about a forehead shape of the user.

The detected user facial feature information in the present disclosure is not limited to the aforementioned descriptions. For example, the detected user facial feature information may include user skip type information (e.g., a dry skin type, a normal skin type, and/or an oily skin type). The detected user facial feature information may include user skin condition information (e.g., information about a skin tone, pores, acne, skin pigmentation, dark circles, wrinkles, and the like).

In the present disclosure, the environment information may include season information. The environment information may include weather information e.g., a sunny weather, a cloudy weather, a rainy weather, a snowy weather, and the like). The environment information may include temperature information. The environment information may include humidity information (or dryness information). The environment information may include precipitation information. The environment information may include wind speed information.

The environment information may be provided via an environment information application installed in the device 100, but in the present disclosure, the environment information is not limited to the aforementioned descriptions. In the present disclosure, the environment information may be provided by an external device connected to the device 100. The external device may include an environment information providing server, a wearable device, an IoT device, or an appcessory, but in the present disclosure, the external device is not limited to the aforementioned descriptions.

In the present disclosure, the user information may include age information of the user. In the present disclosure, the user information may include gender information of the user. In the present disclosure, the user information may include race information of the user. In the present disclosure, the user information may include user skin information input by the user. In the present disclosure, the user information may include hobby information of the user. In the present disclosure, the user information may include preference information of the user. In the present disclosure, the user information may include job information of the user.

In the present disclosure, the user information may be provided via a user information managing application installed in the device 100, but in the present disclosure, a method of providing the user information is not limited to the aforementioned descriptions. The user information managing application may include a life log application. The user information managing application may include an application corresponding to a RIMS. The user information managing application is not limited to the aforementioned descriptions.

In the present disclosure, the user information may be provided by an external device connected to the device 100. The external device may include a user information managing server, a wearable device, an IoT device, or an appcessory, but in the present disclosure, the external device is not limited to the aforementioned descriptions.

In operation S2504, the device 100 may display, on the face image of the user, makeup guide information based on the user facial feature information, the environment information, and the user information. As shown in FIG. 1B, the device 100 may display the makeup guide information in a dotted-line form on the face image of the user. Therefore, the user may view the makeup guide information while the user views the face image of the user which is not obstructed by the makeup guide information.

In operation S2504, the device 100 may generate makeup guide information based on the user facial feature information, the environment information, the user information, and the reference makeup guide information described with reference to FIG. 1A.

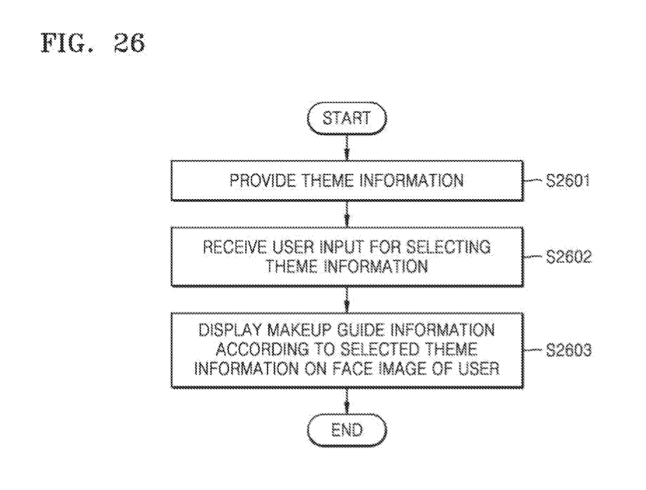

FIG. 26 is a flowchart of a method of providing a makeup mirror that displays theme-based makeup guide information, the method being performed by a device according to various embodiments of the present disclosure.

Referring to FIG. 26, the method may be implemented by a computer program. For example, the method may be performed by using a makeup mirror application installed in the device 100. The computer program may operate in an OS installed in the device 100. The device 100 may write the computer program to a storage medium, and may use the computer program by reading the computer program from the storage medium.

In operation S2601, the device 100 provides theme information. The theme information may be previously set in the device 100. The theme information may include information based on a season (e.g., spring, summer, fall, and/or winter). The theme information may include information based on popularities (e.g., a user's preference, a preference of a user's acquaintance, a current trend, a theme of a currently popular blog, and the like).

In the present disclosure, the theme information may include celebrity information. In the present disclosure, the theme information may include work information. In the present disclosure, the theme information may include date information. In the present disclosure, the theme information may include party information.

In the present disclosure, the theme information may include information about travel destinations (e.g., seas, mountains, historic sites, and the like). In the present disclosure, the theme information may include newness (or most recentness) information. In the present disclosure, the theme information may include physiognomy information to promote good fortune (e.g., fortune in wealth, fortune in job promotion, fortune in popularity, fortune in getting jobs, fortune in passing a test, fortune in marriage, and the like).

In the present disclosure, the theme information may include natural-look information. In the present disclosure, the theme information may include sophisticated-look information. In the present disclosure, the theme information may include information based on points (e.g., eyes, a nose, lips, and/or cheeks). In the present disclosure, the theme information may include drama information.

In the present disclosure, the theme information may include movie information. In the present disclosure, the theme information may include plastic surgery information (e.g., an eye plastic surgery, a chin plastic surgery, a lips plastic surgery, a nose plastic surgery, and/or a cheek plastic surgery). In the present disclosure, the theme information is not limited to the aforementioned descriptions.

In the present disclosure, the theme information may be provided as a text-based list. In the present disclosure, the theme information may be provided as an image-based list. In the present disclosure, an image included in the theme information may be formed as an icon, a representative image, or a thumbnail image, but the image included in the theme information is not limited to the aforementioned descriptions.

An external device connected to the device 100 may provide the theme information to the device 100. In response to a request from the device 100, the external device may provide the theme information to the device 100. Regardless of the request from the device 100, the external device may provide the theme information to the device 100.

When a detection result (e.g., when a display with respect to the face image of the user is detected) by the device 100 is transmitted to the external device, the external device may provide the theme information to the device 100. In the present disclosure, a condition for providing the theme information is not limited to the aforementioned descriptions.

In operation S2602, the device 100 may receive a user input for selecting the theme information. The user input may include a touch-based user input. The user input may include a user's voice signal-based user input. The user input may include an external device-based user input. The user input may include a user's gesture-based user input. The user input may include a user input based on an operation by the device 100.

In operation S2603, the device 100 may display makeup guide information according to the selected theme information on the face image of the user.

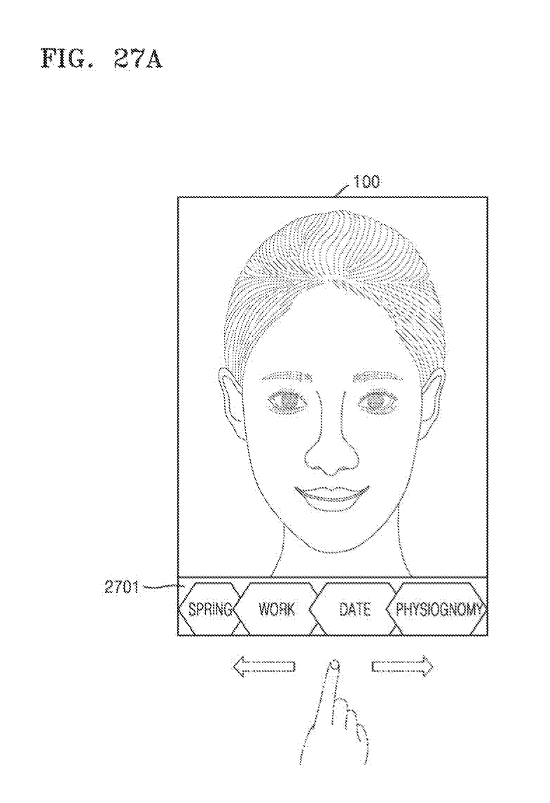

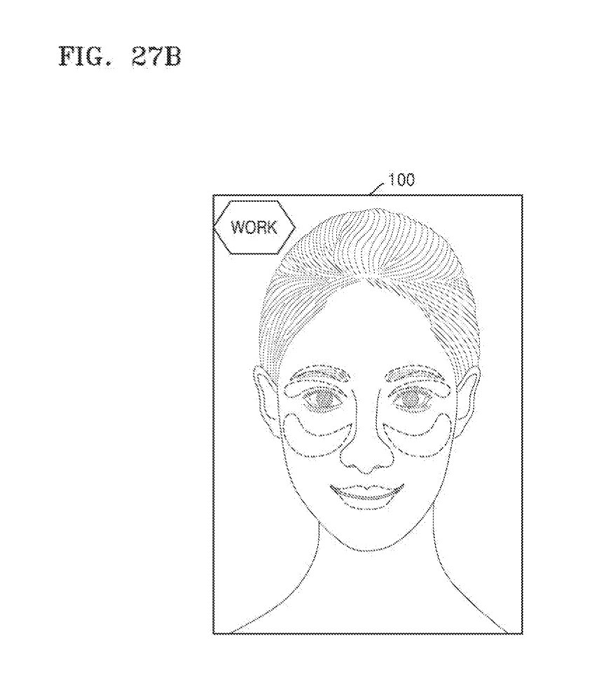

FIGS. 27A and 27B illustrate a makeup mirror of a device, which provides theme information and provides makeup guide information based on the selected theme information according to various embodiments of the present disclosure.

Referring to FIG. 27A, the device 100 opens a theme tray 2701 on a screen of the device 100 on which a face image of a user is displayed. The theme tray 2701 may be open according to a user input. The user input to open the theme tray 2701 may include an input for touching a lowermost left corner of the screen of the device 100 and dragging the touch rightward. Alternatively, the user input to open the theme tray 2701 may include an input for touching a point of a lowermost part of the screen of the device 100 and dragging the point toward an upper part of the screen of the device 100. Alternatively, the user input to open the theme tray 2701 may include an input for touching a lowermost right corner of the screen of the device 100 and dragging the touch leftward. In the present disclosure, the user input to open the theme tray 2701 is not limited to the aforementioned descriptions.

Referring to FIG. 27B, the device 100 may provide, via the theme tray 2701, the theme information described in operation S2601. When a user input for touching a point of the open theme tray 2701 and dragging the touch leftward or rightward is received, the device 100 may display a plurality of pieces of theme information included in the theme tray 2701 while the device 100 leftward or rightward scrolls the plurality of pieces of theme information included in the theme tray 2701. Accordingly, the user may view various types of theme information.

Referring to FIG. 27A, when a user input for selecting a work item is received, the device 100 may display work-based makeup guide information as shown in FIG. 27B on the face image of the user.

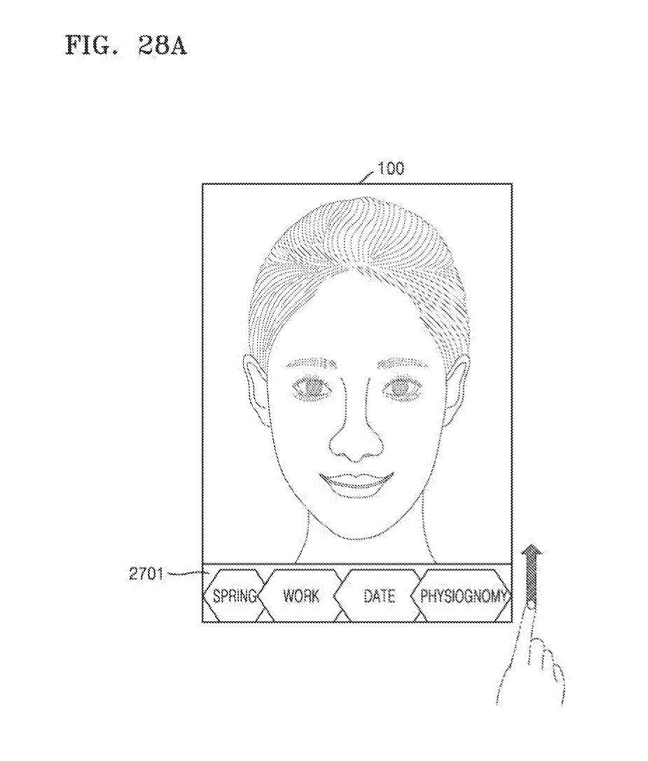

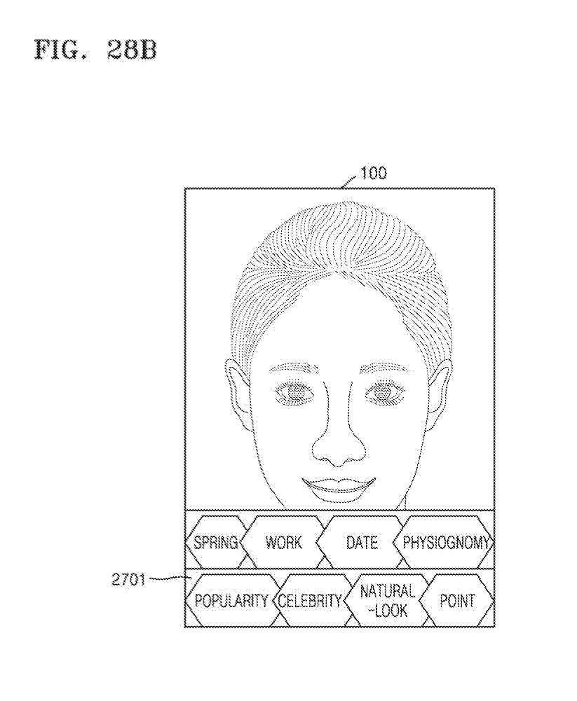

FIGS. 28A and 28B illustrate a makeup mirror of a device, which provides theme information based on a theme tray according to various embodiments of the present disclosure.

Referring to FIGS. 28A and 28B, when a user input for touching the open theme tray 2701 and then dragging the touch upward on a screen of the device 100 is received, the device 100 may extend an open area of the theme tray 2701 as shown in FIG. 28B so as to further display another theme information. In the present disclosure, the theme information may be referred to as a theme item.

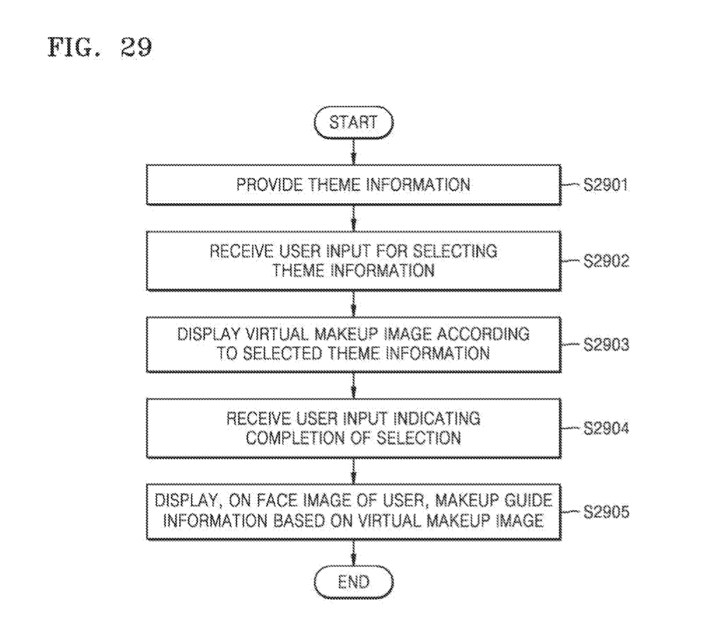

FIG. 29 is a flowchart of a method of providing a makeup mirror that displays makeup guide information based on a theme-based virtual makeup image, the method being performed by a device according to various embodiments of the present disclosure.

Referring to FIG. 29, the method may be implemented by a computer program. For example, the method may be performed by using a makeup mirror application installed in the device 100. The computer program may operate in an OS installed in the device 100. The device 100 may write the computer program to a storage medium, and may use the computer program by reading the computer program from the storage medium.

In operation S2901, the device 100 may provide theme information. The theme information may be previously set in the device 100. The theme information may include information based on a season (e.g., spring, summer, fall, and/or winter). The theme information may include information based on popularities (e.g., a user's preference, a preference of a user's acquaintance, a current trend, a theme of a currently popular blog, and the like).

In the present disclosure, the theme information may include celebrity information. In the present disclosure, the theme information may include work information. In the present disclosure, the theme information may include date information. In the present disclosure, the theme information may include party information.

In the present disclosure, the theme information may include information about travel destinations (e.g., seas, mountains, historic sites, and the like). In the present disclosure, the theme information may include newness (or most recentness) information. In the present disclosure, the theme information may include physiognomy information to promote good fortune (e.g., fortune in wealth, fortune in job promotion, fortune in popularity, fortune in getting jobs, fortune in passing a test, fortune in marriage, and the like).

In the present disclosure, the theme information may include natural-look information. In the present disclosure, the theme information may include sophisticated-look information. In the present disclosure, the theme information may include information based on points (e.g., eyes, a nose, lips, and/or cheeks). In the present disclosure, the theme information may include drama information.

In the present disclosure, the theme information may include movie information. In the present disclosure, the theme information may include plastic surgery information (e.g., an eye plastic surgery, a chin plastic surgery, a lips plastic surgery, a nose plastic surgery, and/or a cheek plastic surgery). In the present disclosure, the theme information is not limited to the aforementioned descriptions.

In the present disclosure, the theme information may be provided as a text-based list. In the present disclosure, the theme information may be provided as an image-based list. In the present disclosure, an image included in the theme information may be formed as an icon, a representative image, or a thumbnail image.

In operation S2902, the device 100 may receive a user input for selecting the theme information. The user input may include a touch-based user input. The user input may include a user's voice signal-based user input. The user input may include an external device-based user input. The user input may include a user's gesture-based user input. The user input may include a user input based on an operation by the device 100.

In operation S2903, the device 100 may display a virtual makeup image according to the selected theme information. The virtual makeup image may be based on a face image of a user.

In operation S2904, the device 100 may receive a user input for informing completion of selection. The user input for informing completion of selection may be based on a touch with respect to a button displayed on the screen of the device 100. The user input for informing completion of selection may be based on a user's voice signal. The user input for informing completion of selection may be based on a gesture by the user. The user input for informing completion of selection may be based on an operation of the device 100.

In operation S2905, since the user input is received in operation S2904, the device 100 may display, on the face image of the user, makeup guide information based on the virtual makeup image.

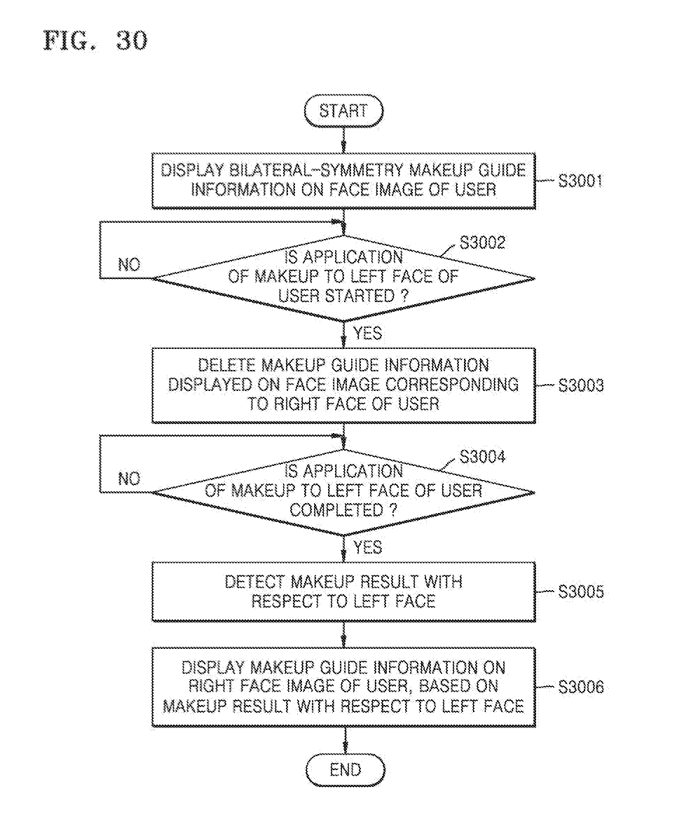

FIG. 30 is a flowchart of a method of providing a makeup mirror that displays bilateral-symmetry makeup guide information with respect to a face image of a user, the method being performed by a device according to various embodiments of the present disclosure.

Referring to FIG. 30, the method may be implemented by a computer program. For example, the method may be performed by using a makeup mirror application installed in the device 100. The computer program may operate in an OS installed in the device 100. The device 100 may write the computer program to a storage medium, and may use the computer program by reading the computer program from the storage medium.

In operation S3001, the device 100 may display, on the face image of the user, the bilateral-symmetry makeup guide information according to a bilateral symmetry reference line (hereinafter, referred to as the reference line) based on the face image of the user. The reference line may be a straight line from a forehead of the user through a tip of a nose to a chin line, but in the present disclosure, the reference line is not limited to the aforementioned descriptions. In the present disclosure, the reference line may be displayed on the face image of the user but is not limited thereto. For example, in the present disclosure, the reference line may not be displayed on the face image of the user but may be managed by the device 100.

The device 100 may determine whether to display the reference line, according to a user input. For example, when a touch-based user input with respect to a nose included in the displayed face image of the user is received, the device 100 may display the reference line. While the reference line is displayed on the displayed face image of the user, when a touch-based user input with respect to the reference line is received, the device 100 may not display the reference line. Here, an operation of not displaying the reference line may correspond to an operation of hiding the reference line.

In operation S3002, when application of makeup to a left face of the user is started, in operation S3003, the device 100 may delete makeup guide information displayed on the displayed face image corresponding to a right face of the user.

The device 100 may detect movement of a makeup tool on the face image of the user which is obtained or is received in real-time, so that the device 100 may determine whether the application of the makeup to the left face of the user is started, but in the present disclosure, a method of determining whether the application of the makeup to the left face of the user is started is not limited to the aforementioned descriptions.

For example, the device 100 may determine whether the application of the makeup to the left face of the user is started, by detecting an end portion of the makeup tool on the face image of the user which is obtained or is received in real-time.

In addition, the device 100 may determine whether the application of the makeup to the left face of the user is started, by detecting the end portion of the makeup tool and movement of the makeup tool on the face image of the user which is obtained or is received in real-time.

In addition, the device 100 may determine whether the application of the makeup to the left face of the user is started, by detecting a tip portion of a finger and movement of the finger on the face image of the user which is obtained or is received in real-time.

In operation S3004, when the application of the makeup to the left face of the user is completed, in operation S3005, the device 100 may detect a result of the application of the makeup to the left face of the user.

For example, the device 100 may compare, based on the reference line, a left face image with a right face image of the face image of the user which is captured in real-time by using a camera. According to a result of the comparison, the device 100 may detect the makeup result with respect to the left face. The makeup result with respect to the left face may include makeup area information based on chrominance information in units of pixels. In the present disclosure, a method of detecting the makeup result with respect to the left face is not limited to the aforementioned descriptions.

In operation S3006, the device 100 may display makeup guide information on the right face image of the user, based on the makeup result with respect to the left face which is detected in operation S3005. In operation S3006, the device 100 may adjust the makeup result with respect to the left face, which is detected in operation S3005, according to the right face image of the user. An operation of adjusting the makeup result with respect to the left face, which is detected in operation S3005, according to the right face image of the user may indicate an operation of converting the makeup result with respect to the left face to the makeup guide information about the right face image of the user.

In operation S3006, the device 100 may generate the makeup guide information about the right face image of the user, based on the makeup result with respect to the left face which is detected in operation S3005.

The user may apply makeup to a right face, based on the makeup guide information that the device 100 displays on the right face image of the user.

The method described with reference to FIG. 30 may be changed to display makeup guide information about the left face image of the user, based on a makeup result with respect to the right face of the user.

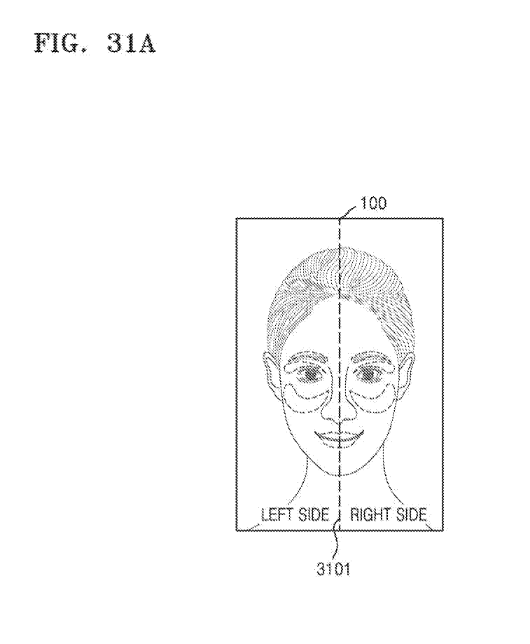

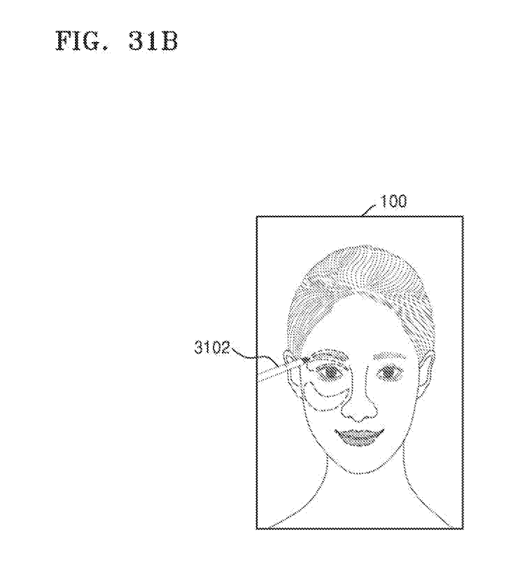

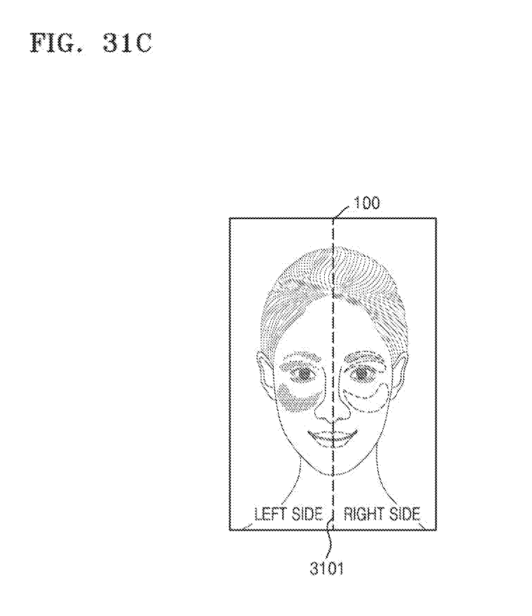

FIGS. 31A to 31C illustrate a makeup mirror of a device, which displays a plurality of pieces of bilateral-symmetry makeup guide information based on a bilateral symmetry reference line (hereinafter, referred to as the reference line) according to various embodiments of the present disclosure.

Referring to FIG. 31A, the device 100 displays left-side makeup guide information and right-side makeup guide information on a face image of a user, according to a reference line 3101 with respect to the displayed face image of the user. With reference to FIG. 31A, a left side and a right side are determined with respect to the user who sees the device 100. The reference line 3101 may not be displayed on the face image of the user.

Referring to FIG. 31B, when an end of a makeup tool (e.g., a makeup brush) 3102 and/or movement of the makeup tool 3102 is detected from a left face image of the user, the device 100 may maintain a display status with respect to makeup guide information displayed on the left face image of the user, and may delete makeup guide information displayed on a right face image of the user.

Referring to FIG. 31C, when the application of the makeup to the left face of the user is completed, the device 100 may detect makeup information about the left face from the left face image of the user, based on the reference line 3101. The device 100 may change the detected makeup information about the left face to makeup guide information about the right face image of the user. The device 100 may display, on the right face image of the user, the makeup guide information about the right face image of the user.

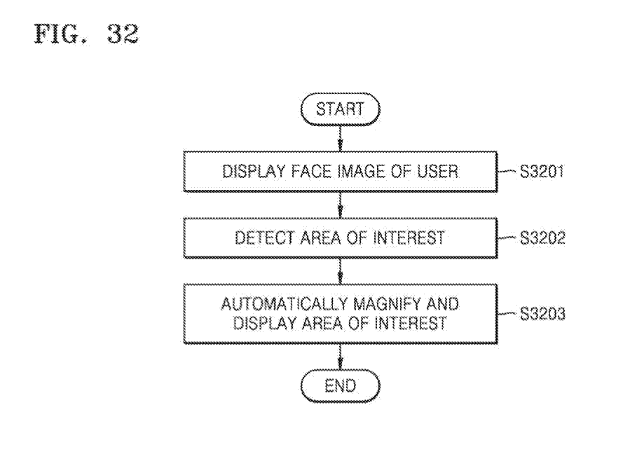

FIG. 32 is a flowchart of a method of providing a makeup mirror that detects an area of interest from a face image of the user and magnifies the area of interest, the method being performed by a device according to various embodiments of the present disclosure.

Referring to FIG. 32, the method may be implemented by a computer program. For example, the method may be performed by using a makeup mirror application installed in the device 100. The computer program may operate in an OS installed in the device 100. The device 100 may write the computer program to a storage medium, and may use the computer program by reading the computer program from the storage medium.

In operation S3201, the device 100 may display the face image of the user. In operation S3201, the device 100 may display the face image of the user on which makeup guide information is displayed as in FIG. 1B. In operation S3201, the device 100 may display the face image of the user on which the makeup guide information is not displayed.

In operation S3201, the device 100 may display a face image of the user which is obtained or is received in real-time. In operation S3201, the device 100 may display a before-makeup face image of the user. In operation S3201, the device 100 may display a during-makeup face image of the user. In operation S3201, the device 100 may display an after-makeup face image of the user. A face image of the user which is displayed in operation S3201 is not limited to the aforementioned descriptions.

In operation S3202, the device 100 may detect the area of interest from the displayed face image of the user. The area of interest may be an area of the face image of the user, wherein the user wants to look closely at the area. The area of interest may include an area where makeup is currently performed. For example, the area of interest may include an area (e.g., a tooth of the user) that the user wants to check.

The device 100 may detect the area of interest by using the face image of the user which is obtained or is received in real-time. The device 100 may detect, from the face image of the user, position information of a tip of a finger, position information of an end of a makeup tool, and/or position information of an area where many movements occur. The device 100 may detect the area of interest based on the detected position information.

In order to detect the position information of the tip of the finger, the device 100 may detect a hand area from the face image of the user. The device 100 may detect the hand area by using a method of detecting a skin color and a method of detecting occurrence of movement in an area. The device 100 may detect a center of the hand from the detected hand area. The device 100 may detect a center point of the hand (or the center of the hand) by using a distance transform matrix based on 2D coordinates values of the hand area.

The device 100 may detect finger-tip candidates from the detected center point of the detected hand area. The device 100 may detect the finger-tip candidates by using overall detection information about the hand, e.g., by detecting a portion of the detected hand area whose contour has a high curvature value or by detecting an oval-shape portion of the detected hand area (i.e., by determining similarity between the oval-shape portion and an oval approximation model of a first knuckle of a hand).

The device 100 may detect a hand end point from the detected finger-tip candidates. The device 100 may detect the hand end point from the detected finger-tip candidates and position information of the hand end point on a screen of the device 100 by taking into account a distance and an angle between the center of the hand and each of the finger-tip candidates, and/or a convex characteristic of between each of the finger-tip candidates and the center of the hand.

In order to detect the position information of the end of the makeup tool, the device 100 may detect an area where movement occurs. The device 100 may detect, from the detected area, an area having a color different from a color of the face image of the user. The device 100 may determine the area having the color different from the color of the face image of the user, as a makeup tool area.

The device 100 may detect a portion of the detected makeup tool area whose contour has a high curvature value, as the end of the makeup tool, and may detect the position information of the end of the makeup tool. The device 100 may detect a point of the makeup tool which is farthest from the hand area, as the end of the makeup tool, and may detect the position information of the end of the makeup tool.

The device 100 may detect, from the detected face image of the user, the area of interest by using the position information of the tip of the finger, the position information of the end of the makeup tool, and/or the position information of the area where many movements occur and position information of each of parts (e.g., eyebrows, eyes, a nose, lips, cheeks, and the like) included in the face image of the user. The area of interest may include the tip of the finger and/or the end of the makeup tool and at least one of the parts included in the face image of the user.

In operation S3203, the device 100 may automatically magnify and may display the detected area of interest. The device 100 may display the detected area of interest so that the detected area of interest may fill the screen, but in the present disclosure, the magnification with respect to the area of interest is not limited to the aforementioned descriptions.

For example, the device 100 matches a center point of the detected area of interest and a center point of the screen. The device 100 determines a magnification percentage with respect to the area of interest by taking into account a ratio of a horizontal length to a vertical length of the area of interest and a ratio of a horizontal length to a vertical length of the screen. The device 100 may magnify the area of interest, based on the determined magnification percentage.

The device 100 may display, as the magnified area of interest, an image including less information than information included in the area of interest. The device 100 may display, as the magnified area of interest, an image including more information than the information included in the area of interest.

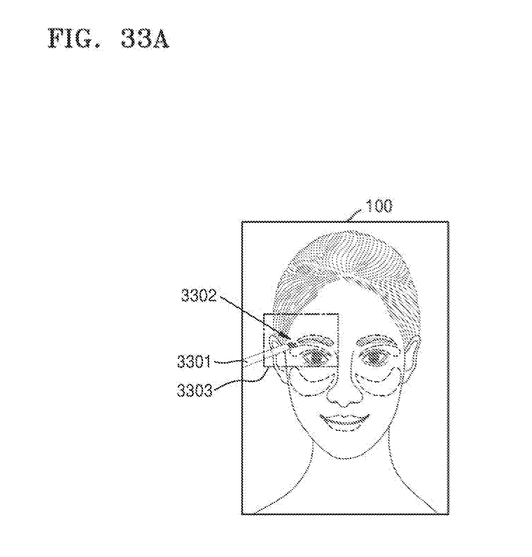

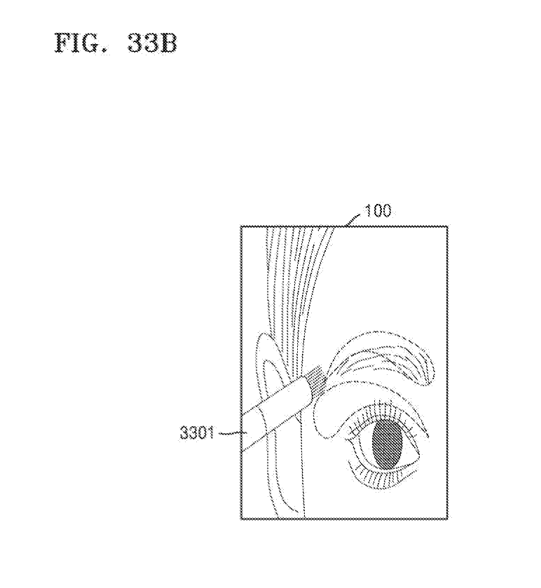

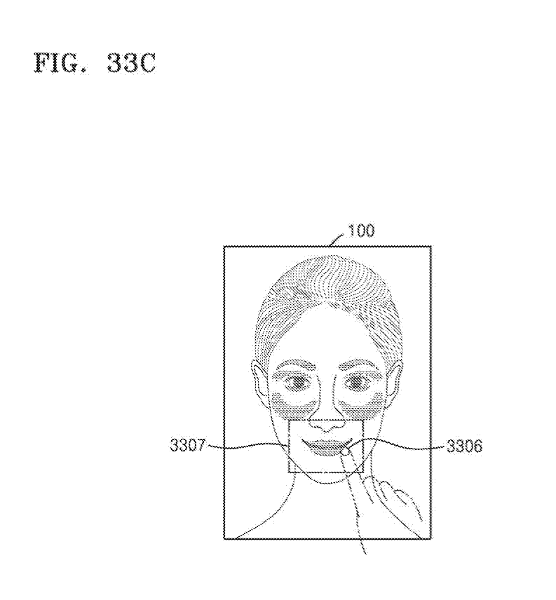

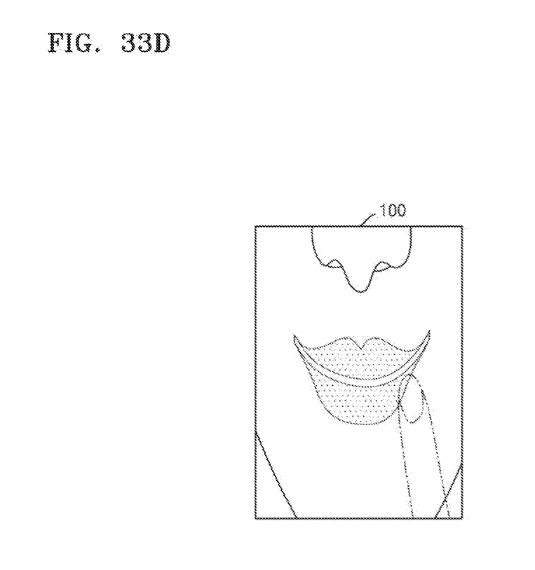

FIGS. 33A and 33B illustrate a makeup mirror of a device, which magnifies an area of interest from a face image of a user according to various embodiments of the present disclosure.

Referring to FIG. 33A, the device 100 may detect, from the displayed face image of the user, an end point 3302 of a makeup tool 3301 and position information of the end point 3302. The device 100 may detect an area of interest 3303 based on the detected position information of the end point 3302 of the makeup tool 3301. The area of interest 3303 may be detected based on the detected position information of the end point 3302 of the makeup tool 3301 and position information (referring to FIG. 33A, position information of an eyebrow and an eye) of each of parts included in the face image of the user. In the present disclosure, information used to detect the area of interest is not limited to the aforementioned descriptions. For example, the device 100 may detect the area of interest by further considering a screen size (e.g., 5.6 inches) of the device 100,

As illustrated in FIG. 33A, when makeup guide information is displayed on the face image of the user, the device 100 may detect the area of interest 3303 by using the position information of the end point 3302 of the makeup tool 3301 and position information of the makeup guide information.

Referring to FIG. 33B, when an area of interest is detected, the device 100 may automatically magnify and may display the detected area of interest. Accordingly, the user may wear an elaborate makeup while the user views the magnified area of interest.

FIGS. 33C and 33D illustrate a makeup mirror of a device, which magnifies an area of interest from a face image of a user according to various embodiments of the present disclosure.

Referring to FIG. 33C, the device 100 may detect a finger-tip 3306 of the user from the face image of the user, and may detect a point of interest 3307 (hereinafter, referred to as the interest point 3307) by using position information of the detected finger-tip 3306 and position information of lips included in the face image of the user. As described with reference to FIG. 33A, the device 100 may detect the interest point 3307 by further considering the screen size of the device 100.

Referring to FIG. 33D, when the interest point 3307 is detected, the device 100 may magnify and may display an interest point. Therefore, the user may closely view a user-desired area.

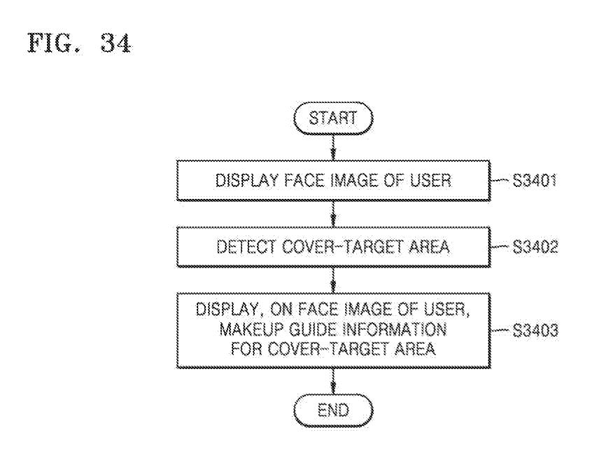

FIG. 34 is a flowchart of a method of providing a makeup mirror that displays makeup guide information with respect to a cover-target area of a face image of a user, the method being performed by a device according to various embodiments of the present disclosure.

Referring to FIG. 34, the method may be implemented by a computer program. For example, the method may be performed by using a makeup mirror application installed in the device 100. The computer program may operate in an OS installed in the device 100. The device 100 may write the computer program to a storage medium, and may use the computer program by reading the computer program from the storage medium.

In operation S3401, the device 100 may display the face image of the user. In operation S3401, the device 100 may display an after-makeup face image of the user, but the present disclosure is not limited thereto.

For example, in operation S3401, the device 100 may display a before-makeup face image of the user. In operation S3401, the device 100 may display a face image of the user without a color makeup. In operation S3401, the device 100 may display the face image of the user which is obtained in real-time.

In operation S3401, the device 100 may display a during-makeup face image of the user. In operation S3401 the device 100 may display the face image of the user after the makeup.

In operation S3402, the device 100 may detect a cover-target area from the displayed face image of the user. The cover-target area of the face image of the user indicates an area that needs to be covered by makeup. In the present disclosure, the cover-target area may include an area including acne. In the present disclosure, the cover-target area may include an area including blemishes (e.g., moles, skin pigmentation (e.g., chloasma), freckles, and the like). In the present disclosure, the cover-target area may include an area including wrinkles. In the present disclosure, the cover-target area may include an area including extending pores. In the present disclosure, the cover-target area may include a dark circle area. In the present disclosure, the cover-target area is not limited to the aforementioned descriptions. For example, in the present disclosure, the cover-target area may include a rough skin area.

The device 100 may detect the cover-target area, based on a difference between skin colours of the face image of the user. For example, the device 100 may detect, as the cover-target area, a skin area whose color is darker than a peripheral skin color in the face image of the user. To do so, the device 100 may use a skin color detecting algorithm that detects pixel-unit colour information with respect to the face image of the user.

The device 100 may detect the cover-target area from the face image of the user by using a difference image (or a difference value) with respect to a difference between a plurality of blur images. The plurality of blur images indicate images that were blurred with different emphasises with respect to the face image of the user displayed in operation S3401. For example, the plurality of blur images may include an image obtained by blurring the face image of the user with a high emphasis, and an image obtained by blurring the face image of the user with a low emphasis, but in the present disclosure, the plurality of blur images are not limited to the aforementioned descriptions. In the present disclosure, the plurality of blur images may include N blur images. Here, N is a natural number equal to or greater than 2.

The device 100 may compare the plurality of blur images and may detect the difference image with respect to the difference between the plurality of blur images. The device 100 may compare the detected difference image with a pixel-unit threshold value and may detect the cover-target area. The threshold value may be previously set, but the present disclosure is not limited to the aforementioned descriptions. For example, the threshold value may be variably set according to a pixel value of an adjacent pixel. The adjacent pixel may include pixels included in a range (e.g., 8×8 pixels, 16×16 pixels, and the like) preset with respect to a target pixel, but in the present disclosure, the adjacent pixel is not limited to the aforementioned descriptions. The threshold value may be set based on the preset threshold value with a value (e.g., an average value, an intermediate value, a value corresponding to a lower 30%, and the like) determined according to the pixel value of the adjacent pixel.

The device 100 may detect the cover-target area from the face image of the user by using a pixel-unit gradient value respect to the face image of the user. The device 100 may detect the pixel-unit gradient value by performing image filtering on the face image of the user.

The device 100 may use a face feature information detecting algorithm so as to detect a wrinkle area from the face image of the user.

In operation S3403, the device 100 may display, on the face image of the user, makeup guide information for the detected cover-target area.

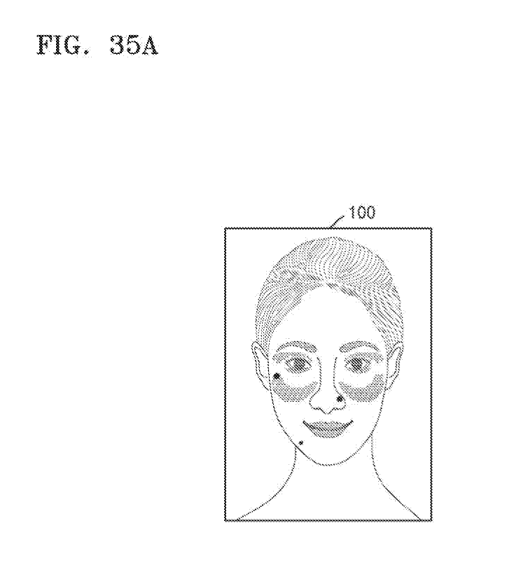

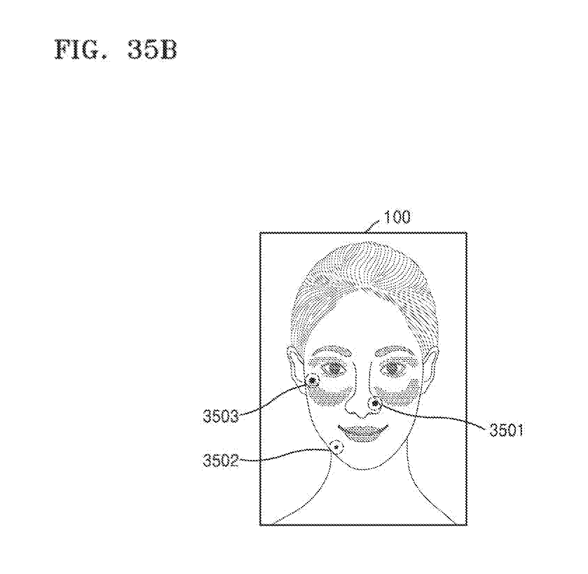

FIGS. 35A and 35B illustrate a makeup mirror of a device, which displays makeup guide information for a cover-target area on a face image of a user according to various embodiments of the present disclosure.

Referring to FIG. 35A, the device 100 may detect positions of moles in the displayed face image of the user.

Referring to FIG. 3513, the device 100 may display a plurality of pieces of makeup guide information 3501, 3502, and 3503 with respect to the positions of the moles.

Accordingly, in a case where the user is a male that does not wear a color makeup, the device 100 may provide makeup guide information (e.g., a concealer-based makeup) for a cover-target area. In a case where the user is a male who has a rough skin due to heavy drinking in last night, the device 100 may provide makeup guide information for the rough skin.

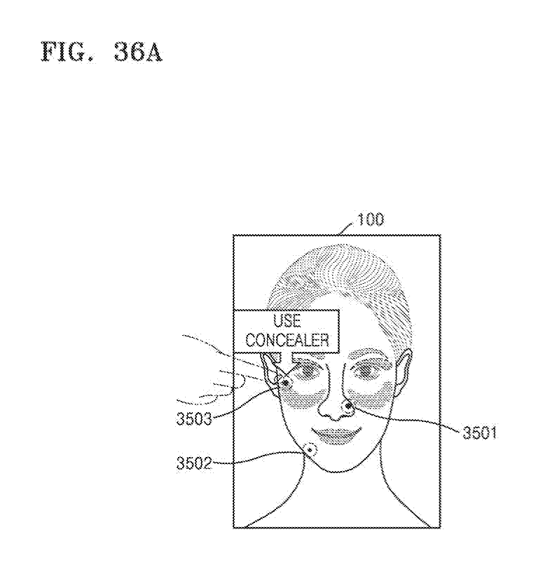

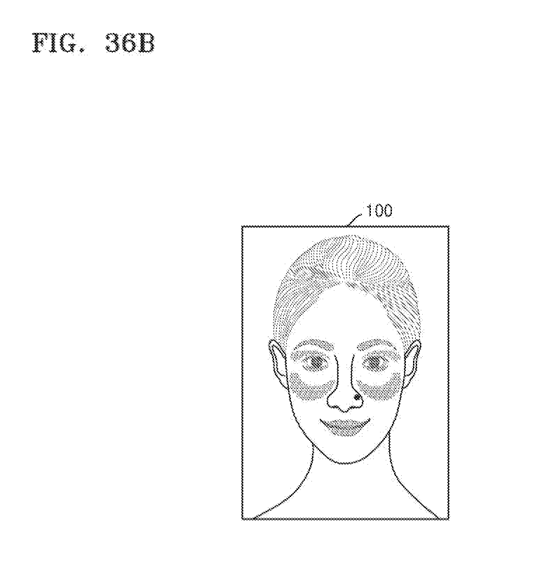

FIGS. 36A and 36B illustrate a makeup mirror of a device, which displays a makeup result based on detailed makeup guide information for a cover-target area on a face image of a user according to various embodiments of the present disclosure.

Referring to FIG. 36A, when a plurality of pieces of makeup guide information 3501, 3502, and 3503 with respect to positions of moles on the displayed face image of the user are displayed, if the device 100 receives a user input for selecting the makeup guide information 3503, the device 100 may provide the detailed makeup guide information.

The detailed makeup guide information may include information about a makeup product (e.g., a concealer). Referring to FIG. 36A, the detailed makeup guide information is provided by using a pop-up window. In the present disclosure, a method of providing the detailed makeup guide information is not limited to that shown with reference to FIG. 36A.

In the present disclosure, the detailed makeup guide information may include information about a makeup tip based on the makeup product (e.g., “Please apply a liquid concealer onto a target area and spread the liquid concealer while dabbing the liquid concealer with a finger”).

Based on the detailed makeup guide information provided with reference to FIG. 36A, the user may apply makeup only to a desired area. For example, the user may perform a cover makeup on moles corresponding to the two pieces of makeup guide information 3502 and 3503 from among the plurality of pieces of makeup guide information 3501, 3502, and 3503 provided with reference to FIG. 36A, and may not perform the cover makeup on a mole corresponding to the makeup guide information 3501.

Referring to FIG. 36B, while the cover makeup for the mole corresponding to the makeup guide information 3501 is not performed as described above, if a user input for informing makeup completion is received, the device 100 may display a face image of the user to which a cover makeup for a cover-target area from among all cover-target areas is not performed. In this manner, the user may not apply the makeup to an area that does not require the cover makeup from among the makeup guide information for the cover-target area which is provided by the device 100. The area that does not require the cover makeup may be an area that the user thinks as a charming point.

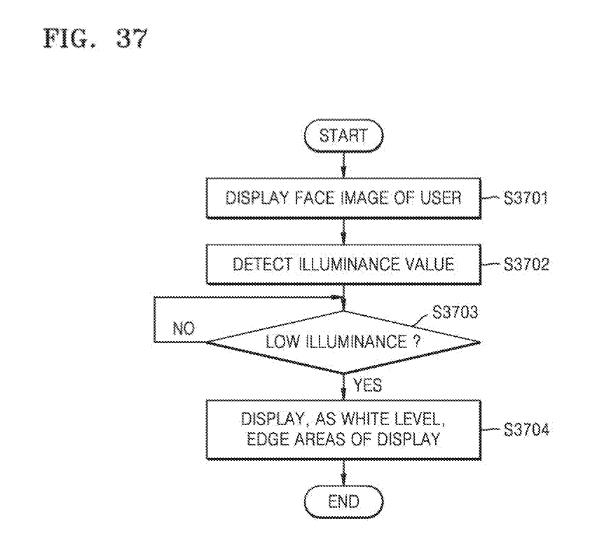

FIG. 37 is a flowchart of a method of providing a makeup mirror for compensating for a low illuminance environment, the method being performed by a device according to various embodiments of the present disclosure.

Referring to FIG. 37, the method may be implemented by a computer program. For example, the method may be performed by using a makeup mirror application installed in the device 100. The computer program may operate in an OS installed in the device 100. The device 100 may write the computer program to a storage medium, and may use the computer program by reading the computer program from the storage medium.

In operation S3701, the device 100 may display a face image of a user. In operation S3701, the device 100 may display a before-makeup face image of the user. In operation S3701, the device 100 may display a during-makeup face image of the user. In operation S3701, the device 100 may display an after-makeup face image of the user. In operation S3701, the device 100 may display a face image of the user which is Obtained or is received in real-time, regardless of makeup processes.

In operation S3702, the device 100 may detect an illuminance level, based on the face image of the user. A method of detecting the illuminance level, based on the face image of the user, may be performed based on a brightness level of the face image of the user, but in the present disclosure, the method of detecting the illuminance level is not limited to the aforementioned descriptions.

In operation S3702, when the device 100 obtains the face image of the user, the device 100 may detect an amount of ambient light by using an illuminance sensor included in the device 100, and may detect an illuminance value by converting the detected amount of ambient light to the illuminance value.

In operation S3703, the device 100 may compare the detected illuminance value with a reference value and may determine whether the detected illuminance value indicates a low illuminance. The low illuminance indicates a state at which a level of an amount of light is low (or a state of dim light). The reference value may be set based on an amount of light by which the user may clearly view the face image of the user. The device 100 may previously set the reference value.

In operation S3703, when the illuminance value is determined as the low illuminance, in operation S3704, the device 100 may display, as a white level, edge areas of a display of the device 100. Accordingly, due to light emitted from the edge areas of the display of the device 100, the user may feel an increase in the amount of ambient light, and may view the more clear face image of the user. The white level indicates that a color level of the display is white. A technique of making a color level as a white level may vary according to a color model of the display. The color model may include a gray model, a red, green, blue (RGB) model, a hue saturation value (HSV) model, a YUV (YCbCr) model, and the like, but in the present disclosure, the color model is not limited to the aforementioned descriptions.

The device 100 may previously set the edge areas of the display which are to be displayed as the white level. The device 100 may change information about the preset edge areas of the display, according to a user input. The device 100 may display the edge areas of the display as the white level, and then may adjust the edge areas displayed as the white level, according to a user input.

As a result of the determination in operation S3703, if the detected illuminance value is not the low illuminance, an operation of the device 100 may be in a standby state for detecting a next illuminance value, but the present disclosure is not limited thereto. For example, as the result of the determination in operation S3703, if the detected illuminance value is not the low illuminance, the device 100 may return to an operation of displaying the face image of the user. The detection of the illuminance value may be performed by a unit of an intra (I) frame. However, in the present disclosure, the unit of detecting the illuminance value is not limited to the aforementioned descriptions.

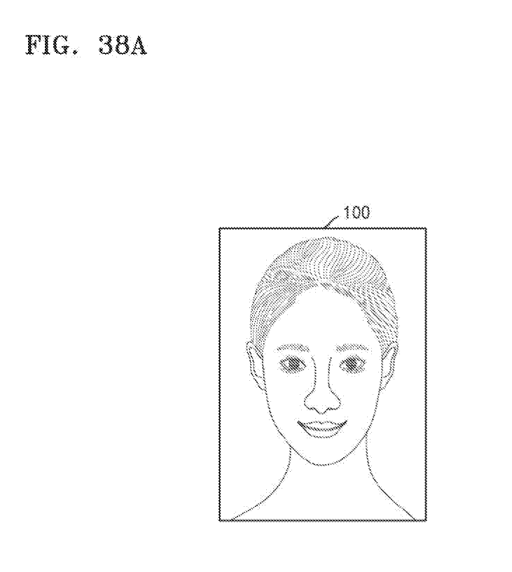

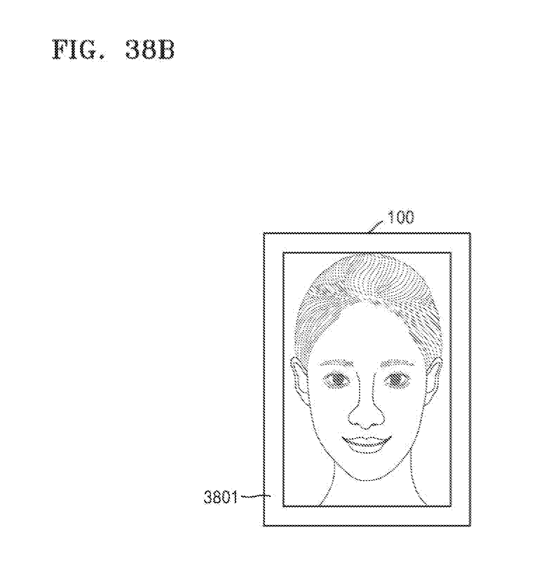

FIGS. 38A and 38B illustrate a makeup mirror of a device, which displays, as a white level, edge areas of a display according to various embodiments of the present disclosure.

Referring to FIG. 38A, when a face image of a user is displayed, if the device 100 determines that an illuminance value indicates a low illuminance, the device 100 may display a white level display area 3801 on edges of the device 100 as shown in FIG. 38B.

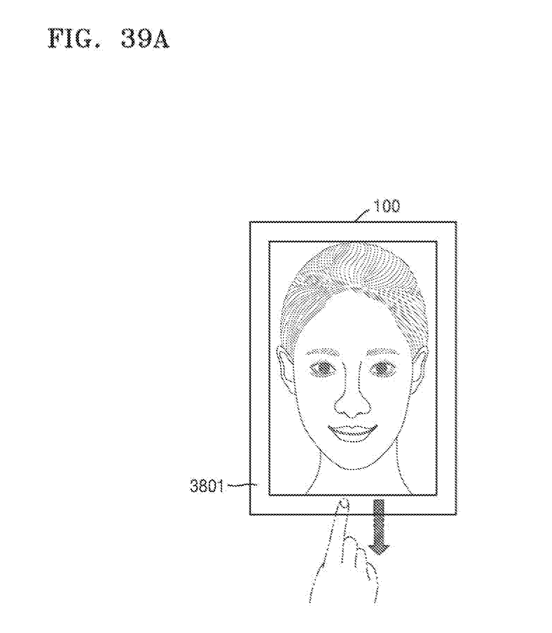

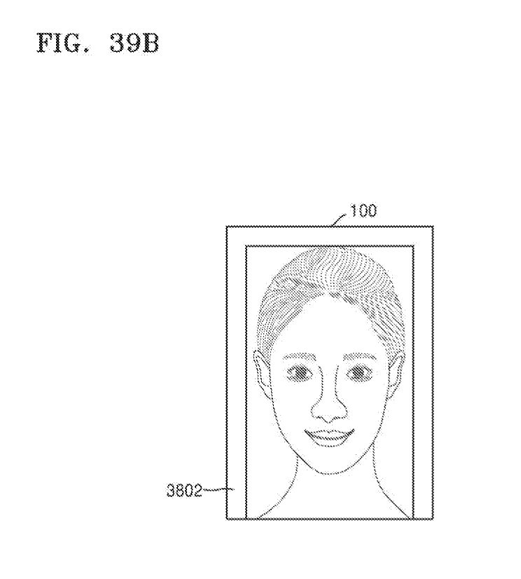

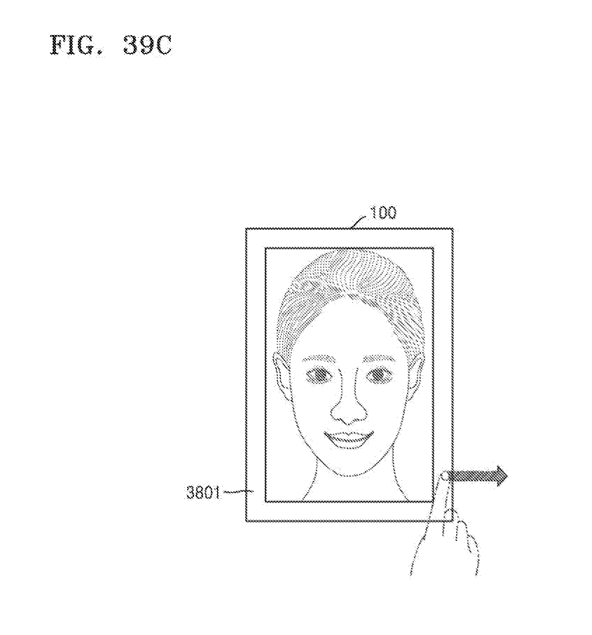

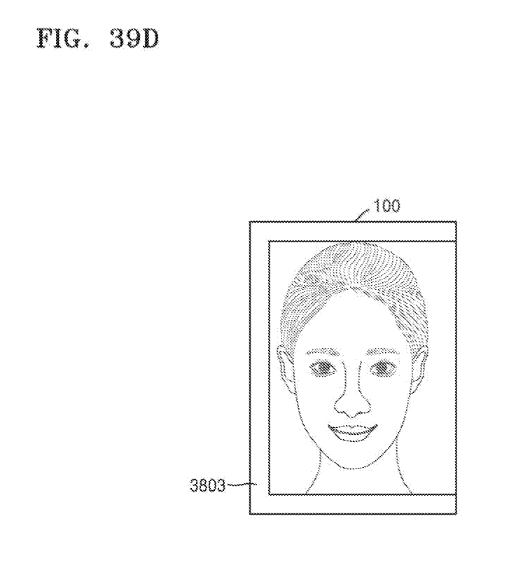

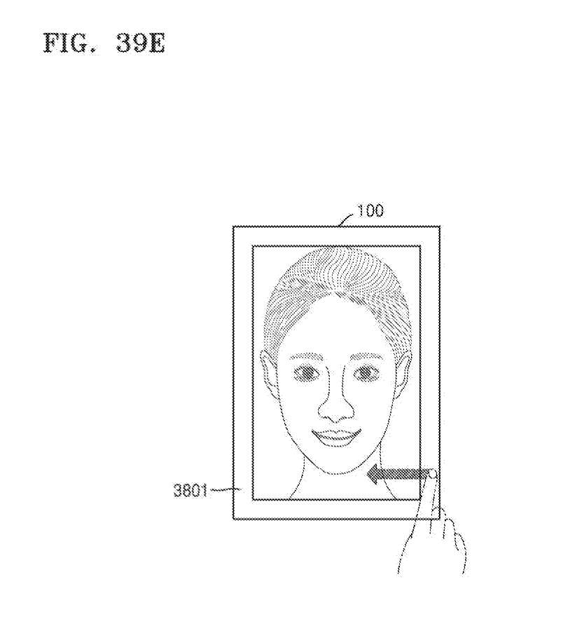

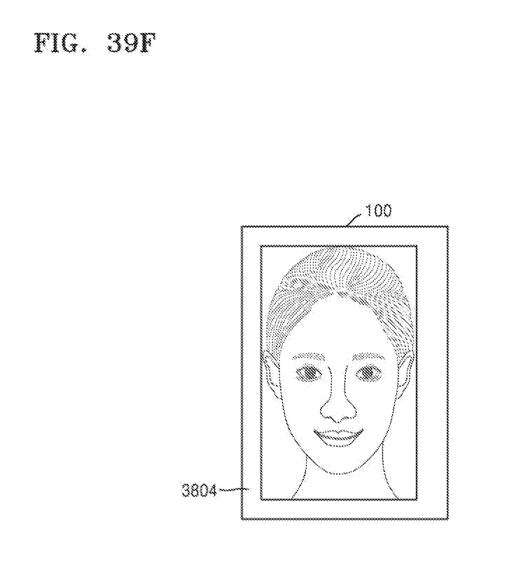

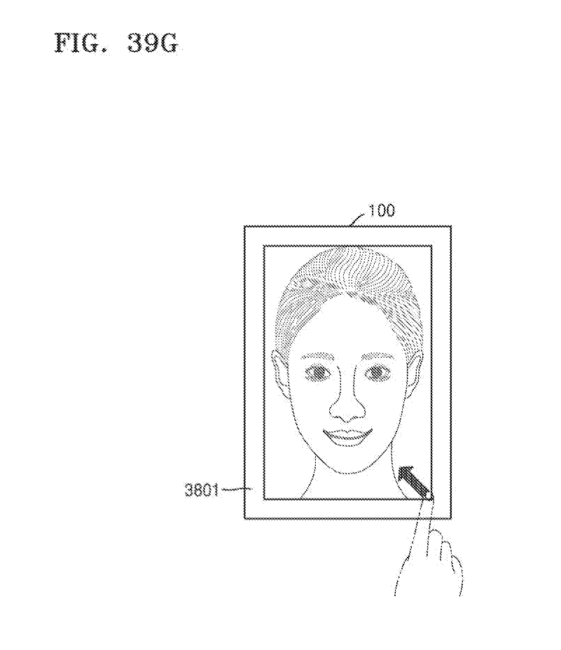

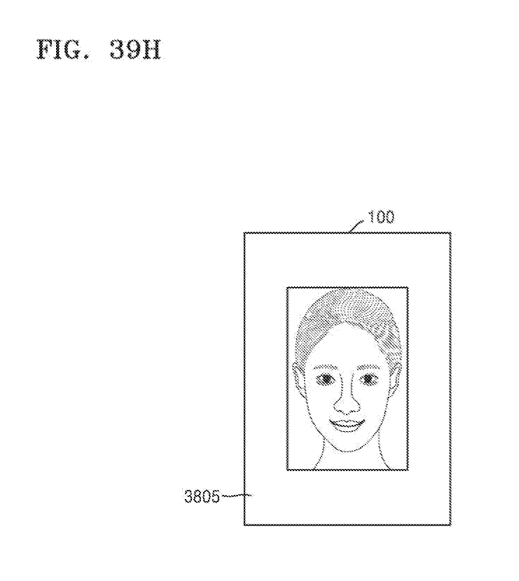

FIGS. 39A to 39H illustrate a makeup mirror of a device, which adjusts a white level display area on edge areas of a display according to various embodiments of the present disclosure.

Referring to FIGS. 39A and 39B, while the white level display area 3801 is displayed on the edge areas of the display of the device 100, when a user input based on a bottom area of the white level display area 3801 shown in FIG. 39A is received, the device 100 may display a white level display area 3802 from which the bottom area is deleted as shown in FIG. 39B.

Referring to FIGS. 39C and 39D, while the white level display area 3801 is displayed on the edge areas of the display of the device 100, when a user input based on a right area of the white level display area 3801 shown in FIG. 39C is received, the device 100 may display a white level display area 3803 from which the right area is deleted as shown in FIG. 39D.

Referring to FIGS. 39E and 39F, while the white level display area 3801 is displayed on the edge areas of the display of the device 100, when a user input based on the right area of the white level display area 3801 shown in FIG. 39E is received, the device 100 may display a white level display area 3804 in which the right area is extended as shown in FIG. 39F.

Referring to FIG. 39G and 39H, while the white level display area 3801 is displayed on the edge areas of the display of the device 100, when a user input based on at least one from among four corners of the device 100 shown in FIG. 39G is received, the device 100 may display a white level display area 3805 in which four corners are extended as shown in FIG. 39H. Due to the white level display area 3805 in which four corners are extended, the device 100 may reduce an area where the face image of the user is displayed as shown in FIG. 39H.

When the white level display area 3805 in which four corners are extended is displayed as shown in FIG. 39H, the device 100 may not reduce but may maintain the area where the face image of the user is displayed. In this case, the device 100 may overlap the white level display area 3805 in which four corners are extended with the face image of the user, so that the white level display area 3805 in which four corners are extended may be displayed on the face image of the user.

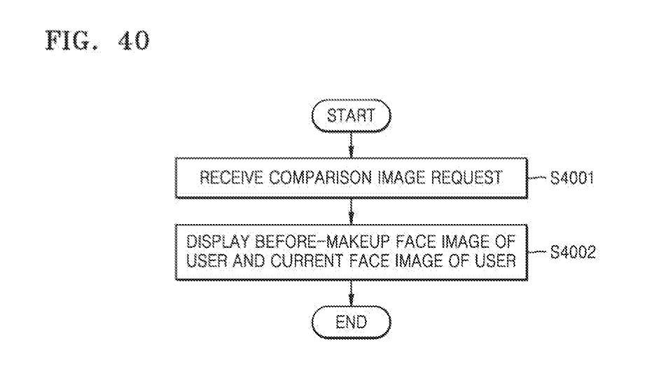

FIG. 40 is a flowchart of a method of providing a makeup mirror for displaying a comparison between a before-makeup face image of a user and a current face image of the user, the method being performed by a device according to various embodiments of the present disclosure.

Referring to FIG. 40, the current face image of the user may indicate the face image of the user to which the makeup has been so far applied. The method may be implemented by a computer program. For example, the method may be performed by using a makeup mirror application installed in the device 100. The computer program may operate in an OS installed in the device 100. The device 100 may write the computer program to a storage medium, and may use the computer program by reading the computer program from the storage medium.

In operation S4001, the device 100 may receive a user input of a comparison image request. The comparison image request indicates the user input of requesting a comparison between the before-makeup face image of the user and the current face image of the user. The user input of the comparison image request may be input by using the device 100. In the present disclosure, the user input of the comparison image request is not limited to the aforementioned descriptions. For example, the user input of the comparison image request may be received from an external device connected to the device 100.

The before-makeup face image of the user may include a face image of the user which is first displayed on the device 100 during a makeup procedure that is currently performed. The before-makeup face image of the user may include a face image of the user which is first displayed on the device 100 during a day. The current face image of the user may include a face image of the user to which the makeup is being applied. The current face image of the user may include an after-makeup face image of the user. The current face image of the user may include a face image of the user which is obtained or is received in real-time.

In operation S4002, the device 100 may read the before-makeup face image of the user from a memory of the device 100. When the before-makeup face image of the user is stored in another device, the device 100 may request the other device to provide the before-makeup face image of the user, and may receive the before-makeup face image of the user from the other device.

The before-makeup face image of the user may be stored in each of the device 100 and the other device. In this case, the device 100 may selectively read the before-makeup face image of the user stored in the device 100 or the before-makeup face image of the user stored in the other device, and may use the selected face image.

The device 100 may separately display the before-makeup face image of the user and the current face image of the user. For example, the device 100 may display the before-makeup face image of the user and the current face image of the user on one screen in a split screen manner. Alternatively, the device 100 may display the before-makeup face image of the user and the current face image of the user on different page screens. In this case, according to a user input for page switching, the device 100 may separately provide the before-makeup face image of the user and the current face image of the user to the user.

In operation S4002, the device 100 may perform facial feature matching processing and/or pixel-unit matching processing on the before-makeup face image of the user and the current face image of the user and may display the face images. Since the matching processing is performed, even if an image-capturing angle of a camera when the camera captures the before-makeup face image of the user is different from an image-capturing angle of the camera when the camera captures the current face image of the user, the device 100 may display the before-makeup face image of the user and the current face image of the user as if the face image and the current face image were captured at a same image-capturing angle. Therefore, the user may easily compare the before-makeup face image of the user with the current face image of the user.

In addition, since the matching processing is performed, even if a display size of the before-makeup face image of the user is different from a display size of the current face image of the user, the device 100 may display the before-makeup face image of the user and the current face image of the user as if the face image and the current face image have a same display size. Therefore, the user may easily compare the before-makeup face image of the user with the current face image of the user.

In order to perform the facial feature matching processing on a plurality of images, the device 100 may fix a facial feature of each of the before-makeup face image of the user and the current face image of the user. The device 100 may warp the face image of the user according to the fixed facial feature.

To fix the facial feature of each of the before-makeup face image of the user and the current face image of the user may indicate to match display positions of eyes, a nose, and lips included in each of the before-makeup face image of the user and the current face image of the user. In the present disclosure, the before-makeup face image of the user and the current face image of the user may be referred to as a plurality of face images of the user.

In order to perform the pixel-unit matching processing on the plurality of face images, the device 100 may estimate, from another image, a pixel (e.g., a q-pixel) that corresponds to a p-pixel included in one image. If the one image corresponds to the before-makeup face image of the user, the other image may correspond to the current face image of the user.

The device 100 may estimate, from the other image, the q-pixel having information similar to that of the p-pixel by using a descriptor vector indicating information about each pixel.

In more detail, the device 100 may detect, from the other image, the q-pixel having information similar to a descriptor vector of the p-pixel included in one image. The fact that the q-pixel has the information similar to the descriptor vector of the p-pixel indicates that a difference between a descriptor vector of the q-pixel and the descriptor vector of the p-pixel is small.

When the q-pixel is detected from the other image, the device 100 may determine whether a display position of the q-pixel in the other image is similar to a display position of the p-pixel in the one image. If the display position of the q-pixel is similar to the display position of the p-pixel, the device 100 may determine whether a pixel corresponding to a pixel adjacent to the q-pixel is included in a pixel adjacent to the p-pixel.

The adjacent pixel indicates a peripheral pixel. In the present disclosure, the adjacent pixel may include 8 pixels that surround the q-pixel. For example, when display position information of the q-pixel indicates (x1, y1), a plurality of pieces of display position information of the 8 pixels may include (x1−1, y1−1), (x1−1, y1), (x1−1, y1+1), (x1, y1−1), (x1, y1+1), (x1+1, y1−1), (x1+1, y1), and (x1+1, y1+1). In the present disclosure, display position information of the adjacent pixel is not limited to the aforementioned descriptions.

When the device 100 determines that the pixel corresponding to the pixel adjacent to the q-pixel is included in the pixel adjacent to the p-pixel, the device 100 may determine the q-pixel as a pixel that corresponds to the p-pixel.

Even if the descriptor vector of the q-pixel and the descriptor vector of the p-pixel are similar, if a difference between the display position of the q-pixel in the other image and the display position of the p-pixel in the one image is large, the device 100 may determine the q-pixel as a pixel that does not correspond to the p-pixel. A reference value for determining whether or not the difference between the display positions is large may be previously set. The reference value may be set according to a user input.

If the pixel corresponding to the pixel adjacent to the q-pixel is not included in the pixel adjacent to the p-pixel, even if the descriptor vector of the q-pixel and the descriptor vector of the p-pixel are similar and the difference between the display position of the q-pixel in the other image and the display position of the p-pixel in the one image is not large, the device 100 may determine the q-pixel as a pixel that does not correspond to the p-pixel.

In the present disclosure, the pixel-unit matching processing is not limited to the aforementioned descriptions.

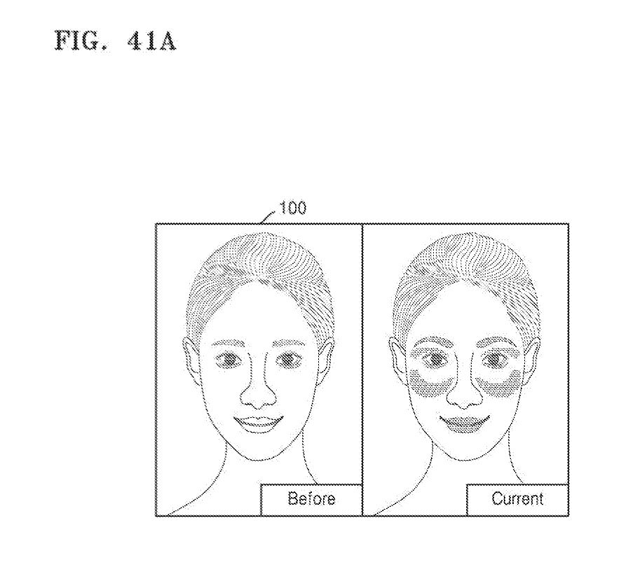

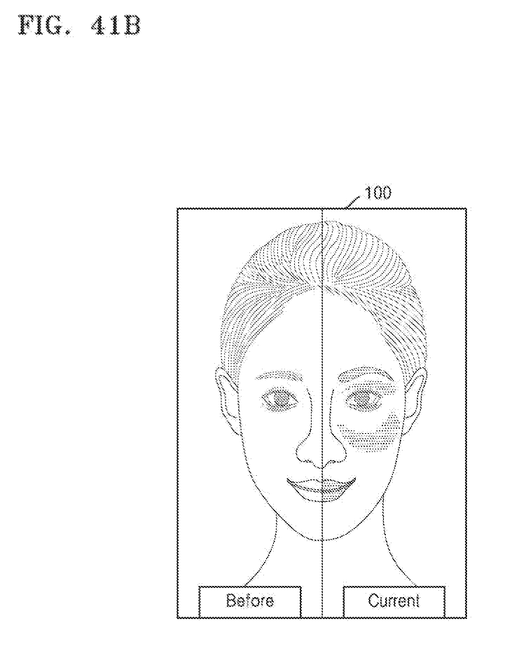

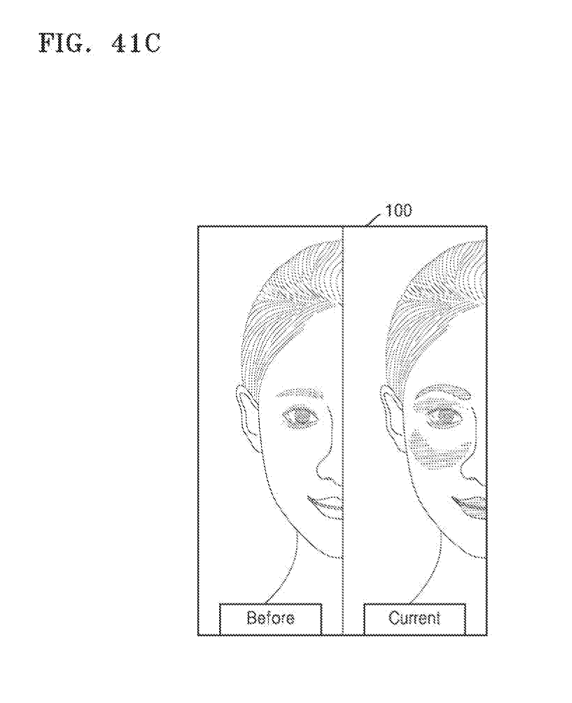

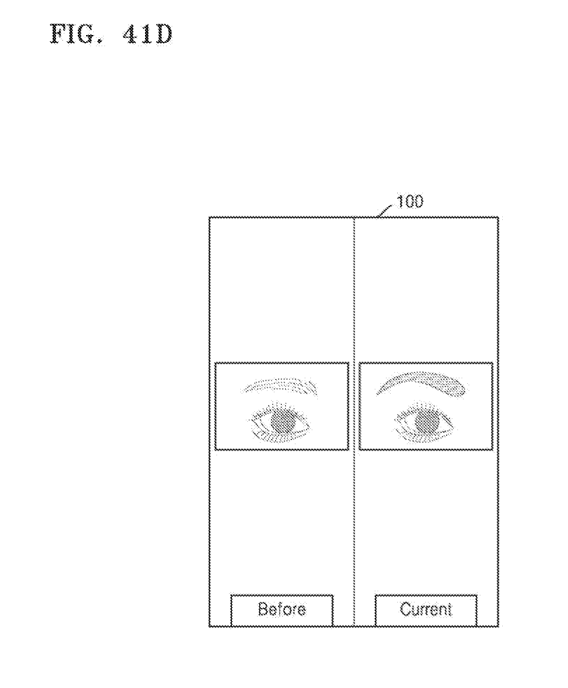

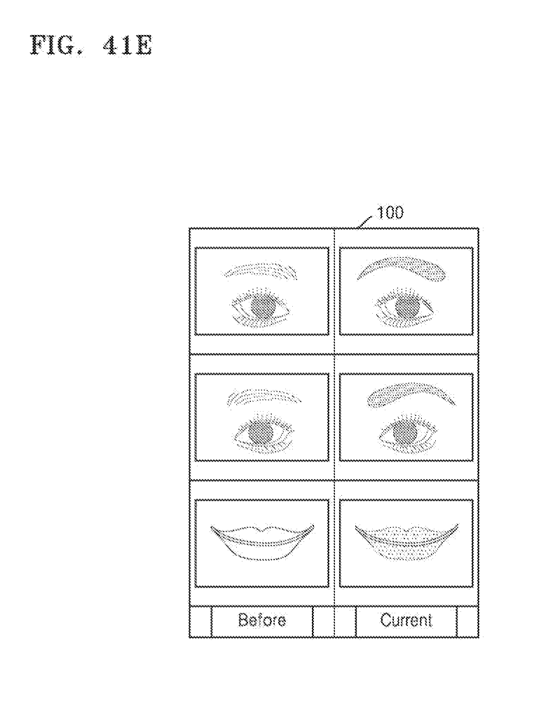

FIGS. 41A to 41E illustrate a makeup mirror of a device, which displays a comparison between a before-makeup face image of a user and a current face image of the user according to various embodiments of the present disclosure.

Referring to FIG. 41A, compared images in the form of split screens described with reference to the operation S4002 of FIG. 40 is illustrated. Referring to FIG. 41A, the device 100 displays the before-makeup face image of the user on one side display area (e.g., a left display area) of a split screen, and displays the current face image of the user on the other side display area (e.g., a right display area) of the split screen.

Referring to FIG. 41A, when the before-makeup face image of the user and the current face image of the user are displayed, the device 100 may perform the facial feature matching processing and/or the pixel-unit matching processing on the two face images as described with reference to the operation S4002 of FIG. 40. Accordingly, the device 100 may display the before-makeup face image of the user and the current face image of the user which have a same image-capturing angle and/or a same display size.

FIG. 41B illustrates the compared images in the form of split screens described with reference to the operation S4002 of FIG. 40.

Referring to FIG. 41B, the device 100 displays a left face image of the user before makeup on one side display area (e.g., a left display area) of a split screen, and displays a current right face image of the user on the other side display area (e.g., a right display area) of the split screen.

As illustrated in FIG. 41B, in order to display half-face images of the user on split display areas, respectively, the device 100 may halve each of the before-makeup face image of the user and the current face image of the user, along the reference line 3101 described with reference to FIG. 31A. The device 100 may determine display-target images from among split face images of the user.

In order to display a face image of the user as shown in FIG. 41B, the device 100 may determine the left face image of the before-makeup face image, as the display-target image, and may determine the right face image of the current face image of the user, as the display-target image.

An operation of determining the display-target image may be performed by the device 100 according to a preset reference. In the present disclosure, the operation of determining the display-target image is not limited to the aforementioned descriptions. For example, the display-target image may be determined according to a user input.

The device 100 may perform the facial feature matching processing and/or the pixel-unit matching processing on the half-face image of the user before the makeup and the current half-face image of the user as described with reference to the operation S4002, and may display the half-face images. Accordingly, the user may view, as one face image of the user, the half-face image of the user before the makeup and the current half-face image of the user which are displayed on the split screens.

FIG. 41C illustrates the compared images in the form of a split screen described with reference to the operation S4002 of FIG. 40.

Referring to FIG. 41C, the device 100 displays a left face image of the user before makeup is applied to the user on one side display area (e.g., a left display area) of a split screen, and displays a current left face image of the user on the other side display area (e.g., a right display area) of the split screen. Accordingly, the user may compare face images of a same side on a face image of the user.

As illustrated in FIG. 41C, in order to display half-face images of the user on split display areas, respectively, the device 100 may halve each of the before-makeup face image of the user and the current face image of the user, along the reference line 3101 described with reference to FIG. 4113. The device 100 may determine display-target images from among split face images of the user. The device 100 may perform the facial feature matching processing and/or the pixel-unit matching processing on the determined display-target images of the user, and may display the images.

FIG. 41D illustrates compared images with respect to an area of interest of a face image of a user, wherein the compared images are displayed in a form of split screens described with reference to the operation S4002 of FIG. 40.

Referring to FIG. 41D, the device 100 may detect, from a before-makeup face image of the user, an area of interest (e.g., an area including a left eye) described with reference to FIG. 32, may detect a same area (e.g., the area including the left eye) from a current face image of the user, and may display the detected areas of interest on the split screens, respectively.

In order to detect the area of interest shown in FIG. 41D, the device 100 may use display position information about facial features, hut in the present disclosure, a method of detecting the area of interest is not limited to the aforementioned descriptions. For example, when the device 100 receives a user input of selecting one point of the displayed face image of the user, the device 100 may detect, as the area of interest, an area that was preset with respect to the selected point.

The preset area may be quadrangular but is not limited thereto. For example, the preset area may be circular, pentagonal, or triangular. The device 100 may display the detected area of interest as a preview. Therefore, the user may check the detected area of interest before the user views the compared images.

In the present disclosure, the area of interest is not limited to the area including the left eye. For example, the area of interest may include a nose area, a mouth area, a cheek area, or a forehead area, but in the present disclosure, the area of interest is not limited to the aforementioned descriptions.

In addition, the compared images shown in FIG. 41D may be provided while the face image of the user who is wearing makeup is displayed on the device 100. In this case, the device 100 may manage a display hierarchy of the face image of the user who is wearing the makeup, as a hierarchy lower than a display hierarchy of the compared images shown in FIG. 41D.

The device 100 may perform the facial feature matching processing and/or the pixel-unit matching processing on the detected area of interest, and may display the detected area of interest. Before the device 100 detects the area of interest, the device 100 may perform the facial feature matching processing and/or the pixel-unit matching processing on the before-makeup face image of the user and the current face image of the user.

FIG. 41E illustrates compared images with respect to each of parts of a face image of a user, wherein the compared images are displayed in the form of split screens described with reference to the operation S4002 of FIG. 40.

Referring to FIG. 41E, the device 100 displays, on the split screens, a comparison image with respect to a left eye area included in a before-makeup face image of the user and a left eye area included in a current face image of the user, a comparison image with respect to a right eye area included in the before-makeup face image of the user and a right eye area included in the current face image of the user, and a comparison image with respect to a lips area included in the before-makeup face image of the user and a lips area included in the current face image of the user.

In order to display the compared images as shown in FIG. 41E, the device 100 may split a screen into 6 regions. In the present disclosure, an operation of displaying the compared images with respect to the parts is not limited to that shown in FIG. 41E.

In order to display the compared images with respect to the parts of the face image of the user, the device 100 may detect each of the parts from the face image of the user, according to facial features, may perform the facial feature matching processing and/or the pixel-unit matching processing on images of the parts, and may display the images. Before the device 100 detects each of the parts, the device 100 may perform the facial feature matching processing and/or the pixel-unit matching processing on each of the face images.

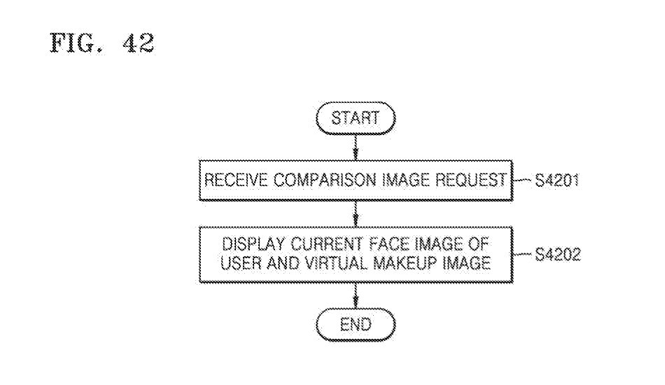

FIG. 42 is a flowchart of a method of providing a makeup mirror for displaying a comparison between a current face image of a user and a virtual makeup image, the method being performed by a device according to various embodiments of the present disclosure.

Referring to FIG. 42, the method may be implemented by a computer program. For example, the method may be performed by using a makeup mirror application installed in the device 100. The computer program may operate in an OS installed in the device 100. The device 100 may write the computer program to a storage medium, and may use the computer program by reading the computer program from the storage medium.

In operation S4201, the device 100 may receive a user input of a comparison image request. The comparison image request in the operation S4201 indicates the user input of requesting the comparison between the current face image of the user and the virtual makeup image. The user input of the comparison image request may be input by using the device 100 or may be received from an external device connected to the device 100.

In the present disclosure, the current face image of the user may include a face image of the user to which makeup is being applied. In the present disclosure, the current face image of the user may include an after-makeup face image of the user. In the present disclosure, the current face image of the user may include a face image of the user before the makeup. In the present disclosure, the current face image of the user may include a face image of the user which is obtained or is received in real-time.

The virtual makeup image indicates a face image of the user to which a user-selected virtual makeup is applied. The user-selected virtual makeup may include the color-based virtual makeup or the theme-based virtual makeup, but in the present disclosure, the virtual makeup is not limited to the aforementioned descriptions.

In operation S4202, the device 100 may separately display the current face image of the user and the virtual makeup image. The device 100 may read the virtual makeup image from a memory of the device 100. The device 100 may receive the virtual makeup image from another device. The device 100 may selectively use the virtual makeup image stored in the device 100 or the virtual makeup image stored in the other device.

In operation S4202, the device 100 may display the current face image of the user and the virtual makeup image on one screen in a split screen manner, in operation S4202, the device 100 may display the current face image of the user and the virtual makeup image on different page screens. In this case, according to a user input for page switching, the device 100 may separately provide the current face image of the user and the virtual makeup image to the user.

In operation S4202, the device 100 may perform the facial feature matching processing and/or the pixel-unit matching processing on the current face image of the user and the virtual makeup image as described with reference to FIG. 40, and may display the images. Since the matching processing is performed, even if an image-capturing angle of a camera when the camera captures the current face image of the user is different from an image-capturing angle of the camera when the camera captures the virtual makeup image, the device 100 may display the current face image of the user and the virtual makeup image as if the current face image of the user and the virtual makeup image were captured at a same image-capturing angle.

In addition, since the matching processing is performed, even if a display size of the current face image of the user is different from a display size of the virtual makeup image, the device 100 may display the current face image of the user and the virtual makeup image as if the current face image of the user and the virtual makeup image have a same display size. Therefore, the user may easily compare the virtual makeup image with the current face image of the user.

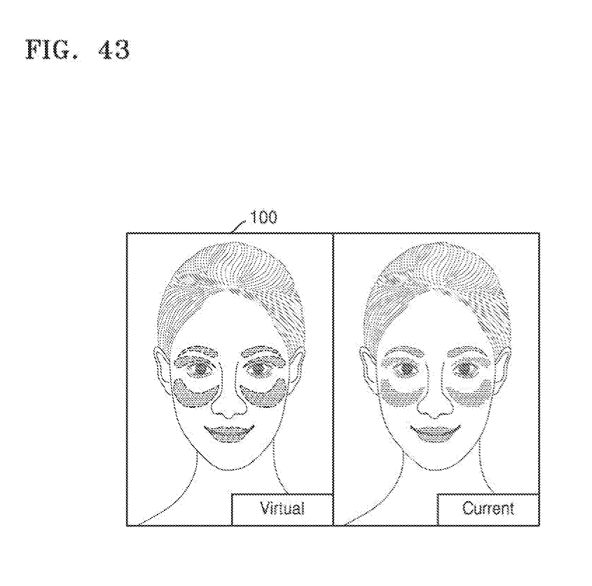

FIG. 43 illustrates a makeup mirror of a device, which displays a comparison between a current face image of a user and a virtual makeup image according to various embodiments of the present disclosure.

Referring to FIG. 43, the device 100 provides both the current face image of the user and the virtual makeup image in a split screen manner.

In the present disclosure, compared images with respect to the current face image of the user and the virtual makeup image are not limited to that shown in FIG. 43. For example, the device 100 may display the compared images with respect to the current face image of the user and the virtual makeup image, based on at least one of comparison image types shown in FIGS. 41B to 41E.

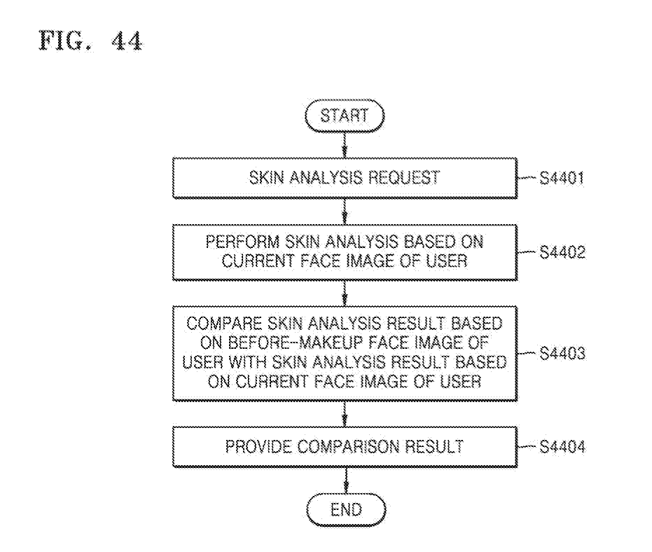

FIG. 44 is a flowchart of a method of providing a makeup mirror for providing a skin analysis result, the method being performed by a device according to various embodiments of the present disclosure.

Referring to FIG. 44, the method may be implemented by a computer program. For example, the method may be performed by using a makeup mirror application installed in the device 100. The computer program may operate in an OS installed in the device 100. The device 100 may write the computer program to a storage medium, and may use the computer program by reading the computer program from the storage medium.

In operation S4401, the device 100 may receive a user input of a skin analysis request. The user input may be received by using the device 100 or may be received from an external device connected to the device 100.

In operation S4402, the device 100 may perform a skin analysis based on a current face image of a user. The skin analysis may be performed by using a skin item analysis technique based on a face image of the user. Here, a skin item may include a skin tone, acne, wrinkles, hyperpigmentation (or skin pigmentation), and/or pores, but in the present disclosure, the skin item is not limited thereto.

In operation S4403, the device 100 may compare a skin analysis result based on a before-makeup face image of the user with a skin analysis result based on the current face image of the user. The device 100 may read the skin analysis result based on the before-makeup face image of the user, which is stored in a memory of the device 100, and may use the skin analysis result.

In the present disclosure, the skin analysis result based on the before-makeup face image of the user is not limited to the aforementioned descriptions. For example, the device 100 may receive the skin analysis result based on the before-makeup face image of the user from the external device connected to the device 100. If the skin analysis result based on the before-makeup face image of the user is stored in each of the device 100 and the external device, the device 100 may selectively use the skin analysis result stored in the device 100 or the skin analysis result stored in the external device.

In operation S4404, the device 100 may provide a comparison result. The comparison result may be displayed via a display of the device 100. The comparison result may be transmitted to an external device (e.g., a smart mirror) connected to the device 100 and may be displayed. Accordingly, while the user views, via the device 100, the face image of the user to which the makeup has been so far applied, the user may view skin comparison analysis result information displayed on the smart mirror.

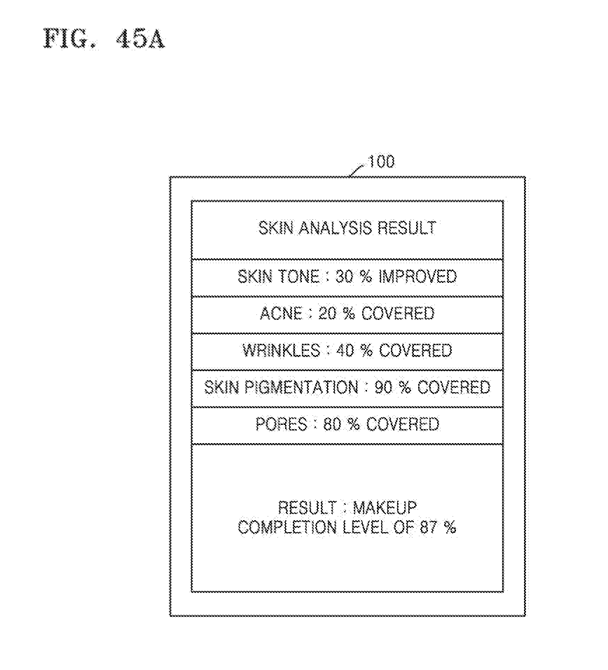

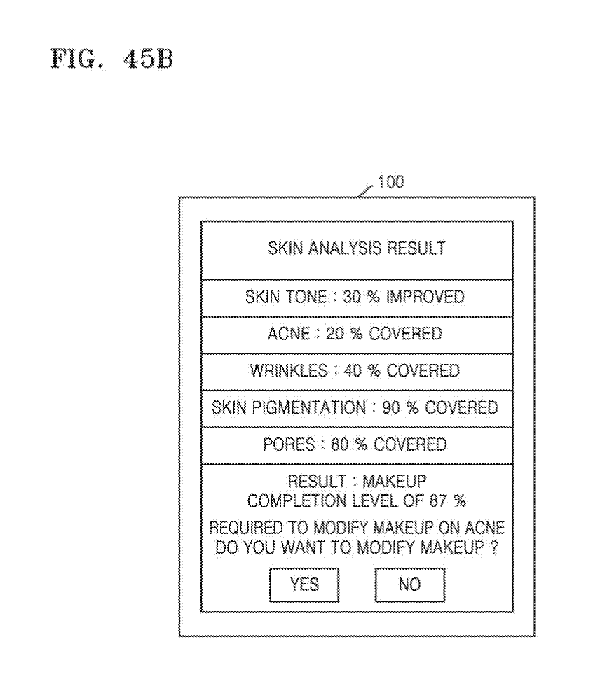

FIGS. 45A and 45B illustrate skin comparison analysis result information displayed by a device according to various embodiments of the present disclosure.

Referring to FIG. 45A, the device 100 may display skin analysis result information including a skin tone improvement level (e.g., 30%), an acne covering level (e.g., 20%), a wrinkles covering level (e.g., 40%), a skin pigmentation covering level (e.g., 90%), and a pores covering level (e.g., 80%), but the present disclosure is not limited thereto.

For example, the device 100 may display the skin tone improvement level as the skin analysis result information. The device 100 may display the acne covering level as the skin analysis result information. The device 100 may display the wrinkles covering level as the skin analysis result information. The device 100 may display the skin pigmentation coveting level as the skin analysis result information. The device 100 may display the pores covering level as the skin analysis result information.

Referring to FIG. 45A, the device 100 may display skin analysis result information including total analysis information (e.g., a makeup completion level of 87%) with respect to the analysis results.

Referring to FIG. 45B, the device 100 may display skin analysis result information including detailed total analysis information. For example, the detailed total analysis information may include notice messages, such as a position of a browridge is slanted toward a right side, a lower lip line needs to be modified, it is required to cover acne, and the like. The detailed total analysis information may include a query language and modification-makeup guide information. The query language may be to ask whether to modify makeup, but in the present disclosure, the query language is not limited to the aforementioned descriptions. When the device 100 determines that the makeup needs to be modified, the device 100 may provide the query language. When a user input for modification based on the query language is received, the device 100 may provide the modification-makeup guide information.

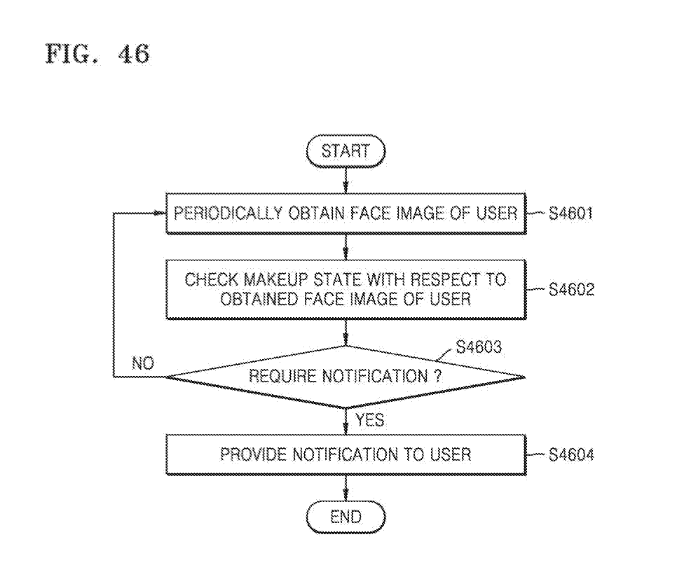

FIG. 46 is a flowchart of a method of providing a makeup mirror for managing a makeup state of a user while the user is unaware of the management, the method being performed by a device according to various embodiments of the present disclosure.

Referring to FIG. 46, the method may be implemented by a computer program. For example, the method may be performed by using a makeup mirror application installed in the device 100. The computer program may operate in an OS installed in the device 100. The device 100 may write the computer program to a storage medium, and may use the computer program by reading the computer program from the storage medium.

In operation S4601, the device 100 may periodically obtain a face image of the user. In operation S4601, the device 100 may obtain the face image of the user while the user is unaware of it. In operation S4601, the device 100 may use a low power consumption regular detection function. Whenever the device 100 detects that the user uses the device 100, the device 100 may obtain the face image of the user. When the device 100 is a smartphone, a condition under which the user uses the device 100 may include that the device 100 determines that the user is viewing the device 100. In the present disclosure, the condition in which the user uses the device 100 is not limited to the aforementioned descriptions.

In operation S4602, the device 1.00 may check a makeup state with respect to the face image of the user which is periodically obtained. The device 100 may compare an after-makeup face image of the user with a current face image of the user and thus may check the makeup state with respect to the face image of the user.

In the present disclosure, a range of checking, by the device 100, the makeup state is not limited to the makeup. For example, as a result of checking the makeup state with respect to the face image of the user, the device 100 may detect rheum from the face image of the user. As the result of checking the makeup state with respect to the face image of the user, the device 100 may detect a nose hair from the face image of the user. As the result of checking the makeup state with respect to the face image of the user, the device 100 may detect foreign substances, such as a red pepper powder, a grain of steamed rice, and the like from the face image of the user.

In operation S4602, as the result of checking the makeup state with respect to the face image of the user, if an undesirable state is detected from the face image of the user, in operation S4603, the device 100 may determine that notification is required. The undesirable state may include a makeup-modification required state (e.g., a smudge of makeup, a removal of the makeup, and the like), a state in which the foreign substances are detected from the face image of the user, or a state in which the nose hair, the sleep, and the like is detected from the face image of the user, but in the present disclosure, the undesirable state is not limited to the aforementioned descriptions.

Accordingly, in operation S4604, the device 100 may provide notification to the user. The notification may be provided in the form of a pop-up window, but in the present disclosure, the form of the notification is not limited to the aforementioned descriptions. For example, the notification may be provided as a particular notification sound or a particular sound message.

In operation S4602, as the result of checking the makeup state with respect to the face image of the user, if the undesirable state is not detected from the face image of the user, in operation S4603, the device 100 may determine that the notification is not required. Accordingly, the device 100 may return to the operation S4601 and may periodically check the makeup state with respect to the face image of the user.

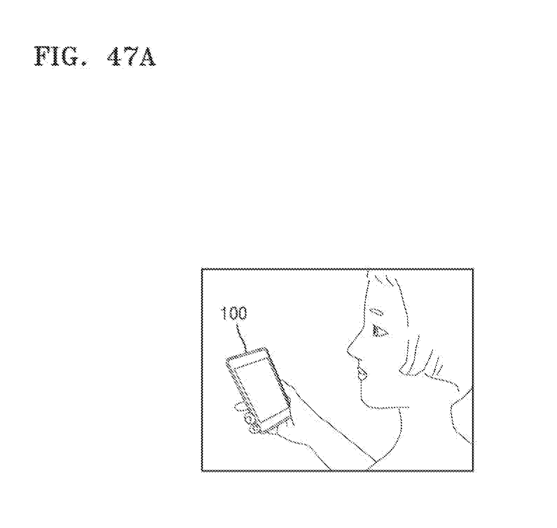

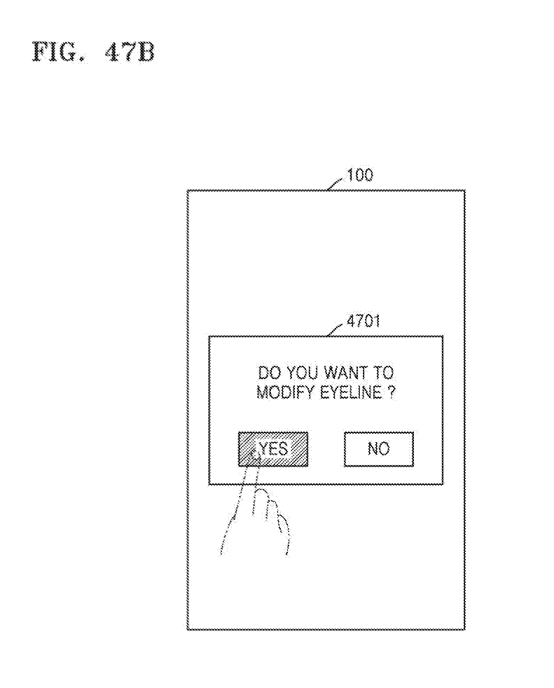

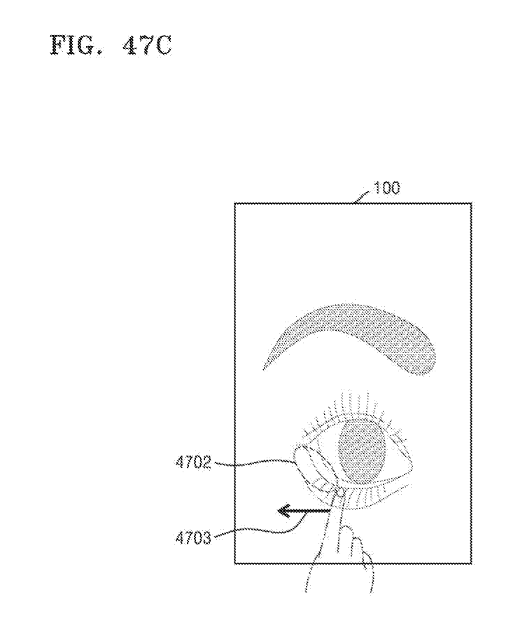

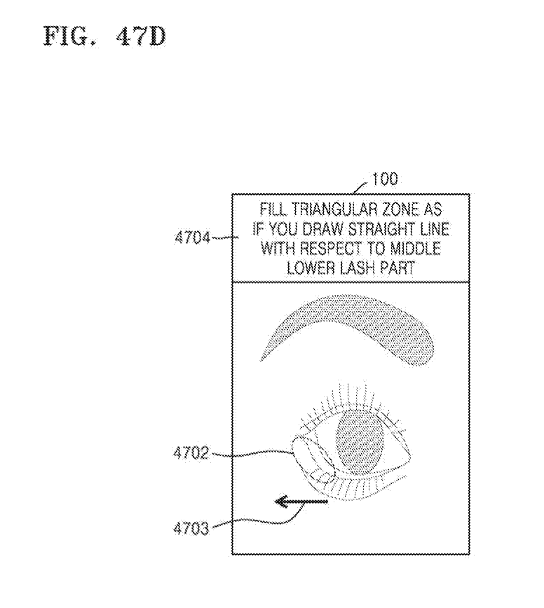

FIGS. 47A to 47D illustrate a makeup mirror of a device, which checks a makeup state of a user while the user is unaware of the checking, and provides makeup guide information according to various embodiments of the present disclosure.

Referring to FIGS. 47A to 47D, while the device 100 recognizes that the user uses the device 100, the device 100 may periodically obtain a face image of the user, and may check a makeup state with respect to the obtained face image of the user. As a result of the check, when the device 100 determines that makeup needs to be modified, the device 100 may provide a makeup modification notification 4701 as shown in FIG. 4713. In the present disclosure, the notification may be provided when the foreign substances are detected from the face image of the user.

The device 100 may provide the makeup modification notification 4701 as shown in FIG. 47B. The makeup modification notification 4701 provided in the present disclosure is not limited to that shown in FIG. 47B. When the notification is provided, the device 100 may have been executing an application, but the present disclosure is not limited thereto. When the notification is provided, the device 100 may be in a lock state. When the notification is provided, the device 100 may be in a screen-off state. The makeup modification notification 4701 may be provided as a pop-up window.

With reference to FIG. 47B, when a user input for modifying the makeup is received, the device 100 may provide a plurality of pieces of makeup guide information 4702 and 4703 as shown in FIG. 47C. When a user input for requesting detailed information about the plurality of pieces of makeup guide information 4702 and 4703 provided with reference to FIG. 47C is received, the device 100 may provide detailed makeup guide information 4704 as shown in FIG. 47D.

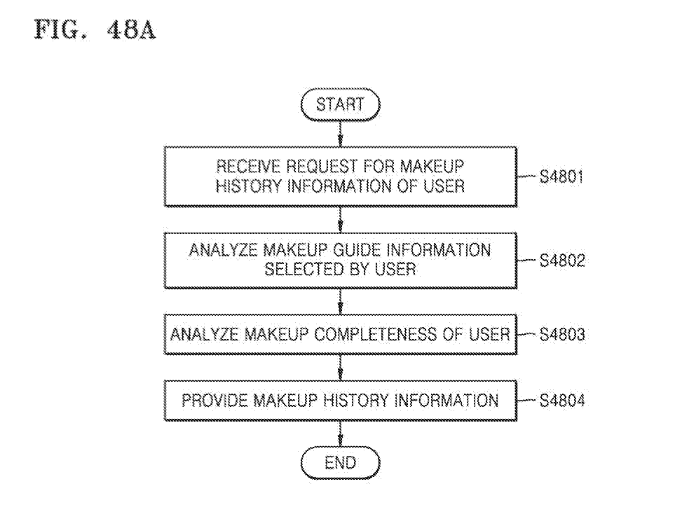

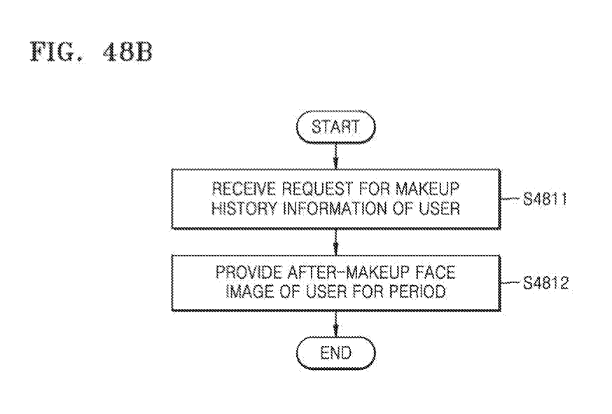

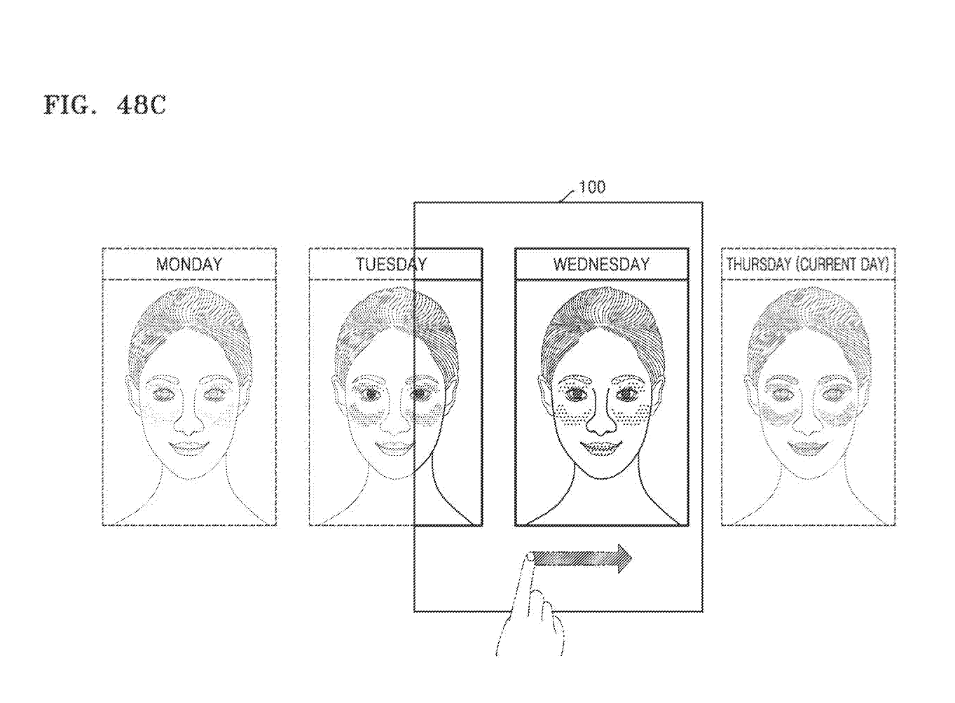

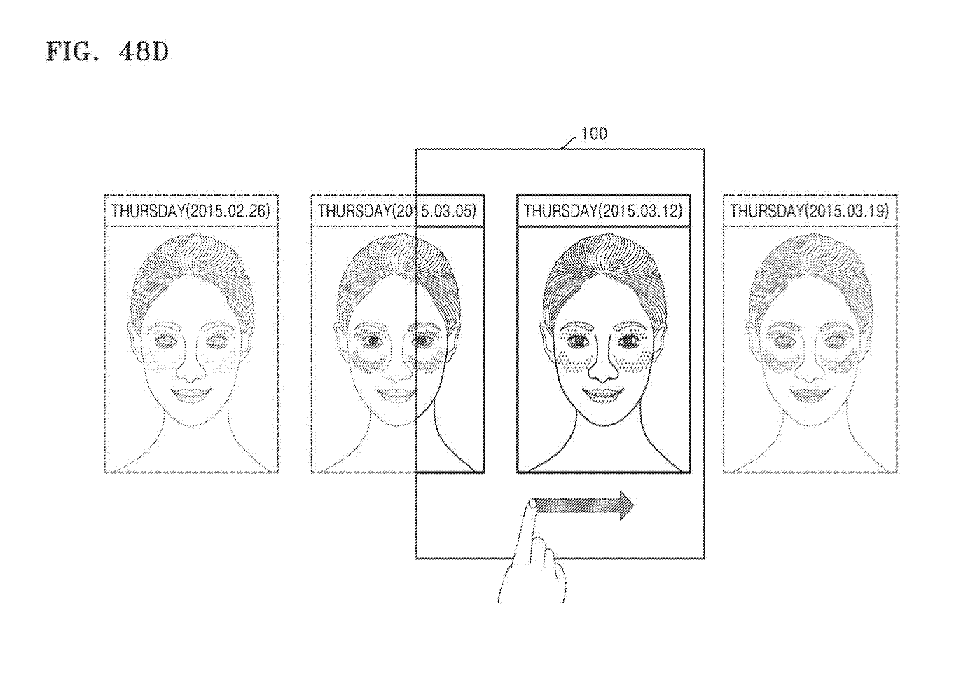

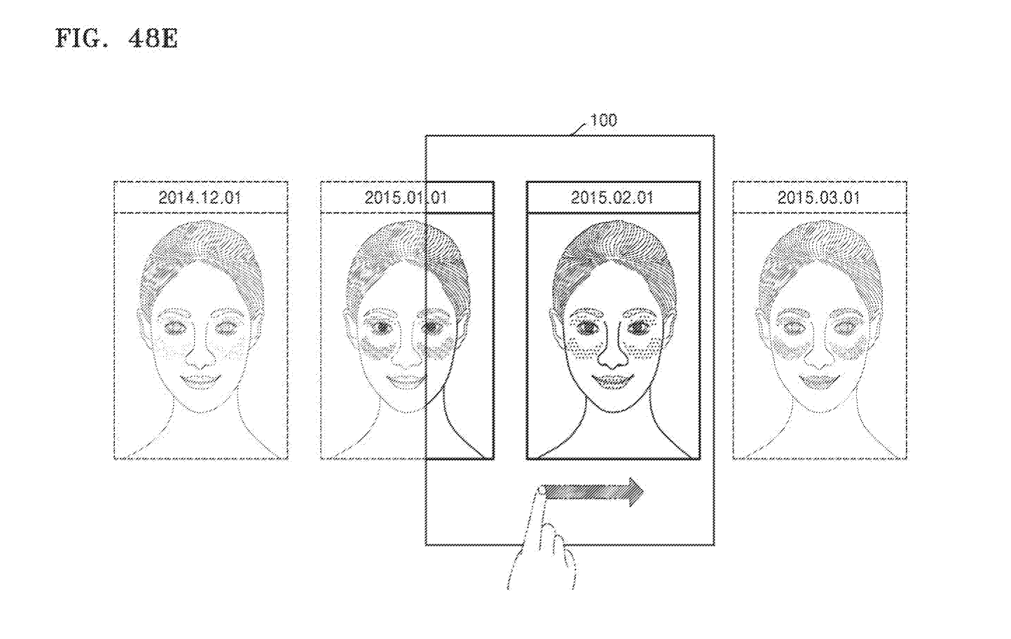

FIG. 48A is a flowchart of a method of providing a makeup mirror that provides makeup history information of a user, the method being performed by a device according to various embodiments of the present disclosure.

Referring to FIG. 48A, the method may be implemented by a computer program. For example, the method may be performed by using a makeup mirror application installed in the device 100. The computer program may operate in an OS installed in the device 100. The device 100 may write the computer program to a storage medium, and may use the computer program by reading the computer program from the storage medium.

In operation S4801, the device 100 may receive a user input of a request for makeup history information of the user. The user input of the request for the makeup history information of the user may be input via the device 100. The user input of the request for the makeup history information of the user may be received from an external device connected to the device 100.

In operation S4802, the device 100 may analyze makeup guide information that was selected by the user. In operation S4803, the device 100 may analyze makeup completeness of the user. The makeup completeness may be obtained from the skin analysis result described with reference to FIGS. 45A and 458. In operation S4804, the device 100 may provide the makeup history information of the user, according to results of analyses in operations S4802 and S4803.

FIG. 48B is a flowchart of a method of providing a makeup mirror that provides another makeup history information of a user, the method being performed by a device according to various embodiments of the present disclosure.

Referring to FIG. 48B, the method may be implemented by a computer program. For example, the method may be performed by using a makeup mirror application installed in the device 100. The computer program may operate in an OS installed in the device 100. The device 100 may write the computer program to a storage medium, and may use the computer program by reading the computer program from the storage medium.

Referring to FIG. 4813, in operation S4811, the device 100 may receive a user input of a makeup history information request with respect to the user. The user input of the makeup history information request with respect to the user may be input by using the device 100. The user input of the makeup history information request with respect to the user may be received from an external device connected to the device 100.

In operation S4812, the device 100 provides an after-makeup face image of a user for a period. In operation S4812, the device 100 may perform a process of setting a user-desired period. For example, the device 100 may perform the process of setting the user-desired period, based on calendar information. For example, the device 100 may perform the process of setting the user-desired period in a unit of a week (Monday through Sunday), in a unit of a day (e.g., Monday), in a unit of a month, or in units of days. In the present disclosure, the user-desired period that can be set by the user is not limited to the aforementioned descriptions.

FIG. 48C illustrates a makeup mirror of a device, which provides makeup history information of a user according to various embodiments of the present disclosure. FIG. 48C illustrates a plurality of pieces of makeup history information being provided in a unit of a week. The device 100 may provide the plurality of pieces of makeup history information of FIG. 48C in a panorama manner, regardless of a user input.

Referring to FIG. 48C, the device 100 daily provides an after-makeup face image of a user. Referring to FIG. 48C, when a touch & drag input (or a page turning input) in a right direction is received, the device 100 provides after-makeup face images of the user in an order of a today's after-makeup face image of the user (e.g., an after-makeup face image of the user on Thursday), a yesterday's after-makeup face image of the user (e.g., an after-makeup face image of the user on Wednesday), and a day before yesterday's after-makeup face image of the user (e.g., an after-makeup face image of the user on Tuesday).

FIG. 48D illustrates a makeup mirror of a device, which provides makeup history information of a user according to various embodiments of the present disclosure. FIG. 48D illustrates a plurality of pieces of makeup history information being provided in a unit of a particular day (e.g., Thursday). The device 100 may provide the plurality of pieces of makeup history information of FIG. 48D in a panorama manner, regardless of a user input.

Referring to FIG. 48D, when a touch & drag input (or a page turning input) in a right direction is received, the device 100 sequentially provides after-makeup face images of the user on Thursdays, starting from an after-makeup face image of the user on a most recent Thursday (e.g., Mar. 19, 2015).

FIG. 48E illustrates a makeup mirror of a device, which provides makeup history information of a user according to various embodiments of the present disclosure. FIG. 48E illustrates a plurality of pieces of the makeup history information being provided in a unit of a month. The device 100 may provide the plurality of pieces of makeup history information of FIG. 48E in a panorama manner, regardless of a user input.

Referring to FIG. 48E, when a touch and drag input (or a page turning input) in a right direction is received, the device 100 sequentially provides after-makeup face images of the user on opening days of months.

In the present disclosure, providable makeup history information is not limited to those described with reference to FIGS. 48A to 48E. For example, the device 100 may provide makeup hi story information based on a plurality of pieces of makeup guide information that were mainly selected by the user.

When the providable makeup history information type is plural in number, the device 100 may provide providable makeup history information types to the user. When one of the makeup history information types is selected by the user, the device 100 may provide makeup history information according to the makeup history information type selected by the user. According to makeup history information types selected by the user, the device 100 may provide a plurality of pieces of different makeup history information.

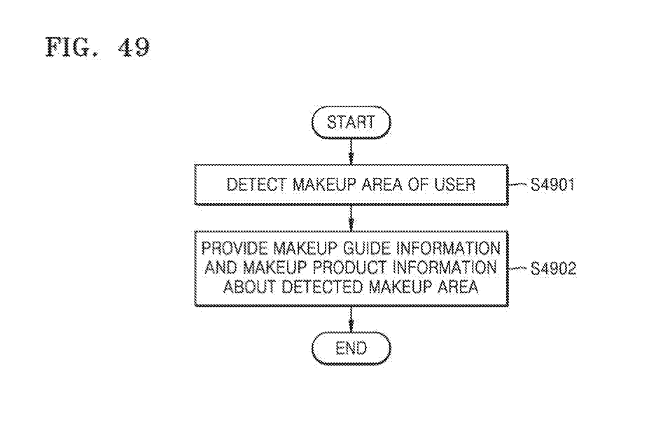

FIG. 49 is a flowchart of a method of providing a makeup mirror that provides makeup guide information and product information, based on a makeup area of a user, the method being performed by a device according to various embodiments of the present disclosure.

Referring to FIG. 49, the method may be implemented by a computer program. For example, the method may be performed by using a makeup mirror application installed in the device 100. The computer program may operate in an OS installed in the device 100. The device 100 may write the computer program to a storage medium, and may use the computer program by reading the computer program from the storage medium.

In operation S4901, the device 100 may detect the makeup area of the user. The device 100 may detect the makeup area of the user in a similar way of detecting the area of interest.

In operation S4902, the device 100 may provide makeup product information while the device 100 displays makeup guide information about the detected makeup area on a face image of the user. The makeup product information may include a product registered by the user. The makeup product information may be provided from an external device connected to the device 100. The makeup product information may be updated in real-time according to information received from the external device connected to the device 100.

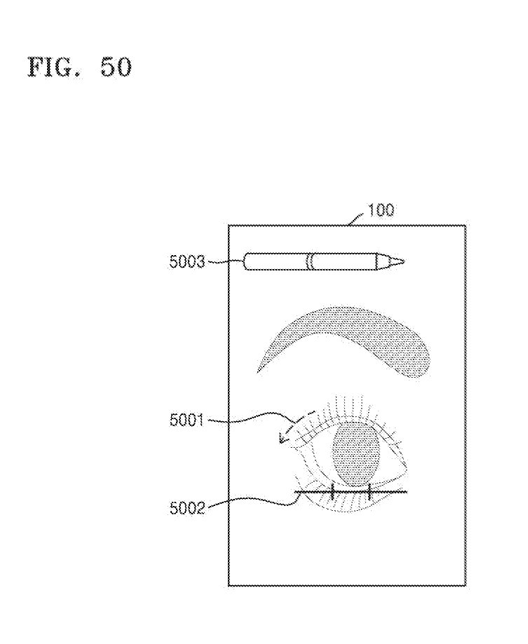

FIG. 50 illustrates a makeup mirror of a device, which provides a plurality of pieces of makeup guide information and makeup product information which are about a makeup area according to various embodiments of the present disclosure.

Referring to FIG. 50, the device 100 may provide the makeup guide information 5001 about drawing an outer corner of an eye according to an eye length. In addition, the device 100 may provide the makeup guide information 5002 about an inner lower lash part, a middle lower lash part, and an outer lower lash part based on trisection of an under eye area. The device 100 may provide the makeup product information 5003 related to the plurality of pieces of makeup guide information 5001 and 5002. In the example of FIG. 50, the device 100 provides a pencil eyeliner as the makeup product information 5003.

According to a user input, when the makeup product information 5003 is changed to information about another makeup product (e.g., a liquid eyeliner), the plurality of pieces of makeup guide information 5001 and 5002 provided by the device 100 may be changed.

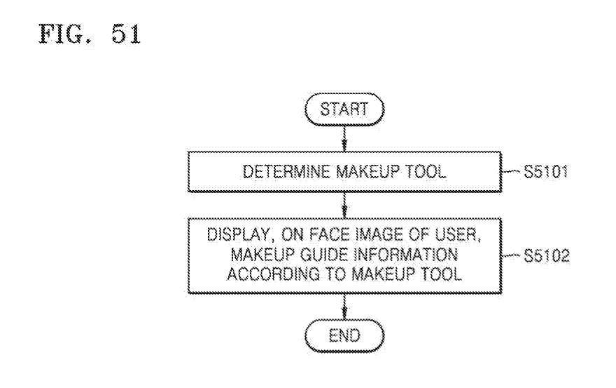

FIG. 51 is a flowchart of a method of providing a makeup mirror that provides makeup guide information according to determination of a makeup tool, the method being performed by a device according to various embodiments of the present disclosure.

Referring to FIG. 51, the method may be implemented by a computer program. For example, the method may be performed by using a makeup mirror application installed in the device 100. The computer program may operate in an OS installed in the device 100. The device 100 may write the computer program to a storage medium, and may use the computer program by reading the computer program from the storage medium.

In operation S5101, the device 100 may determine a makeup tool. The makeup tool may be determined according to a user input. For example, the device 100 may display a plurality of pieces of information about usable makeup tools. When a user input for selecting one piece of information from among the plurality of pieces of displayed information about the makeup tools is received, the device 100 may determine, as a usage-target makeup tool, the makeup tool selected according to the user input.

In operation S5102, the device 100 may display, on a face image of a user, makeup guide information according to the determined makeup tool.

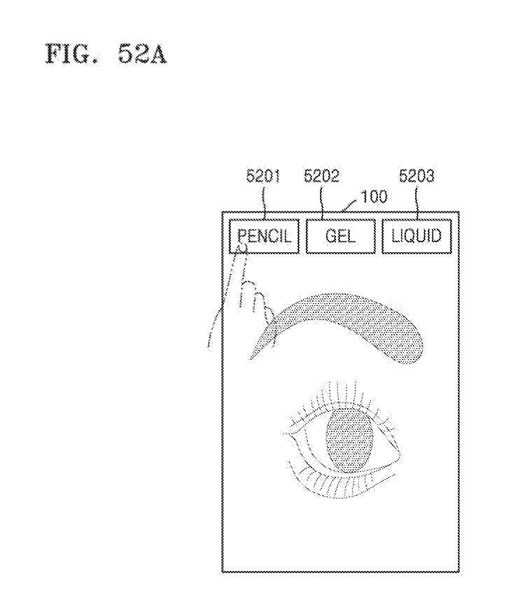

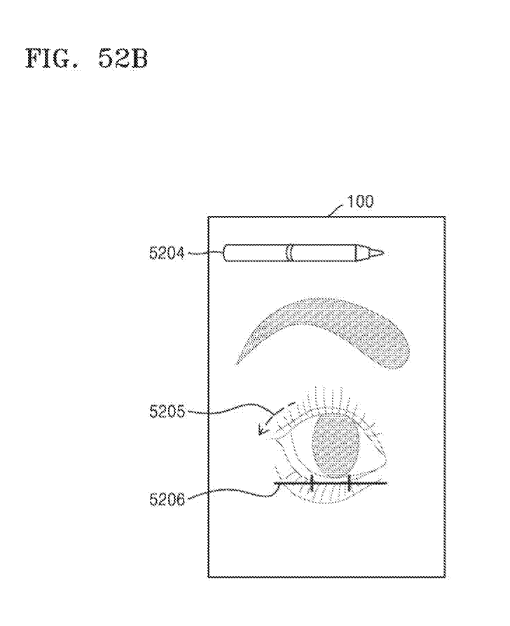

FIGS. 52A and 52B illustrate a makeup minor of a device, which provides makeup guide information according to determination of a makeup tool according to various embodiments of the present disclosure.

Referring to FIG. 52A, the device 100 may provide an eye makeup area and a plurality of pieces of information about makeup tools including a pencil eyeliner 5201, a gel eyeliner 5202, and a liquid eyeliner 5203 that are usable in the eye makeup area.

Referring to FIG. 52A, when a user input for selecting the pencil eyeliner 5201 is received, the device 100 may determine a pencil eyeliner as a makeup tool to be used in an eye makeup.

Referring to FIG. 52B, the device 100 may display, on a face image of a user, an image 5204 and a plurality of pieces of makeup guide information 5205 and 5206 which correspond to the pencil eyeliner 5201.

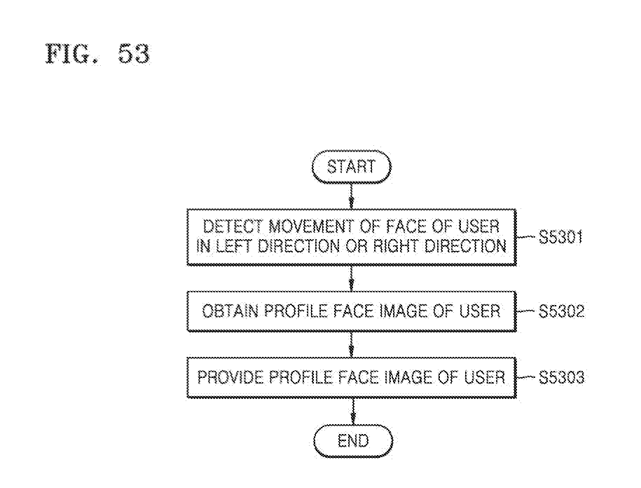

FIG. 53 is a flowchart of a method of providing a makeup mirror that provides a profile face image of a user which the user cannot see, the method being performed by a device according to various embodiments of the present disclosure.

Referring to FIG. 53, the method may be implemented by a computer program. For example, the method may be performed by using a makeup mirror application installed in the device 100. The computer program may operate in an OS installed in the device 100. The device 100 may write the computer program to a storage medium, and may use the computer program by reading the computer program from the storage medium

In operation S5301, the device 100 may detect movement of a face of the user in a left direction or a right direction. The device 100 may detect the movement of the face of the user by comparing face images of the user which are obtained or are received in real-time. The device 100 may detect, by using a head pose estimation technique, left-direction movement or right-direction movement of the face of the user based on a preset angle.

In operation S5302, the device 100 may obtain a face image of the user. When the device 100 detects, by using the head pose estimation technique, the left-direction movement or the right-direction movement of the face of the user which corresponds to the preset angle, the device 100 may obtain a profile face image of the user.

In operation S5303, the device 100 may provide the obtained profile face image of the user. In operation S5303, the device 100 may store the profile face image of the user. According to a user input of a storage request, the device 100 may store the profile face image of the user. The device 100 may provide the stored profile face image of the user, according to a user request. Accordingly, the user may easily view a profile face of the user via the makeup mirror.

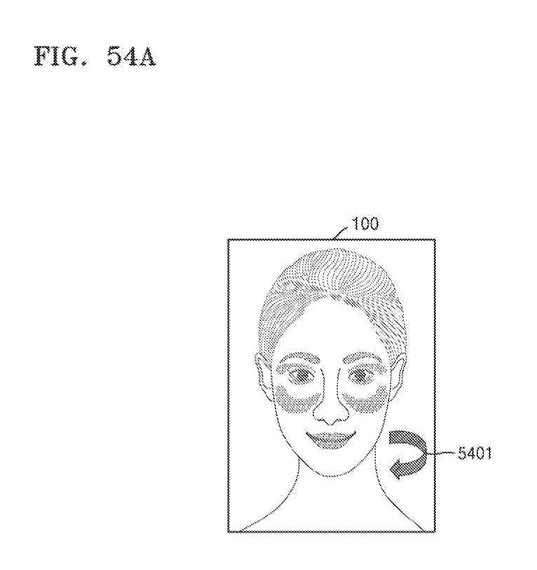

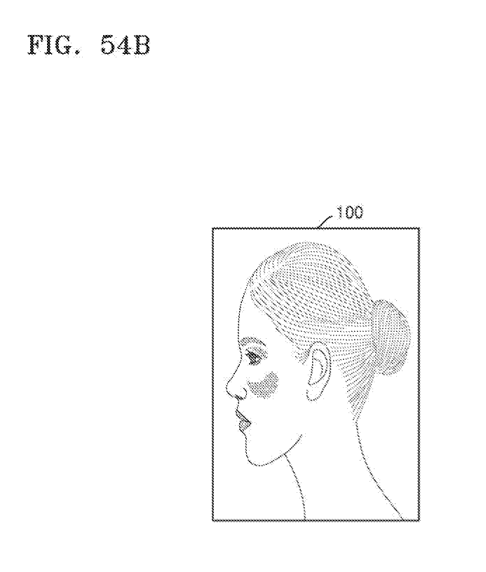

FIGS. 54A and 54B illustrate a makeup mirror of a device, which provides a profile face image of a user which the user cannot see according to various embodiments of the present disclosure.

Referring to FIG. 54A, the device 100 may detect whether a face of the user moves in a left direction or a right direction, by using a head pose estimation technique and face images of the user which are obtained in real-time.

Referring to FIG. 54A, when the face of the user moves by a preset angle in a left direction 5401 with respect to the user who views the device 100, the device 100 ma obtain a face image of the user. The device 100 may provide a profile face image of the user as shown in FIG. 54B.

Referring to FIG. 54B, the preset angle is about 45 degrees, but in the present disclosure, the present angle is not limited thereto. For example, the preset angle may be about 30 degrees. The preset angle may be changed according to a user input.

When a user input for requesting a change in angle information is received, the device 100 may display settable angle information. When the angle information is displayed, the device 100 may provide virtual profile face images that can be provided according to angles, respectively. Therefore, the user may set desired angle information, based on the virtual profile face images.

In addition, a plurality of pieces of angle information may be set in the device 100. When the plurality of pieces of angle information are set, the device 100 may obtain face images of the user at a plurality of angles. The device 100 may provide, via split screens, the face images of the user obtained at the plurality of angles. The device 100 may provide, via a plurality of pages, the face images of the user obtained at the plurality of angles. The device 100 may provide, in a panorama manner, the face images of the user obtained at the plurality of angles.

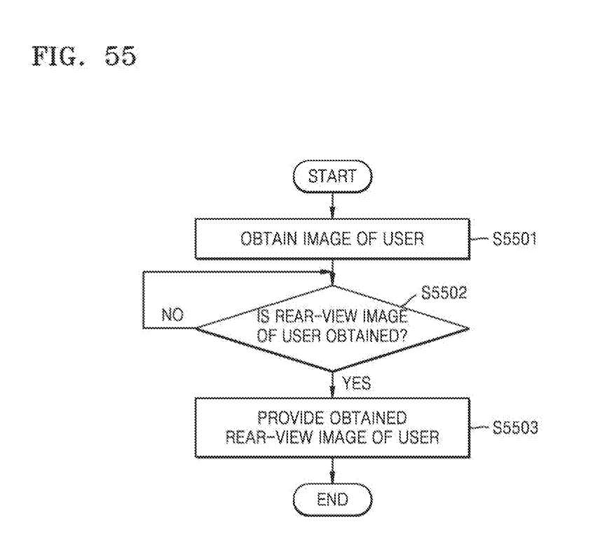

FIG. 55 is a flowchart of a method of providing a makeup mirror that provides a rear-view image of a user, the method being performed by a device according to various embodiments of the present disclosure.

Referring to FIG. 55, the method may be implemented by a computer program. For example, the method may be performed by using a makeup mirror application installed in the device TOO. The computer program may operate in an OS installed in the device 100. The device 100 may write the computer program to a storage medium, and may use the computer program by reading the computer program from the storage medium.

In operation S5501, the device 100 may obtain in real-time images of the user based on a face of the user. The device 100 may compare images of the user which are obtained in real-time. As a result of the comparison, in operation S5502, if an image determined as a rear-view image of the user is obtained, in operation S5503, the device 100 may provide the obtained rear-view image of the user. Accordingly, the user may easily see a rear-view of the user by using the makeup mirror.

The device 100 may provide the rear-view image of the user, according to a request from the user. In operation S5503, the device 100 may store the obtained rear-view image of the user. When a user input of a storage request is received, the device 100 may store the rear-view image of the user.

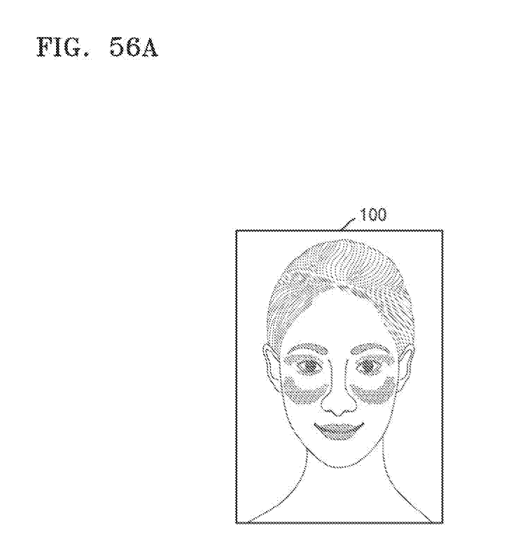

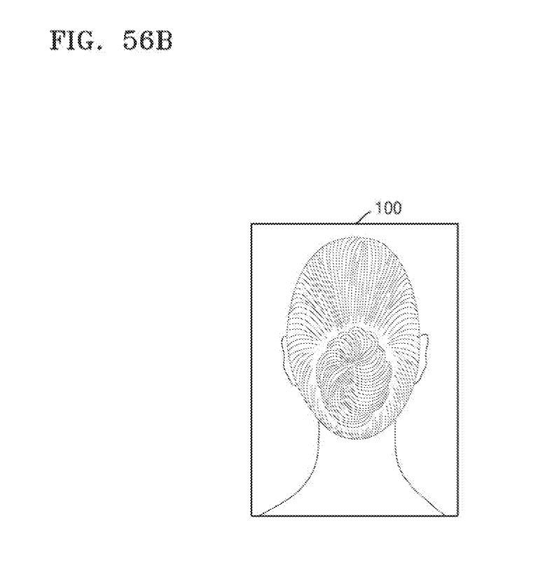

FIGS. 56A and 56B illustrate a makeup mirror of a device, which provides a rear-view image of a user according to various embodiments of the present disclosure.

Referring to FIGS. 56A and 56B, the device 100 may obtain face images of the user in real-time. As a result of comparing the obtained face images of the user, as shown in FIG. 56B, if an image determined as a rear-view image of the user is obtained, the device 100 may provide the obtained rear-view image of the user.

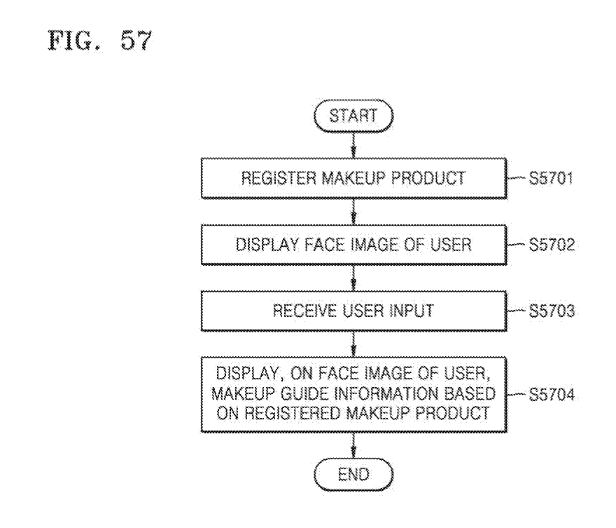

FIG. 57 is a flowchart of a method of providing a makeup mirror that provides makeup guide information based on a makeup product registered by a user, the method being performed by a device according to various embodiments of the present disclosure.

Referring to FIG. 57, the method may be implemented by a computer program. For example, the method may be performed by using a makeup mirror application installed in the device 100. The computer program may operate in an OS installed in the device 100. The device 100 may write the computer program to a storage medium, and may use the computer program by reading the computer program from the storage medium.

In operation S5701, the device 100 may register user makeup product information. The device 100 may register the user makeup product information for each step, and each facial part of the user. To do so, the device 100 may provide guide information for inputting makeup product information for each of the steps (e.g., a base step, a cleansing step, a makeup step, and the like) and for each of the facial parts (e.g., eyebrows, eyes, cheeks, lips, and the like) of the user.

In operation S5702, the device 100 may display a face image of the user. The device 100 may display the face image of the user which is obtained or is received in the operation S301 of FIG. 3.

In operation S5703, when a user input for requesting a makeup guide is received, the device 100 may display, on the face image of the user, makeup guide information based on the registered user makeup product information. For example, in operation S5701, if a product related to a cheek makeup is not registered, in operation S5704, the device 100 may not display cheek makeup guide information on the face image of the user.

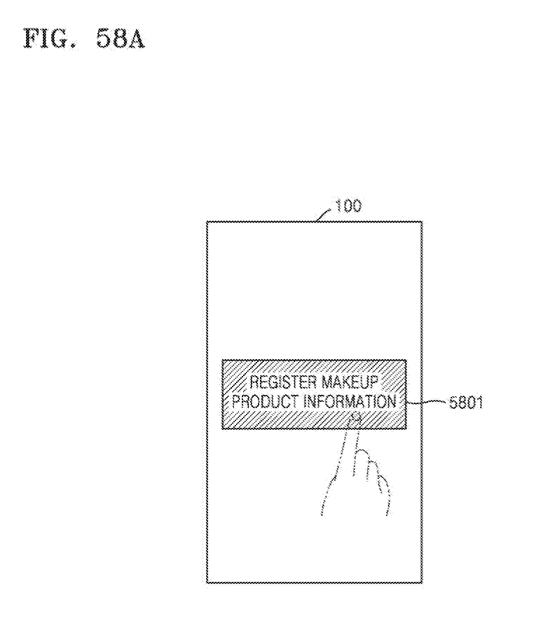

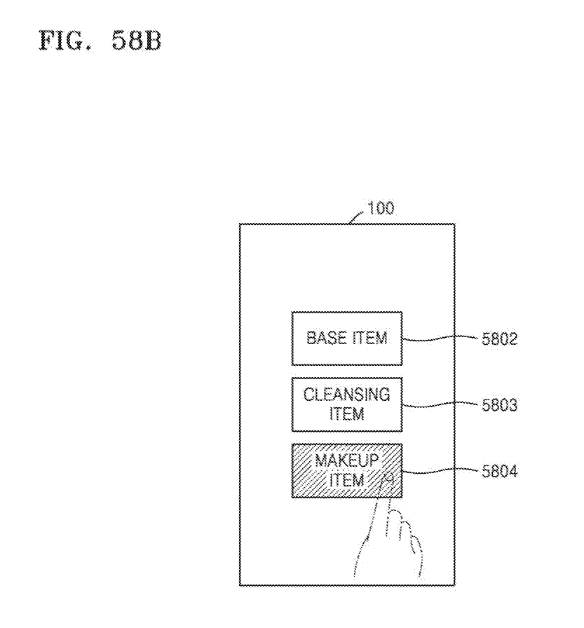

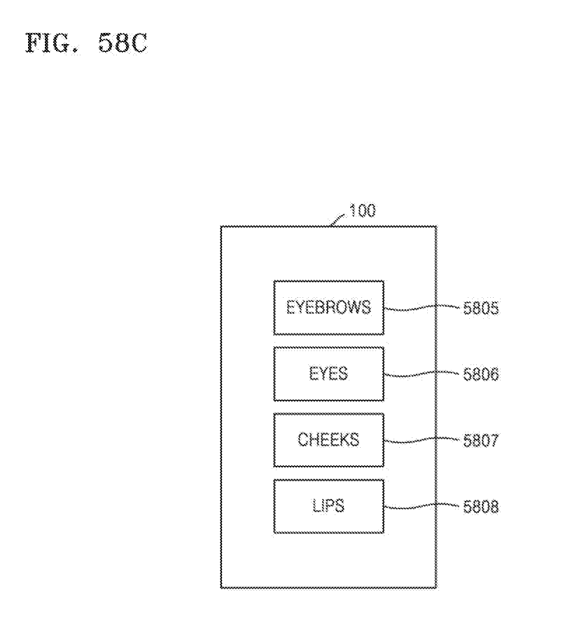

FIGS. 58A to 58C illustrate a makeup mirror of a device, which provides a process of registering user makeup product information according to various embodiments of the present disclosure.

Referring to FIG. 58A, when a user input for registering makeup product information is received based on a ‘Register makeup product information’ message 5801, the device 100 may provide a plurality of pieces of guide information respectively corresponding to steps (a base item 5802, a cleansing item 5803, and a makeup item 5804). In the present disclosure, the plurality of pieces of guide information that respectively correspond to the steps are not limited to those shown in FIG. 58B.

Referring to FIGS. 58B and 58C, when a user input for selecting the makeup item 5804 is received, the device 100 may provide a plurality of pieces of guide information for facial parts (eyebrows 5805, eyes 5806, cheeks 5807, and lips 5808) as shown in FIG. 58C.

The device 100 may provide image-type guide information for registering the makeup product information.

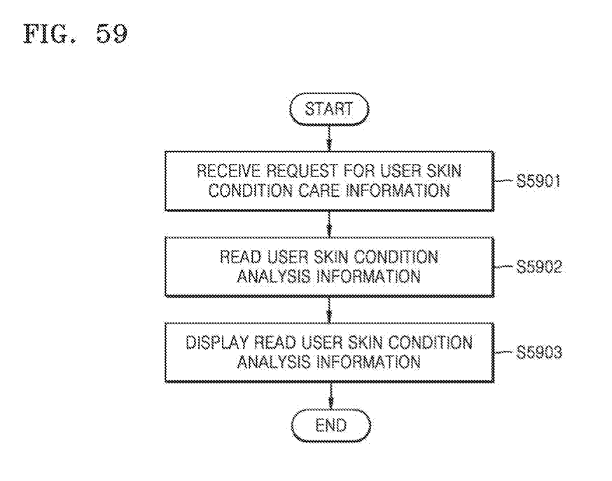

FIG. 59 is a flowchart of a method of providing a makeup mirror that provides user skin condition care information, the method being performed by a device according to various embodiments of the present disclosure.

Referring to FIG. 59, the method may be implemented by a computer program. For example, the method may be performed by using a makeup mirror application installed in the device 100. The computer program may operate in an OS installed in the device 100. The device 100 may write the computer program to a storage medium, and may use the computer program by reading the computer program from the storage medium.

In operation S5901, the device 100 receives a user input of a request for the user skin condition care information. The user input may include a touch-based user input via the device 100, a user input based on a voice signal of the user of the device 100, or a gesture-based user input via the device 100. The user input may be provided from an external device connected to the device 100.

When the user input is received in operation S5901, in operation S5902, the device 100 reads user skin condition analysis information from a memory included in the device 100. The user skin condition analysis information may be stored in the external device connected to the device 100. The user skin condition analysis information may be stored in the memory included in the device 100 or may be stored in the external device. In this case, the device 100 may selectively use the user skin condition analysis information stored in the memory included in the device 100 or the user skin condition analysis information stored in the external device.

The user skin condition analysis information may include the skin analysis result described with reference to FIG. 44. The device 100 may periodically obtained user skin condition analysis information.

In operation S5902, the device 100 may perform a process of receiving user-desired period information. The user may set period information as in the operation 54812 of FIG. 4813. When the device 100 receives the user-desired period information, the device 100 may determine a range of reading the user skin condition analysis information, according to the user-desired period information.

For example, when the received period information indicates every Saturday, the device 100 may read, on every Saturday, the user skin condition analysis information from the memory included in the device 100 or from the external device. The read user skin condition analysis information may include a face image of a user to which skin condition analysis information is applied.

In operation S5903, the device 100 displays the read user skin condition analysis information. The device 100 may display the user skin condition analysis information in the form of numerical information. The device 100 may display the user skin condition analysis information based on the face image of the user. The device 100 may display the user skin condition analysis information along with the face image of the user and the numerical information. Accordingly, the user may easily check a user skin condition change according to time.

In operation S5903, when the device 100 displays the user skin condition analysis information based on the face image of the user, the device 100 may perform the facial feature matching processing and/or the pixel-unit matching processing on face images of the user to be displayed, as described with reference to the operation S4002 of FIG. 40.

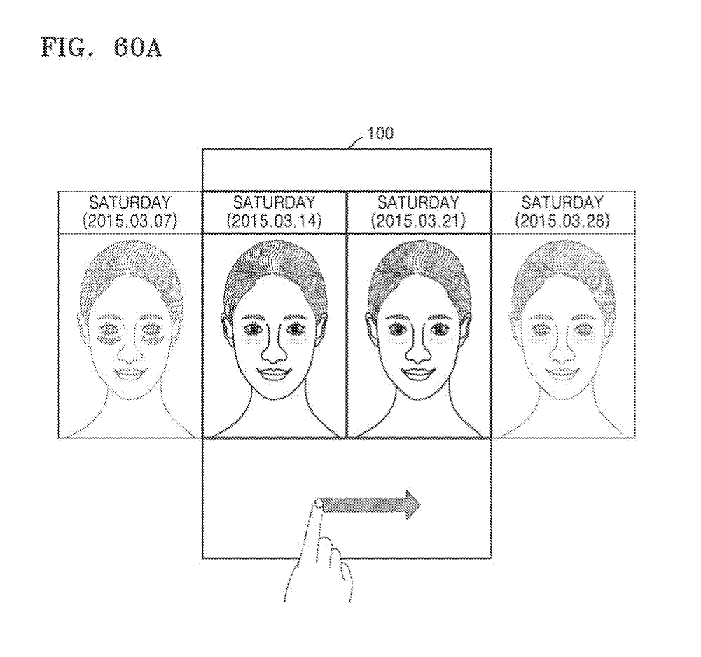

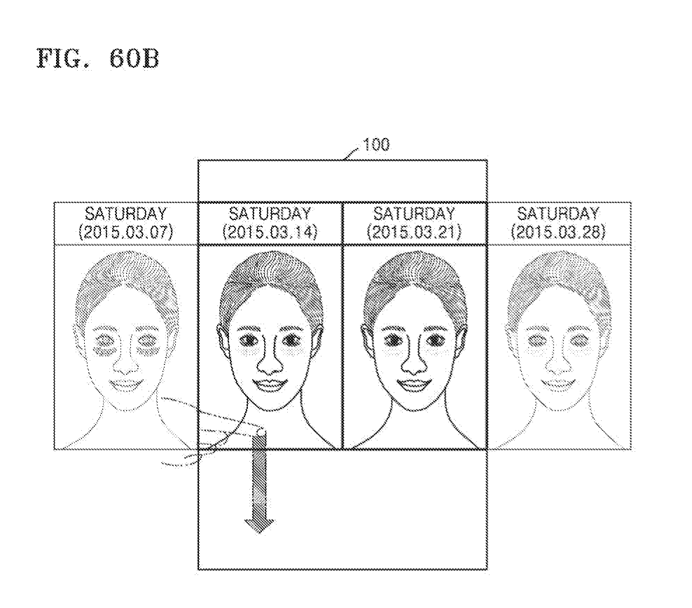

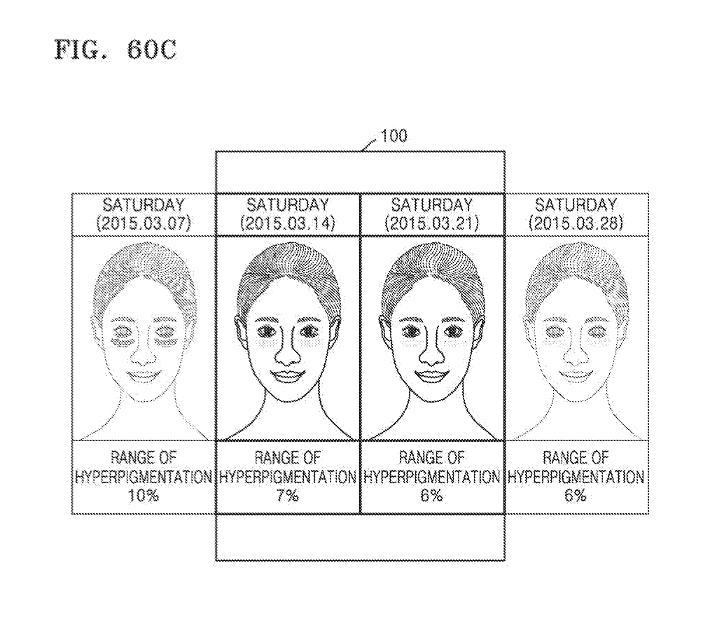

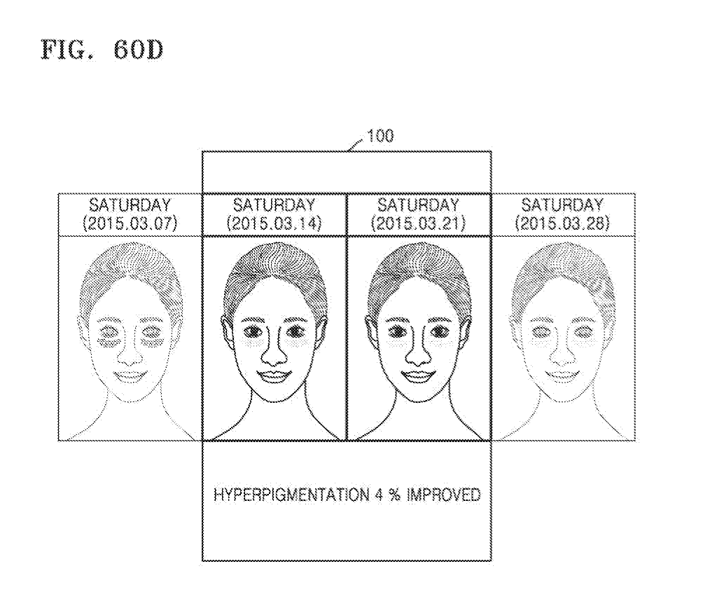

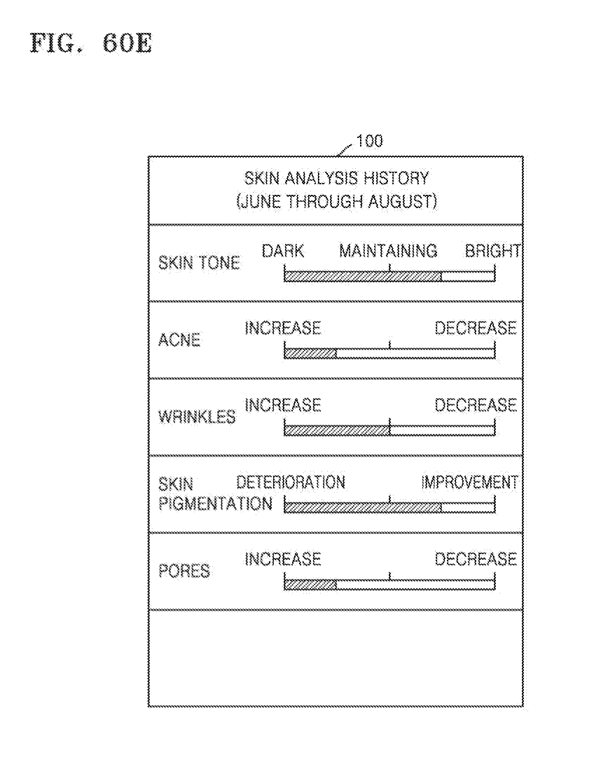

FIGS. 60A to 60E illustrate a makeup mirror of a device, which provides a plurality of pieces of user skin condition care information according to various embodiments of the present disclosure.

Referring to FIGS. 60A to 60D, the plurality of pieces of the user skin condition care information may be provided in a panorama manner, regardless of a user input. The examples of FIGS. 60A through 60D are based on hyperpigmentation. In the present disclosure, providable user skin condition care information is not limited to the hyperpigmentation. For example, the plurality of pieces of user skin condition care information that may be provided in the present disclosure may be provided, according to the items shown in FIG. 45A. In the present disclosure, the plurality of pieces of user skin condition care information that may be provided may be based on at least two items from among the items shown in FIG. 45A.

Referring to FIG. 60A, the device 100 displays, on a face image of a user, hyperpigmentation information detected from a face image of the user on every Saturday. When a touch and drag user input as shown in FIG. 60A is received, the device 100 switches and displays face images of the user to which the hyperpigmentation information is applied. Accordingly, the user may easily recognize a change in hyperpigmentation on the face image of the user.

Referring to FIGS. 60B and 60C, when a touch and drag user input based on an area where a face image of the user is displayed is received, the device 100 may display, as shown in FIG. 60C, a plurality of pieces of numerical information related to hyperpigmentation that respectively correspond to face images of the user.

Referring to FIGS. 60B and 60D, when the touch and drag user input based on the area where the face image of the user is displayed is received, the device 100 may display, as shown in FIG. 60D, detailed information indicating that the hyperpigmentation has been 4% improved from the face image of the user.

Referring to FIG. 60E, the device 100 displays an analysis result value with respect to each of skin analysis items (e.g., a skin tone, acne, wrinkles, hyperpigmentation, pores, and the like) that are measured during a particular period (e.g., between June through August).

Referring to FIG. 60E, the user may recognize that a skin tone has been improved to become bright, wrinkles have not been improved, hyperpigmentation has been improved, and pores have been increased.

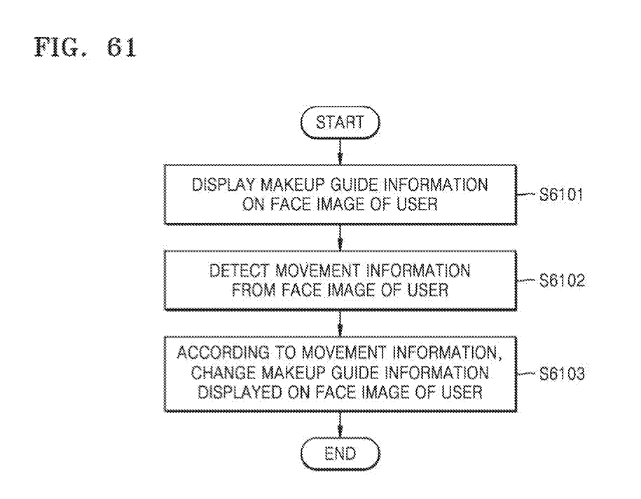

FIG. 61 is a flowchart of a method of providing a makeup mirror that changes makeup guide information according to movement in an obtained face image of a user, the method being performed by the device 100, according to various embodiments of the present disclosure.

Referring to FIG. 61, the method may be implemented by a computer program. For example, the method may be performed by using a makeup mirror application installed in the device 100. The computer program may operate in an OS installed in the device 100. The device 100 may write the computer program to a storage medium, and may use the computer program by reading the computer program from the storage medium.

In operation S6101, the device 100 displays makeup guide information on a face image of the user. The device 100 may display the makeup guide information on the face image of the user as described with reference to FIG. 3.

In operation S6102, the device 100 detects movement information from the face image of the user. The device 100 may detect the movement information from the face image of the user by detecting a difference image with respect to a difference between frames of the obtained face image of the user. The face image of the user may be obtained in real-time. In the present disclosure, to detect the movement information from the face image of the user is not limited to the aforementioned descriptions. For example, the device 100 may detect the movement information from the face image of the user by detecting a plurality of pieces of movement information of facial features from the face image of the user. The movement information may include a movement direction and an amount of movement, but in the present disclosure, the movement information is not limited to the aforementioned descriptions.

In operation S6102, when the movement information is detected from the face image of the user, in operation S6103, the device 100 changes the makeup guide information according to the detected movement information, wherein the makeup guide information is displayed on the face image of the user.

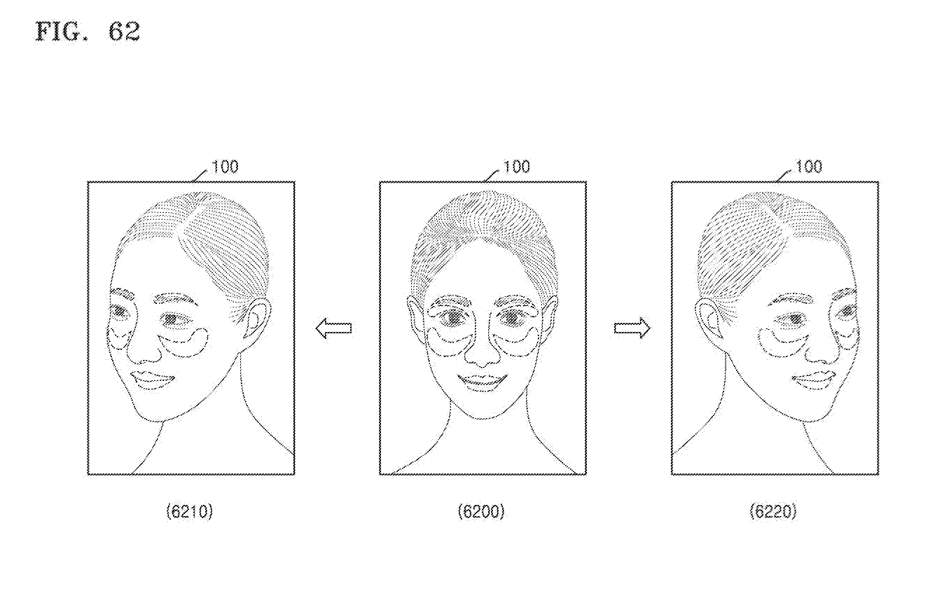

FIG. 62 illustrates a makeup mirror of a device, which changes makeup guide information according to movement information detected from a face image of a user according to various embodiments of the present disclosure.

Referring to FIG. 62, when makeup guide information is displayed on an obtained face image of the user, as shown on a screen 6200, if movement information indicating that a face of the user moves in a right direction is detected from face images of the user which are obtained in real-time, the device 100 may change, as shown on a screen 6210, the displayed makeup guide information according to the detected movement information.

In addition, referring to FIG. 62, if movement information indicating that the face of the user moves in a left direction is detected from face images of the user which are obtained in real-time, the device 100 may change, as shown on a screen 6220, the displayed makeup guide information according to the detected movement information.

In the present disclosure, an operation of changing the displayed makeup guide information, according to the movement information detected from the obtained face image of the user is not limited to those shown in FIG. 62. For example, if movement direction included in the movement information indicates an upward direction, the device 100 may change the makeup guide information according to an amount of detected movement in the upward direction, if the movement direction included in the movement information indicates a downward direction, the device 100 may change the makeup guide information according to an amount of detected movement in the downward direction.

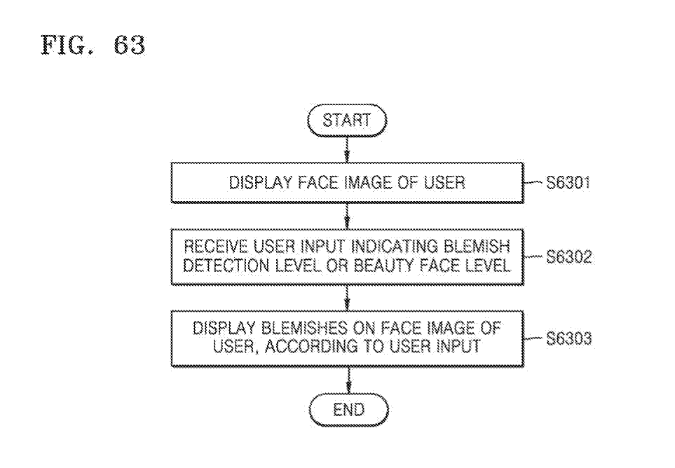

FIG. 63 is a flowchart of a method of providing a makeup mirror that displays blemishes on a face image of a user according to a user input, the method being performed by the device 100, according to various embodiments of the present disclosure.

Referring to FIG. 63, the method may be implemented by a computer program. For example, the method may be performed by using a makeup mirror application installed in the device 100. The computer program may operate in an OS installed in the device 100. The device 100 may write the computer program to a storage medium, and may use the computer program by reading the computer program from the storage medium.

In operation S6301, the device 100 displays a face image of the user. The device 100 may display the face image of the user which is obtained in real-time. The device 100 may select one of face images of the user which are stored in the device 100, according to a user input, and may display the selected face image. The device 100 may display a face image of the user received from an external device. The face image of the user received from the external device may be a face image obtained in real-time in the external device. The face image of the user received from the external device may be a face image stored in the external device.

In operation S6302, the device 100 receives a user input indicating a blemish detection level or a beauty face level. The blemishes may include moles, chloasma, or freckles. The blemishes may include wrinkles. The blemish detection level may be expressed as a threshold value at which the blemishes are emphasised and displayed. The beauty face level may be expressed as a threshold value at which the blemishes are blurred and displayed.

The threshold value may be preset. The threshold value may be variably set. When the threshold value is variably set, the threshold value may be determined according to a pixel value of an adjacent pixel which is included in a preset range (e.g., the present range described with reference to FIG. 34). The threshold value may be variably set based on a preset value and the pixel value of the adjacent pixel.

The blemish detection level or the beauty face level may be expressed based on the face image of the user which is displayed in the operation S6301. For example, the device 100 may express, as a ‘0’ level, the face image of the user which is displayed in the operation S6301, and may express a negative (−) value (e.g., −1, −2, . . . ) as the blemish detection level and may express a positive (+) value (e.g., +1, +2, . . . ) as the beauty face level.

When the blemish detection level and the beauty face level are expressed as described above, when the negative value is decreased, the device 100 may emphasize and display blemishes on the face image of the user. For example, the device 100 may further emphasize and display the blemishes on the face image of the user when the blemish detection level is ‘−2’ than when the blemish detection level is ‘−1’. Therefore, when the negative value is decreased, the device 100 may further emphasize and display more blemishes on the face image of the user.

When the positive value is increased, the device 100 may blur and display the blemishes on the face image of the user. For example, when the beauty face level is ‘+2’ other than ‘+1’, the device 100 may further blur and display the blemishes on the face image of the user. Therefore, when the positive value is further increased, the device 100 may further blur and display more blemishes on the face image of the user. In addition, when the positive value is further increased, the device 100 may brightly display the face image of the user. When the positive value is a large value, the device 100 may display a flawless face image of the user.

In order to blur and display the blemishes on the face image of the user or to brightly display the face image of the user, the device 100 may perform blurring on the face image of the user. A level of the blurring on the face image of the user may be determined based on the beauty face level. For example, when the beauty face level is ‘+2’ other than ‘+2’, the level of the blurring on the face image of the user may be high.

The beauty face level may be expressed as a threshold value for removing the blemishes from the face image of the user. Accordingly, the beauty face level may be included in the blemish detection level. In a case where the beauty face level is included in the blemish detection level, when the blemish detection level is a positive value and the positive value is increased, the device 100 may blur (or may remove) and display the blemishes on the face image of the user.

In the present disclosure, the expression with respect to the blemish detection level and the beauty face level is not limited to the aforementioned descriptions. For example, the device 100 may express a negative (−) value as the beauty face level, and may express a positive (+) value as the blemish detection level.

When the blemish detection level and the beauty face level are expressed as described above, the device 100 may blue and display the blemishes on the face image of the user when the negative value is decreased. For example, when the beauty face level is ‘−2’ other than ‘−1’, the device 100 may further blur and display the blemishes on the face image of the user. Therefore, when the negative value is decreased, the device 100 may further blur and display more blemishes on the face image of the user.

When the blemish detection level is ‘+2’ other than ‘+1’, the device 100 may further emphasize and display the blemishes on the face image of the user. Accordingly, when the positive value is increased, the device 100 may further emphasize and display more blemishes on the face image of the user.

In the present disclosure, the blemish detection level and the beauty face level may be expressed as colour values. For example, the device 100 may express the blemish detection level so that, when it is a darker colour, the blemishes may be further emphasized and displayed. The device 100 may express the beauty face level so that, when it is a brighter colour, the blemishes may be further blurred and displayed. The colour values corresponding to the blemish detection level and the beauty face level may be expressed as gradation colours.

In the present disclosure, the blemish detection level and the beauty face level may be expressed based on a size of a bar graph. For example, the device 100 may express the blemish detection level so that, when a size of a bar graph is increased with respect to the face image of the user which is displayed in the operation S6301, the blemishes may be further emphasized and displayed. The device 100 may express the beauty face level so that, when a size of a bar graph is increased with respect to the face image of the user which is displayed in the operation S6301, the blemishes may be further blurred and displayed.

As described above, the device 100 may set a plurality of the blemish detection levels and a plurality of the beauty face levels. The blemish detection levels and the beauty face levels may be divided according to pixel-unit colour information (or a pixel value).

Colour information corresponding to the plurality of the blemish detection levels may have a value lesser than that of colour information corresponding to the plurality of beauty face levels. The colour information corresponding to the blemish detection levels may have a value lesser than that of colour information corresponding to a skin colour of the face image of the user. Colour information corresponding to some levels from among the beauty face levels may have a value lesser than that of the colour information corresponding to the skin colour of the face image of the user. The colour information corresponding to some levels from among the beauty face levels may have a value equal to or greater than that of the colour information corresponding to the skin colour of the face image of the user.

The blemish detection level for further emphasizing and displaying the blemishes may have decreased pixel-unit colour information. For example, pixel-unit colour information corresponding to the blemish detection level of −2 may be smaller than pixel-unit colour information corresponding to the blemish detection level of −1.

The beauty face level for further blurring and displaying the blemishes may have increased pixel-unit colour information. For example, pixel-unit colour information corresponding to the beauty face level of +2 may be greater than pixel-unit colour information corresponding to the beauty face level of +1.

The device 100 may set the blemish detection level so as to detect blemishes having a small colour difference with respect to the skin colour of the face image of the user and/or thin wrinkles from the face image of the user. The device 100 may set the blemish detection level so that detect blemishes having a great colour difference with respect to the skin colour of the face image of the user and/or thick wrinkles may be removed from the face image of the user.

In operation S6303, the device 100 displays the blemishes on the displayed face image of the user, according to the user input.

When the user input received in the operation S6302 indicates the blemish detection level, in operation S6303, according to the blemish detection level, the device 100 emphasizes and displays the detected blemishes on the face image of the user which is displayed in the operation S6301,

When the user input received in the operation S6302 indicates the beauty face level, in operation S6303, according to the beauty face level, the device 100 blurs and displays the detected blemishes on the face image of the user which is displayed in the operation S6301. In operation S6303, the device 100 may display a flawless face image of the user according to the beauty face level.

For example, when the device 100 receives the beauty face level of +3, the device 100 may detect blemishes from the face image of the user which is displayed in the operation S6301, based on pixel-unit colour information corresponding to the received beauty face level of +3, and may display the detected blemishes. The pixel-unit colour information corresponding to the beauty face level of +3 may have a value greater than pixel-unit colour information corresponding to the beauty face level of +1. Accordingly, the number of the blemishes detected at the beauty face level of +3 may be lesser than the number of blemishes detected at the beauty face level of +1.

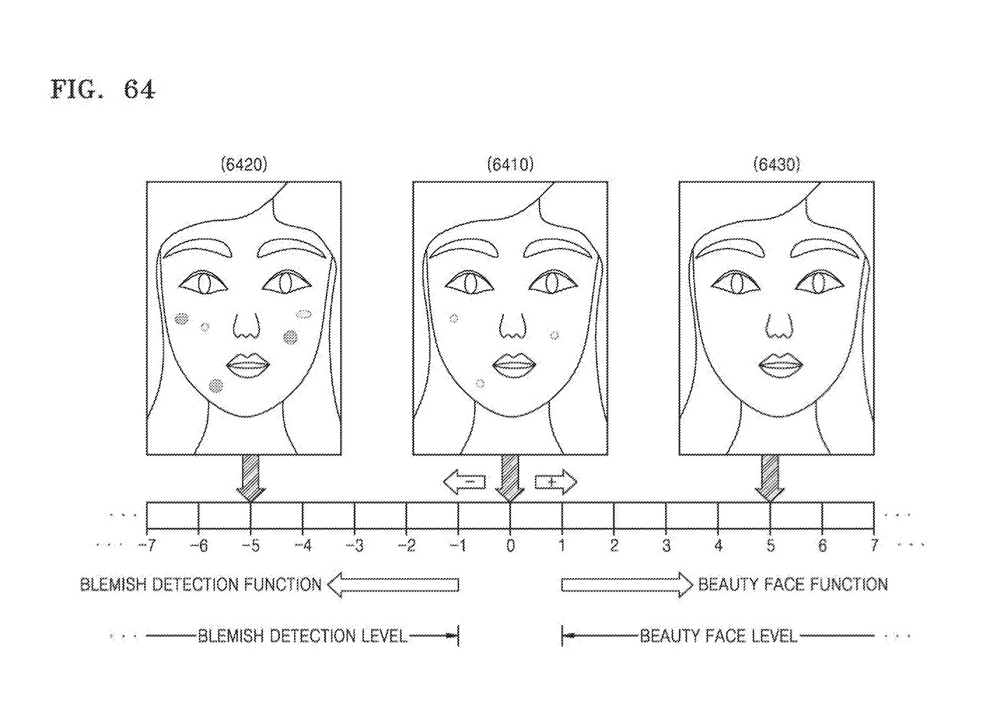

FIG. 64 illustrates examples of a makeup mirror corresponding to a blemish detection level and a beauty face level set in a device according to various embodiments of the present disclosure.

Referring to FIG. 64, the device 100 expresses, as a ‘0’ level, the face image of the user which is displayed in the operation S6301. The device 100 expresses the blemish detection level by using a negative value. The device 100 expresses the beauty face level by using a positive value.

Referring to FIG. 64, the device 100 may provide a blemish detection function for providing a face image of the user based on the blemish detection level. Referring to FIG. 64, the device 100 may provide a beauty face function for providing a face image of the user based on the beauty face level.

With reference to an example 6410 of FIG. 64, the device 100 provides a makeup mirror that displays the face image of the user described in the operation S6301. Referring to the example 6410 of FIG. 64, the displayed face image of the user includes blemishes.

With reference to an example 6420 of FIG. 64, the device 100 provides a makeup mirror that displays a face image of the user according to the blemish detection level of −5. Referring to the example 6420 of FIG. 64, it is possible to check that the number and area of blemishes included in the face image of the user are increased, compared to the number and area of blemishes included in the face image of the user which is displayed in the example 6410 of FIG. 64.

With reference to the example 6420 of FIG. 64, the device 100 may differently display the blemishes, based on a difference between colors of the blemishes and a skin color of the face image of the user. When the blemishes are differently displayed in the example 6420 of FIG. 64, the device 100 may provide guide information about the blemishes.

For example, the device 100 detects a difference between colors of the blemishes displayed in the example 6420 of FIG. 64 and the skin color of the face image of the user. The device 100 compares the detected difference with a reference value and groups the blemishes displayed in the example 6420 of FIG. 64. The reference value may be preset, may be set according to a user input, or may vary. The device 100 may detect the difference by using an image gradient value detecting algorithm. When the number of the reference values is 1, the device 100 divides the blemishes to a group 1 and a group 2. When the number of the reference values is 2, the device 100 divides the blemishes to a group 1, a group 2, and a group 3. In the present disclosure, the number of the reference values is not limited to the aforementioned descriptions. For example, when the number of the reference values is N, the device 100 may divide the blemishes to N+1 groups. Here, N is a positive integer.

When the blemishes are divided to the group 1 and the group 2, and a blemish whose difference is equal to or greater than the reference value is included in the group 1, the device 100 may highlight and display blemishes included in the group 1. In this case, the device 100 may provide guide information about the highlighted blemishes (e.g., the highlighted blemishes may have serious hyperpigmentation). In addition, the device 100 may provide guide information for each of the highlighted blemishes and not-highlighted blemishes.

With reference to an example 6430 of FIG. 64, the device 100 provides a makeup mirror that displays a face image of the user according to the beauty face level of +5. Referring to the example 6430 of FIG. 64, the device 100 displays the face image of the user form which the blemishes on the face image of the user displayed in the example 6410 of FIG. 64 are all removed.

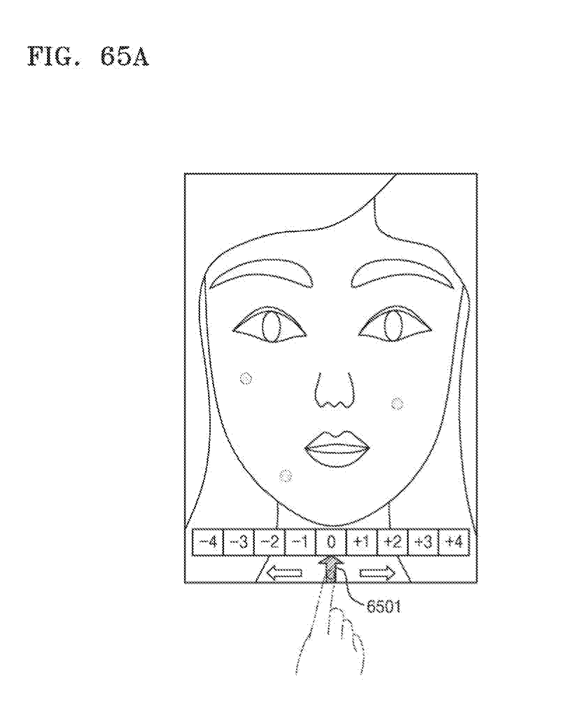

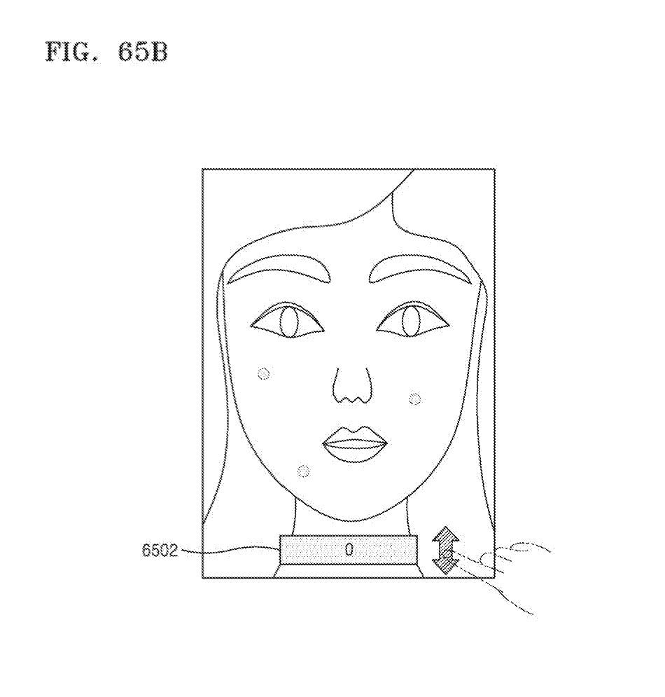

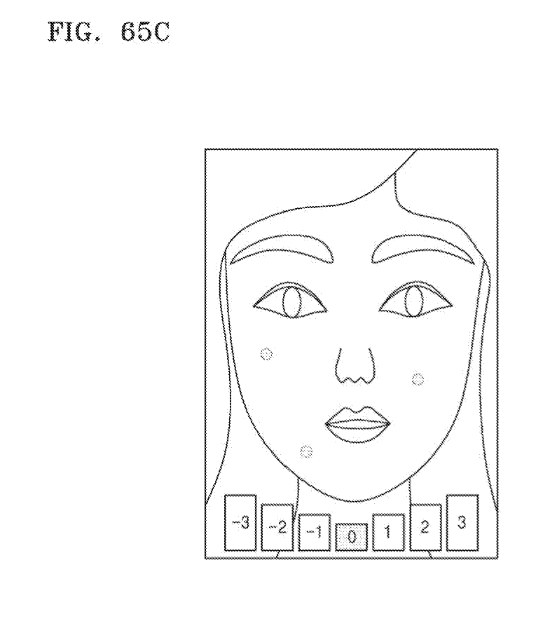

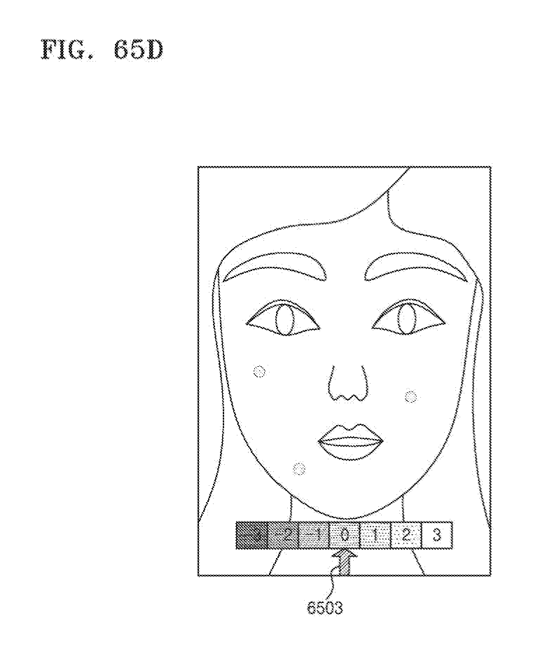

FIGS. 65A to 65D illustrate a device expressing a blemish detection level and/or a beauty face level according to various embodiments of the present disclosure.

Referring to FIG. 65A, the device 100 displays information about the blemish detection level and the beauty face level on an independent area. The device 100 displays, by using an arrow 6501, a level corresponding to a face image of a user which is displayed on the makeup mirror. When a user input for touching the arrow 6501 and moving the arrow 6501 in a left or right direction is received, the device 100 may change the set blemish detection level or beauty face level.

In the present disclosure, an operation of changing the set blemish detection level or beauty face level is not limited to the aforementioned user input. For example, the device 100 receives a touch-based user input with respect to the area where the information about the blemish detection level and the beauty face level is displayed, the device 100 may change the set blemish detection level or beauty face level. When the set blemish detection level or beauty face level is changed, the device 100 may change the face image of the user which is displayed on the makeup mirror.

Referring to FIG. 65B, the device 100 may display a blemish detection level or a beauty face level which is currently set based on a display window 6502. When a touch and drag user input in an upper or lower direction, based on the display window 6502, is received, the device 100 may change the blemish detection level or the beauty face level displayed on the display window 6502. When the blemish detection level or the beauty face level displayed on the display window 6502 is changed, the device 100 may change the face image of the user which is displayed on the makeup mirror.

Referring to FIG. 65C, the device 100 differently displays a display bar according to a blemish detection level or a beauty face level. The device 100 may differ in a color for a set blemish detection level or beauty face level and a color for a not-set blemish detection level or beauty face level. Referring to FIG. 65C, when the device 100 receives a touch-based user input with respect to an area where information about the blemish detection level and the beauty face level is displayed, the device 100 may change the set blemish detection level or beauty face level. When the set blemish detection level or beauty face level is changed, the device 100 may change the face image of the user which is displayed on a makeup mirror.

Referring to FIG. 65D, the device 100 displays a blemish detection level or a beauty face level, based on gradation colors. Referring to FIG. 65D, the device 100 provides darker colors with respect to the blemish detection level. Referring to FIG. 65D, the device 100 may display an arrow 6503 indicating a blemish detection level or a beauty face level which is currently set.

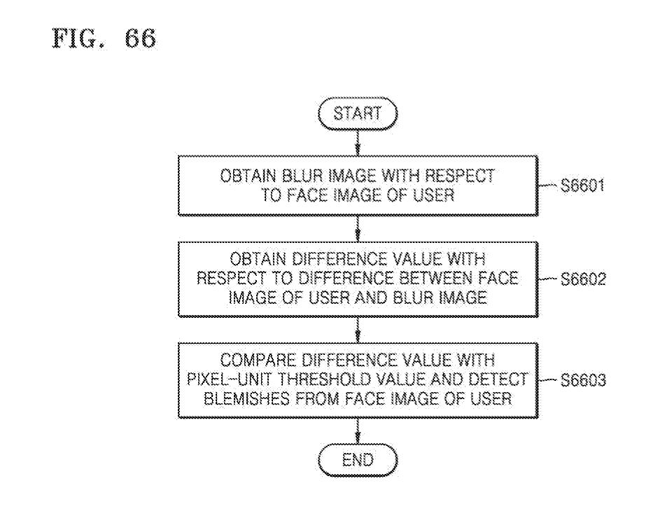

FIG. 66 is a flowchart of a method of detecting blemishes, the method being performed by a device according to various embodiments of the present disclosure.

Referring to FIG. 66, the operation flowchart shown in FIG. 66 may be included in the operation S6303 of FIG. 63. The method may be implemented by a computer program. For example, the method may be performed by using a makeup mirror application installed in the device 100. The computer program may operate in an OS installed in the device 100. The device 100 may write the computer program to a storage medium, and may use the computer program by reading the computer program from the storage medium.

In operation S6601, the device 100 obtains a blur image with respect to the face image of the user which is displayed in the operation 6301. The blur image indicates an image obtained by blurring a skin area of the face image of the user.

In operation S6602, the device 100 obtains a difference value with respect to a difference between the blur image and the face image of the user which is displayed in the operation 6301. The device 100 may obtain an absolute difference value with respect to the difference between the displayed face image of the user and the blur image.

In operation S6603, the device 100 compares the detected difference value with a threshold value and detects blemishes from the face image of the user. The threshold value may be determined according to the user input received in the operation S6302. For example, when the user input received in the operation S6302 indicates a blemish detection level of −3, the device 100 may determine, as the threshold value, pixel-unit colour information corresponding to the blemish detection level of −3. Accordingly, in operation S6603, the device 100 may detect, from the face image of the user, a pixel having a value equal to or greater than that of the pixel-unit colour information corresponding to the blemish detection level of −3,

In the aforementioned operation S6303, the device 100 may display the detected pixel as a blemish on the displayed face image of the user. Accordingly, the pixel detection may be referred to as blemish detection.

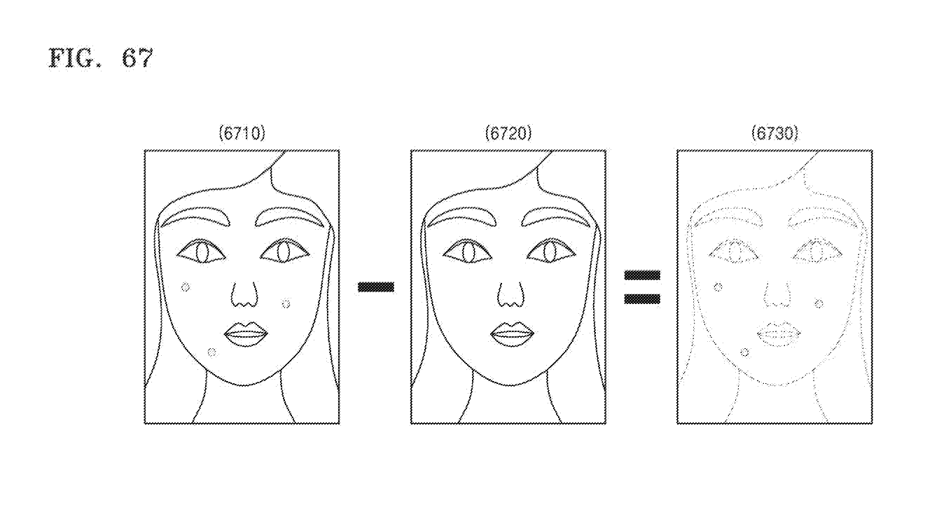

FIG. 67 illustrates a relation by which a device detects blemishes based on a difference between a face image of a user and a blur image according to various embodiments of the present disclosure,

Referring to FIG. 67, an image 6710 indicates the face image of the user which is displayed on the device 100 in the operation S6301. An image 6720 of FIG. 67 indicates the blur image that is obtained by the device 100 in the operation S6601. An image 6730 of FIG. 67 indicates the blemishes that are detected by the device 100 in the operation S6603. The device 100 may detect the blemishes shown in the image 6730 of FIG. 67 by detecting a difference between the face image (i.e., the image 6710 of FIG. 67) and the blur image (i.e., the image 6720 of FIG. 67).

In the aforementioned operation S6303, the device 100 may display the blemishes to be darker than a skin color of the face image of the user. The device 100 may differently display the blemishes according to a difference between the absolute difference value of the detected pixel and the threshold value. For example, in a case of a blemish where a difference between an absolute difference value of a detected pixel and the threshold value is large, the device 100 may emphasize (e.g., may make the blemish darker or highlighted) and may display the blemish.

In the aforementioned operation S6303, the device 100 may display the blemishes detected from the face image of the user, by using a different color according to a blemish detection level. For example, the device 100 may display a blemish detected from the face image of the user, by using a yellow color at the blemish detection level of −1, and may display the blemish detected from the face image of the user, by using an orange color at the blemish detection level of −2.

The embodiment of FIG. 67 may be modified such that a plurality of blur images are obtained, a difference value with respect to a difference between the plurality of obtained blur images is obtained, the obtained difference value is compared with the threshold value, and the blemishes are detected from the face image of the user,

The plurality of blur images may be equal to the plurality of blur images described with reference to FIG. 34. The plurality of blur images may indicate blur images in multiple steps. The multiple steps may correspond to blurring levels. For example, in a case where the multiple steps include a low step, a middle step, and a high step, the low step may correspond to a low blurring level, the middle step may correspond to a middle blurring level, and the high step may correspond to a high blurring

In addition, the device 100 may preset the threshold value, or as described with reference to FIG. 34, the device 100 may variably set the threshold value.

In addition, the device 100 may detect the blemishes from the face image of the user by using an image gradient value detecting algorithm. The device 100 may detect the blemishes from the face image of the user by using a skin analysis algorithm.

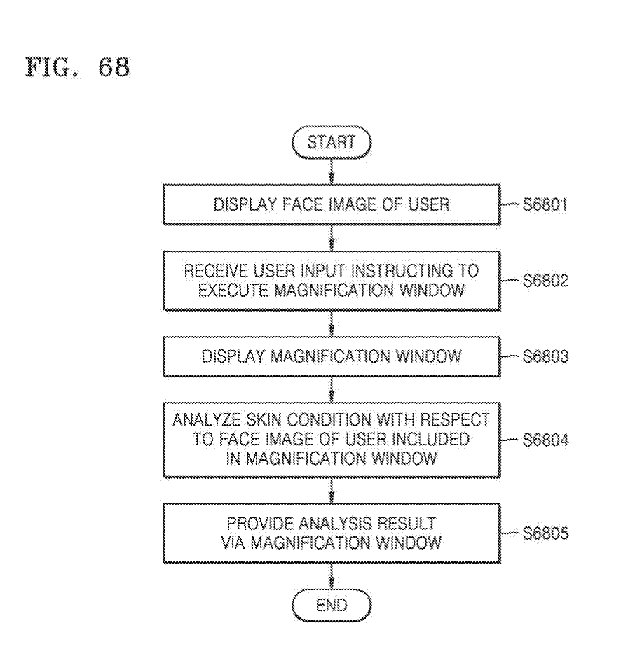

FIG. 68 is an operation flowchart of a device providing a skin analysis result with respect to an area of a face image of a user according to various embodiments of the present disclosure.

Referring to FIG. 68, the method may be implemented by a computer program. For example, the method may be performed by using a makeup mirror application installed in the device TOO. The computer program may operate in an OS installed in the device 100. The device 100 may write the computer program to a storage medium, and may use the computer program by reading the computer program from the storage medium.

In operation S6801, the device 100 displays the face image of the user. The device 100 may display the face image of the user which is obtained in real-time. According to a user input, the device 100 may display the face image of the user which is stored in the device 100. The device 100 may display the face image of the user which is received from an external device. The device 100 may display the face image of the user from which blemishes are removed.

In operation S6802, the device 100 receives a user input instructing to execute a magnification window. The user input instructing to execute the magnification window may correspond to a user input of a skin analysis request for the area of the face image of the user. Therefore, the magnification window may correspond to a skin analysis window.

The device 100 may receive, as the user input instructing to execute the magnification window, a long touch with respect to the area of the displayed face image of the user. The device 100 may receive, as the user input instructing to execute the magnification window, a user input instructing to select a magnification-window execution item included in a menu window.

When the user input instructing to execute the magnification window is received, in operation S6803, the device 100 displays the magnification window on the face image of the user. For example, when the user input instructing to execute the magnification window is the long touch, the device 100 may display the magnification window with respect to a point of the long touch. When the user input instructing to execute the magnification window is received based on the menu window, the device 100 may display the magnification window with respect to a position set as a default.

In operation S6803, the device 100 may enlarge a size of the displayed magnification window, may reduce the size of the displayed magnification window, or may move a display position of the displayed magnification window, according to a user input.

In operation S6804, the device 100 may analyze a skin condition with respect to the face image of the user included in the magnification window. The device 100 may determine a skin condition analysis-target area of the face image of the user which is included in the magnification window, based on a magnification ratio set in the magnification window. The magnification ratio may be preset in the device 100. The magnification ratio may be set by a user input or may vary.

As performed in the operation S4402, the device 100 may perform the skin item analysis technique on the determined area of the face image of the user. Here, the skin item may include a skin tone, acne, wrinkles, hyperpigmentation (or skin pigmentation), pores (or sizes of the pores), a skin type (e.g., a dry skin, a sensitive skin, an oily skin, and the like), and/or dead skin cells, but in the present disclosure, the skin item is not limited to the aforementioned descriptions.

Since the skin analysis is performed on the face image of the user, based on the magnification window and/or the magnification ratio set in the magnification window, the device 100 may decrease computation due to the skin analysis.

Since the device 100 analyzes the face image of the user and provides a result of the analysis while the device 100 magnifies, reduces, or moves the magnification window, the magnification window may correspond to a magnification UI.

When the face image of the user from which the blemishes are removed is displayed in the operation S6801, the device 100 may apply the magnification window to a face image of the user before the blemishes are removed therefrom, and may perform the skin analysis. The face image of the user before the blemishes are removed therefrom may be an image stored in the device 100.

In the operation S6804, the result of the skin analysis with respect to the face image of the user which is included in the magnification window may include a magnified skin condition image.

In operation S6805, the device 100 provides the analysis result via the magnification window. For example, the device 100 may display a magnified image (or a magnified skin condition image) on the magnification window. For example, when the magnification ratio is set as 3, the device 100 may display, on the magnification window, an image that is magnified about three times. For example, when the magnification ratio is set as 1, the device 100 may display, on the magnification window, a skin condition image whose size is equal to an actual size. The device 100 may provide the analysis result in a text form via the magnification window.

When the analysis result provided via the magnification window is in an image form, if a user input for requesting detailed information about the analysis result is received, the device 100 may provide a page for providing the detailed information. The page for providing the detailed information may be provided in the form of a pop-up. The page for providing the detailed information may be independent from a page where the face image of the user is displayed. The user input for requesting the detailed information may include a touch-based input via the magnification window. In the present disclosure, the user input for requesting the detailed information is not limited to the aforementioned descriptions.

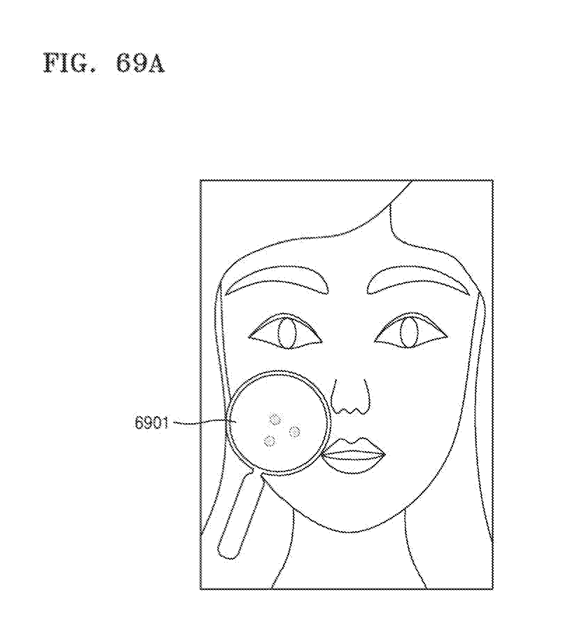

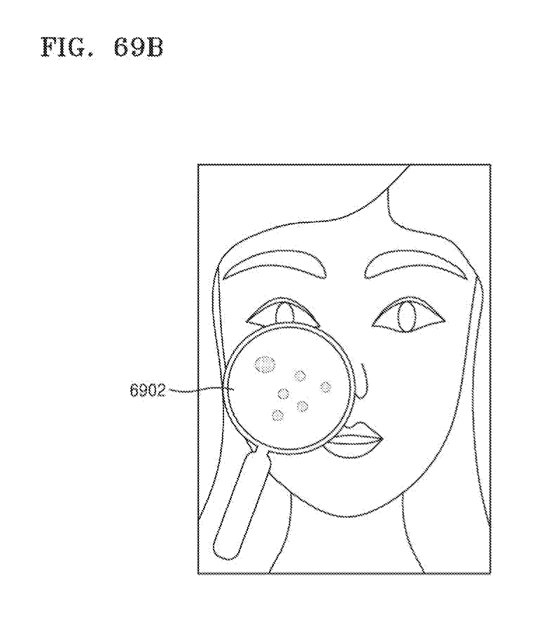

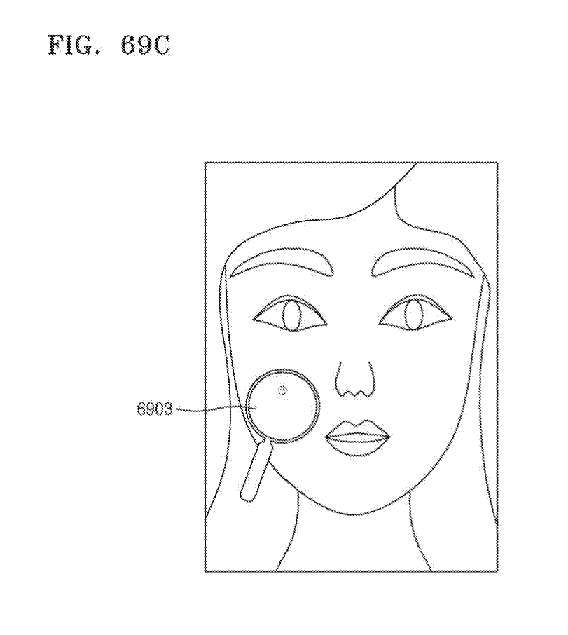

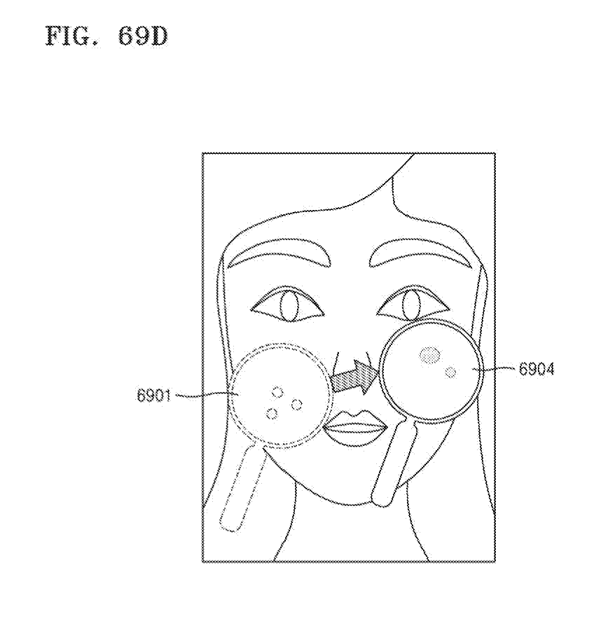

FIGS. 69A through 69D illustrate a makeup mirror of a device, which displays a magnification window according to various embodiments of the present disclosure.

Referring to FIG. 69A, the device 100 displays a magnification window 6901 on an area of a face image of a user. When a touch-based user input with respect to the area of the face image of the user is received, the device 100 may display the magnification window 6901 with respect to a position where the user input is received. The face image of the user may be a face image from which blemishes are removed as 6430 of FIG. 64. The face image of the user may be obtained in real-time.

When the device 100 provides a skin condition analysis result via the magnification window 6901, the device 100 may provide an image that is magnified to be at least three times the actual size as described in the operation S6805.

Referring to FIG. 6913, the device 100 may provide a magnification window 6902 magnified from a size of the magnification window 6901 shown in FIG. 69A. The device 100 may provide the magnification window 6902 whose size is magnified due to a pinch out gesture. The pinch out gesture is a gesture in which two fingers move in different directions while the two fingers touch a screen. However, a user input for magnifying the size of the magnification window 6901 is not limited to the pinch out gesture.

When the magnification window 6902 shown in FIG. 69B is provided, the device 100 may analyze a skin condition with respect to a larger area, compared to the magnification window 6901 shown in FIG. 69A.

When the magnification window 6902 shown in FIG. 69B is provided, the device 100 may provide a skin condition image that is further magnified than the magnification window 6901 shown in FIG. 69A. For example, when the device 100 provides a 1.5 times-magnified skin condition image on the magnification window 6901 shown in FIG. 69A, the device 100 may provide a two times-magnified skin condition image on the magnification window 6902 shown in FIG. 69B.

Referring to FIG. 69C, the device 100 may provide a magnification window 6903 obtained by reducing a size of the magnification window 6901 shown in FIG. 69A. The device 100 may provide the magnification window 6903 obtained by reducing the size of the magnification window 6901 due to a pinch in gesture with respect to the magnification window 6901. The pinch in gesture is a gesture in which two fingers move in different directions while the two fingers touch the screen. However, a user input for reducing the size of the magnification window 6901 is not limited to the pinch in gesture.

When the magnification window 6903 shown in FIG. 69C is provided, the device 100 may analyze a skin condition of an area smaller than the magnification window 6901 shown in FIG. 69A.

When the magnification window 6903 shown in FIG. 69C is provided, the device 100 may provide a skin condition image that is further reduced than the magnification window 6901 shown in FIG. 69A. For example, when the device 100 provides the 1.5 times-magnified skin condition image on the magnification window 6901 shown in FIG. 69A, the device 100 may provide a not-magnified skin condition image on the magnification window 6903 shown in FIG. 69C.

Referring to FIG. 69D, the device 100 may provide a magnification window 6904 obtained by moving a display position of the magnification window 6901 shown in FIG. 69A to another position. The device 100 may provide the magnification window 6904 moved to the other position due to a touch and drag input to the magnification window 6901. A user input for moving the display position of the magnification window 6901 to the other position is not limited to the touch and drag input.

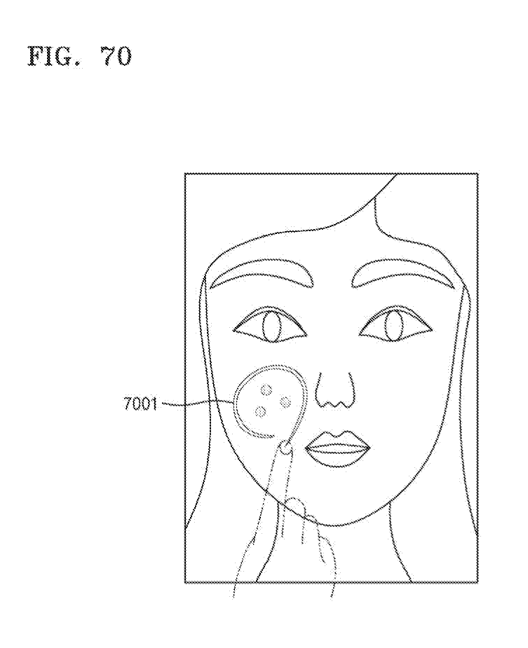

FIG. 70 illustrates a makeup mirror of a device, which displays a skin analysis target area according to various embodiments of the present disclosure.

Referring to FIG. 70, the device 100 may set a skin analysis window (a skin analysis target area) 7001 according to a figure formed based on a touch-based user input. In the example of FIG. 70, the device 100 forms a circle based on the touch-based user input. In the present disclosure, a figure that may be formed based on the touch-based user input is not limited to the circle. For example, the figure that may be formed based on the touch-based user input may be set one of various shapes including a block, a triangle, a heart, a undefined shape, and the like.

Based on the figure formed based on the touch-based user input, the device 100 may analyze a skin of an area of a face image of a user and may provide a result of the analysis via a skin analysis window 7001. The device 100 may provide the result of the analysis via a window or a page different from the skin analysis window 7001.

According to a user input, the device 100 may magnify the skin analysis window 7001 shown in FIG. 70, may reduce the skin analysis window 7001, or may move a display position of the skin analysis window 7001, as in the magnification window 6901.

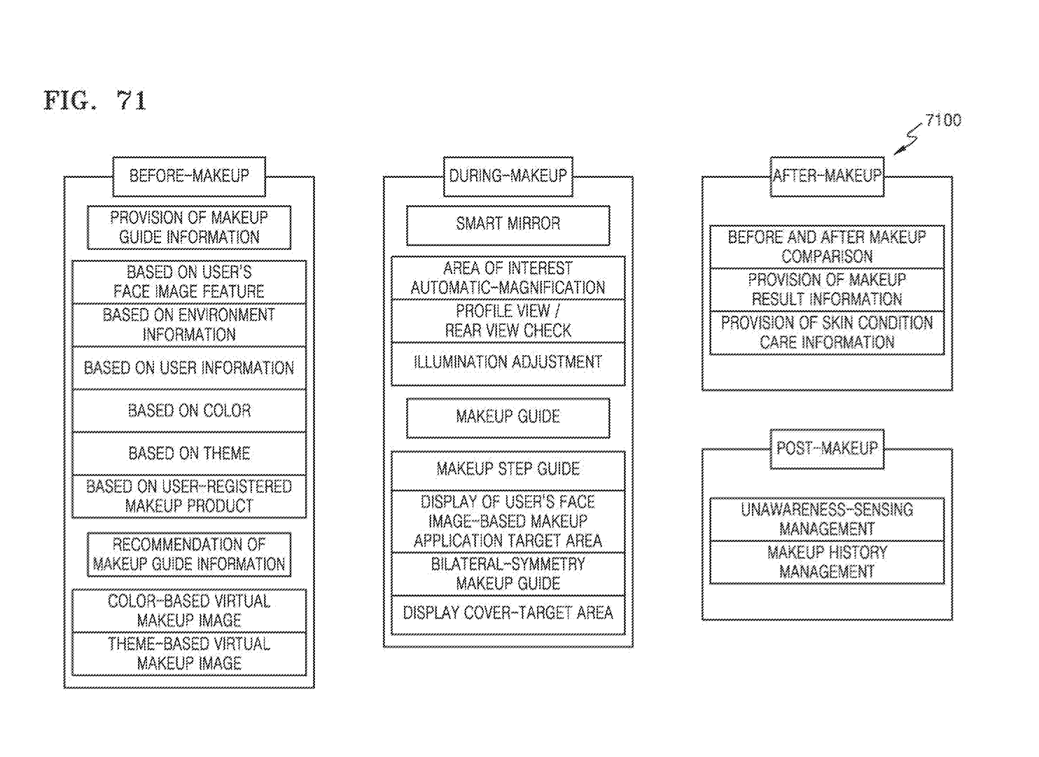

FIG. 71 illustrates software configuration of a makeup mirror application according to various embodiments of the present disclosure.

Referring to FIG. 71, a makeup mirror application 7100 may include, at the top of the makeup mirror application 7100, a before-makeup item, a during-makeup item, an after-makeup item, and/or a post-makeup item.

The before-makeup item may include a makeup guide information providing item, and/or a makeup guide information recommending item.

The makeup guide information providing item may include a user's face image feature-based item, an environment information-based item, a user information-based item, a color-based item, a theme-based item, and/or a user-registered makeup product-based item.

The makeup guide information recommending item may include a color-based virtual makeup image item, and/or a theme-based virtual makeup image item.

The during-makeup item may include a smart mirror item, and/or a makeup guide item.

The smart mirror item may include an area of interest automatic-magnification item, a profile view/rear view check item, and an illumination adjustment item.

The makeup guide item may include a makeup step guide item, a user's face image-based makeup application target area display item, a bilateral-symmetry makeup guide item, and/or a cover-target area display item.

The after-makeup item may include a before and after makeup comparison item, a makeup result information providing item, and/or a skin condition care information providing item. The skin condition care information providing item may be included in the before-makeup item.

The post-makeup item may include an unawareness-detection management item, and/or a makeup history management item.

The items described with reference to FIG. 71 may correspond to functions. The items of FIG. 71 may be used as a providable menu in environment settings of the makeup mirror application 7100. When the menu provided in the environment settings of the makeup mirror application 7100 is based on the configuration shown in FIG. 71, the device 100 may use the items shown in FIG. 71 so as to set particular conditions (e.g., to turn on or off a function, to set the number of pieces of provided information, and the like) for each function.

In the present disclosure, the software configuration of the makeup mirror application 7100 is not limited to that shown in FIG. 71. For example, in the present disclosure, the makeup minor application 7100 may include a blemish detection item based on the blemish detection level and/or the beauty face level described with reference to FIG. 64. The blemish detection item may be performed regardless of the before-makeup item, the during-makeup item, the after-makeup item, or the post-makeup item.

In addition, in the present disclosure, the makeup mirror application 7100 may include an item for analyzing a skin of an area of a face image of a user, based on the magnification window described with reference to FIG. 68. The item for analyzing the skin based on the magnification window may be performed regardless of the before-makeup item, the during-makeup item, the immediately after-makeup item, or the post-makeup item.

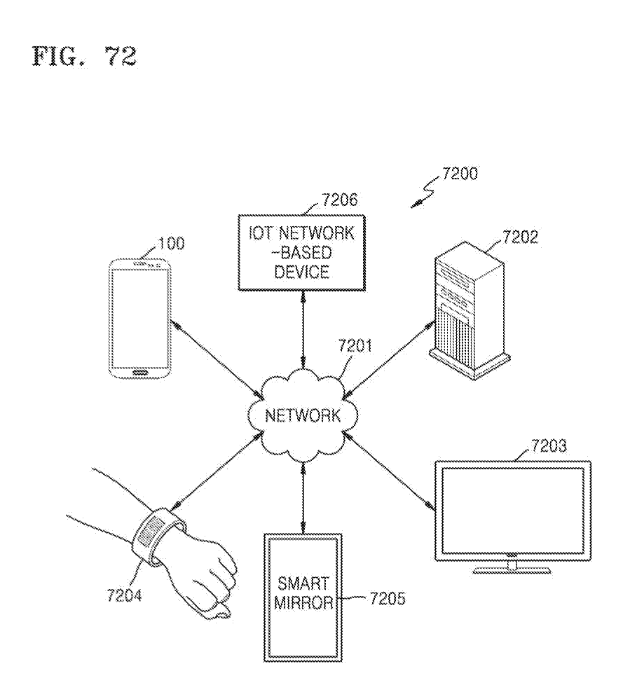

FIG. 72 illustrates a configuration of a system including a device according to various embodiments of the present disclosure.

Referring to FIG. 72, a system 7200 may include the device 100, a network 7201, a server 7202, a smart TV 7203, a smart watch 7204, a smart mirror 7205, and an IoT network-based device 7206. In the present disclosure, the system 7200 is not limited to those shown in FIG. 72. For example, the system 7200 may be embodied with more or less elements than the elements shown in FIG. 72,

When the device 100 is a portable device, the device 100 may include at least one of devices, such as a smart phone, a notebook, a smart board, a tablet personal computer (tablet PC), a handheld device, a handheld computer, a media player, an electronic device, a personal digital assistant (PDA), and the like, but in the present disclosure, the device 100 is not limited to the aforementioned descriptions.

When the device 100 is a wearable device, the device 100 may include at least one of devices, such as smart glasses, a smart watch, a smart band (e.g., a smart waistband, a smart hairband, and the like), various types of smart accessories a smart ring, a smart bracelet, a smart anklet, a smart hair pin, a smart clip, a smart necklace, and the like), various types of smart body pads (e.g., a smart knee pads, and smart elbow pad), smart shoes, smart gloves, smart clothes, a smart hat, smart devices that are usable as an artificial leg for a disabled person, an artificial hand for a disabled person, and the like, but in the present disclosure, the device 100 is not limited to the aforementioned descriptions.

The device 100 may include devices, such as a mirror display, a vehicle, a vehicle navigation device, and the like, which are based on a machine to machine (M2M) or IoT network, but in the present disclosure, the device 100 is not limited to the aforementioned descriptions.

The network 7201 may include a wired network and/or a wireless network. The network 7201 may include a short-range communication network and/or a remote-distance communication network.

The server 7202 may include a server that provides a makeup mirror service (e.g., management of a user's makeup history, a skin condition care for a user, a recent makeup trend, and the like). The server 7202 (e.g., a private cloud server) may include a server that manages user information. The server 7202 may include a social network service (SNS) server. The server 7202 may include a medical institute server capable of managing dermatological information of the user. However, in the present disclosure, the server 7202 is not limited to the aforementioned descriptions.

The server 7202 may provide makeup guide information to the device 100.

The smart TV 7203 may include a smart mirror or a mirror display function which is described in the embodiments of the present disclosure. Accordingly, the smart TV 7203 may include a camera function.

The smart TV 7203 may display a screen where a before-makeup face image of the user is compared with a during-makeup face image of the user, according to a request from the device 100. The smart TV 7203 may display an image for comparing the before-makeup face image of the user with an after-makeup face image of the user, according to a request from the device 100.

The smart TV 7203 may display an image for recommending a plurality of virtual makeup images. The smart TV 7203 may display an image for comparing a user-selected virtual makeup image with the before-makeup face image of the user. The smart TV 7203 may display an image for comparing the user-selected virtual makeup image with the after-makeup face image of the user. Both the smart TV 7203 and the device 100 may display in real-time a makeup process image of the user.

As shown in FIGS. 65A to 65D, when the device 100 is enabled to set the blemish detection level or the beauty face level, the device 100 may display information about the blemish detection level and/or the beauty face level, and the smart TV 7203 may display a face image of the user according to the blemish detection level or the beauty face level which is set by the device 100. In this case, the device 100 may transmit information about the set blemish detection level or information about the set beauty face level to the smart TV 7203.

The smart TV 7203 may display the information about the blemish detection level and the beauty face level as shown in FIGS. 65A to 65D, based on the information received from the device 100. Here, the smart TV 7203 may display the blemish detection level and the beauty face level along with the face image of the user or may not display the face image of the user.

When the smart TV 7203 displays the face image of the user, the smart TV 7203 may display a face image of the user which is received from the device 100 but the present disclosure is not limited thereto. For example, the smart TV 7203 may display a face image of the user which is captured by using a camera included in the smart TV 7203.

When the information about the blemish detection level and the information about the beauty face level are displayed, the smart TV 7203 may set the blemish detection level or the beauty face level according to a user input received via a remote controller for controlling an operation of the smart TV 7203. The smart TV 7203 may transmit information about a set blemish detection level or information about a set beauty face level to the device 100.

As illustrated in FIG. 68, when the skin of the area of the face image of the user is analyzed by using a magnification window, the device 100 may display the magnification window on the face image of the user so as to analyze the skin, and the smart TV 7203 may display a detailed analysis result. In this case, the device 100 may transmit information about the detailed analysis result to the smart TV 7203.

The smart watch 7204 may receive various user inputs for making makeup guide information provided by the device 100, and may transmit the various user inputs to the device 100. A user input receivable by the smart watch 7204 may be similar to a user input receivable by a user input unit included in the device 100.

The smart watch 7204 may receive a user input for setting the blemish detection level and the beauty face level displayed on the device 100, and may transmit the received user input to the device 100. The user input received via the smart watch 7204 may be in the form of identification information (e.g., −1, +1) about a setting-target blemish detection level or a setting-target beauty face level, but in the present disclosure, the user input received via the smart watch 7204 is not limited to the aforementioned descriptions.

The smart watch 7204 may transmit, to the device 100 and the smart TV 7203, a user input for controlling communication between the device 100 and the smart TV 7203, communication between the device 100 and the server 7202, or communication between the server 7202 and the smart TV 7203.

The smart watch 7204 may transmit a control signal based on a user input for controlling an operation of the device 100 or the smart TV 7203 to the device 100 or the smart TV 7203.

For example, the smart watch 7204 may transmit, to the device 100, a signal for requesting execution of a makeup mirror application. Accordingly, the device 100 may execute the makeup mirror application. The smart watch 7204 may transmit, to the smart TV 7203, a signal for requesting synchronization with the device 100. Accordingly, the smart TV 7203 may set a communication channel with the device 100, and may receive, from the device 100, and may display information, such as the face image of the user, makeup guide information, and/or a skin analysis result which is displayed on the device 100, wherein the information occurs according to the execution of the makeup mirror application.

As the other device 1000 shown in FIG. 10C, the smart mirror 7205 may set a communication channel with the device 100 and may display information according to the execution of the makeup mirror application. The smart mirror 7205 may obtain in real-time a face image of the user by using a camera.

When the device 100 is the mirror display as described above, the smart mirror 7205 may display a face image of the user which is obtained at an angle different from an angle of the face image of the user which is displayed on the device 100. For example, when the device 100 displays a front view of the face image of the user, the smart mirror 7205 may display a profile image of the user at 45 degrees.

The IoT network-based device 7206 may include an IoT network-based sensor. The IoT network-based device 7206 may be arranged at a position near the smart mirror 7205 and may detect whether the user approaches the smart mirror 7205. When the IoT network-based device 7206 determines that the user approaches the smart mirror 7205, the IoT network-based device 7206 may transmit a signal for requesting execution of the makeup mirror application to the smart mirror 7205. Accordingly, the smart mirror 7205 may execute the makeup mirror application and may execute at least one of the embodiments described in the present disclosure.

The smart mirror 7205 may detect whether the user approaches, by using a sensor included in the smart mirror 7205, and may execute the makeup mirror application.

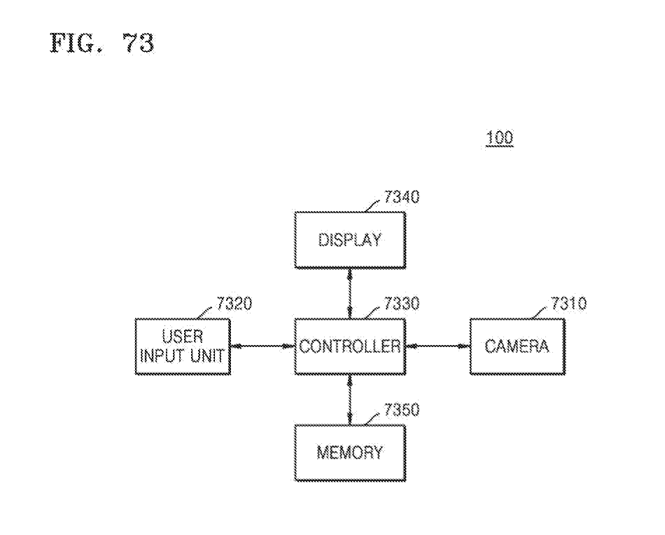

FIG. 73 illustrates a block diagram of a device according to an embodiment of the present disclosure.

Referring to FIG. 73, the device 100 includes a camera 7310, a user input unit 7320, a controller 7330, a display 7340, and a memory 7350.

The camera 7310 may obtain a face image of a user in real-time. Therefore, the camera 7310 may correspond to an image sensor or an image obtainer. The camera 7310 may be embedded at a front surface of the device 100. The camera 7310 includes a lens and optical devices for capturing an image or a moving picture.

The user input unit 7320 may receive a user input with respect to the device 100. The user input unit 7320 may receive a user input of a makeup guide request. The user input unit 7320 may receive a user input for selecting one of a plurality of virtual makeup images.

The user input unit 7320 may receive a user input for selecting one of a plurality of pieces of theme information. The user input unit 7320 may receive a user input for selecting makeup guide information. The user input unit 7320 may receive a user input of a comparison image request for comparison between a before-makeup face image of the user and a current face image of the user. The user input unit 7320 may receive a user input of a comparison image request for comparison between the current face image of the user and a virtual makeup image. The user input unit 7320 may receive a user input of a request for user skin condition care information.

The user input unit 7320 may receive a user input of a skin analysis request. The user input unit 7320 may receive a user input of a makeup history information request with respect to the user. The user input unit 7320 may receive a user input for registering a makeup product of the user.

The user input unit 7320 may receive a user input indicating a blemish detection level or a beauty face level. The user input unit 7320 may receive a user input of a skin analysis request for an area of the face image of the user. The user input unit 7320 may receive a user input for requesting to magnify a size of a magnification window, to reduce the size of the magnification window, or to move a display position of the magnification window to another position. The user input unit 7320 may receive a touch-based input for specifying the area based on the face image of the user. For example, the user input unit 7320 may include a touch screen, but in the present disclosure, the user input unit 7320 is not limited to the aforementioned descriptions.

The display 7340 may display the face image of the user in real-time. The display 7340 may display makeup guide information on the face image of the user. Therefore, the display 7340 may correspond to a makeup mirror display.

The display 7340 may display the plurality of virtual makeup images. The display 7340 may display a color-based virtual makeup image and/or a theme-based virtual makeup image. The display 7340 may display the plurality of virtual makeup images on one page or on a plurality of pages.

The display 7340 may display a plurality of pieces of theme information. The display 7340 may display bilateral-symmetry makeup guide information on the face image of the user.

The display 7340 may be controlled by the controller 7330 so as to display the face image of the user in real-time. The display 7340 may be controlled by the controller 7330 so as to display the makeup guide information on the face image of the user. The display 7340 may be controlled by the controller 7330 so as to display the plurality of virtual makeup images, a plurality of pieces of theme-information, or the bilateral-symmetry makeup guide information.

The display 7340 may be controlled by the controller 7330 so as to display the magnification window on an area of the face image of the user. The display 7340 may be controlled by the controller 7330 so as to display blemishes according to various forms or various levels (or various hierarchies), wherein the blemishes are detected from the face image of the user. The various forms or the various levels may differ according to a difference between color information of the blemishes and skin color information of the face image of the user. In the present disclosure, the various forms or the various levels are not limited to the difference between the two pieces of color information. For example, the various forms or the various levels may differ according to thicknesses of wrinkles. The various forms or the various levels may be expressed by using different colours.

The display 7340 may be controlled by the controller 7330 so as to provide a beauty face image from which the blemishes detected from the face image of the user are removed a plurality of times. The beauty face image indicates an image based on the beauty face level described with reference to FIG. 63.

The display 7340 may include a touch screen but in the present disclosure, configuration of the display 7340 is not limited to the aforementioned descriptions.

The display 7340 may include a liquid crystal display (LCD), a thin film transistor-LCD (TFT-LCD), an organic light-emitting diode (OLED) display, a flexible display, a three-dimensional (3D) display, or an electrophoretic display (EPD).

The memory 7350 may store information (e.g., color-based virtual makeup image information, theme-based virtual makeup image information, Table shown in FIG. 2, and the like) used by the device 100 to provide a makeup mirror including makeup guide information. In addition, the memory 7350 may store makeup history information of the user.

The memory 7350 may store programs for processing and controls by the controller 7330. The programs stored in the memory 7350 may include an OS program and various application programs. The various application programs may include the makeup mirror application according to the embodiments of the present disclosure, a camera application, and the like.

The memory 7350 may store information (e.g., the makeup history information of the user) that is managed by an application program.

The memory 7350 may store the face image of the user. The memory 7350 may store pixel-unit threshold values corresponding to the blemish detection level and/or the beauty face level. The memory 7350 may store information about at least one reference value for grouping the blemishes detected from the face image of the user.

The programs stored in the memory 7350 may be classified into a plurality of modules, according to their functions. For example, the plurality of modules may include a mobile communication module, a Wi-Fi module, a Bluetooth module, a digital multimedia broadcasting (DMB) module, a camera module, a sensor module, a global positioning system (UPS) module, a video reproducing module, an audio reproducing module, a power module, a touch screen module, a UI module, and/or an application module.

The memory 7350 may include a storage medium of at least one type selected from a flash memory, a hard disk, a multimedia card type memory, a card type memory, such as a secure digital (SD) or extreme digital (XD) card memory, random access memory (RAM), static RAM (SRAM), read-only memory (ROM), electrically erasable programmable ROM (EEPROM), PROM, a magnetic memory, a magnetic disc, and an optical disc.

The controller 7330 may correspond to a processor configured to control operations of the device 100. The controller 7330 may control the camera 7310, the user input unit 7320, the display 7340, and the memory 7350 so that the device 100 may display the face image of the user in real-time and may display the makeup guide information on the displayed face image of the user.

In more detail, the controller 7330 may obtain the face image of the user in real-time by controlling the camera 7310. The controller 7330 may display the face image of the user obtained in real-time by controlling the camera 7310 and the display 7340.

When the controller 7330 receives a user input of a makeup guide request via the user input unit 7320, the controller 7330 may display the makeup guide information on the displayed face image of the user. Accordingly, before a makeup or during the makeup, the user may view the makeup guide information while the user views the face image of the user to which a makeup is being applied, and may check completion of the makeup.

When the controller 7330 receives the user input of the makeup guide request via the user input unit 7320, the controller 7330 may display makeup guide information including makeup step information on the face image of the user which is displayed on the display 7340. Accordingly, the user may wear the makeup, based on the makeup step information.

When the controller 7330 receives a user input for selecting one of the plurality of virtual makeup images via the user input unit 7320, the controller 7330 may display makeup guide information based on the selected virtual makeup image on the face image of the user which is displayed on the display 7340.

When the controller 7330 receives a user input for selecting one of the plurality of pieces of theme information via the user input unit 7320, the controller 7330 may display makeup guide information based on the selected theme information on the face image of the user which is displayed on the display 7340.

After the bilateral-symmetry makeup guide information is displayed on the face image of the user which is displayed on the display 7340, the controller 7330 may determine whether a makeup process for one side of a face of the user is started, based on a face image of the user which is obtained in real-time by using the camera 7310.

When the controller 7330 determines that the makeup for one side of the face of the user is started, the controller 7330 may delete makeup guide information displayed on the other side of the face image of the user.

Based on a face image of the user which is obtained in real-time by using the camera 7310, the controller 7330 may determine whether the makeup for one side of the face of the user is ended.

When the controller 7330 determines that the makeup for one side of the face of the user is ended, the controller 7330 may detect a makeup result with respect to one side of the face of the user, based on a face image of the user which is obtained by using the camera 7310.

The controller 7330 may display makeup guide information based on the makeup result with respect to one side of the face of the user, on another side of the face image of the user which is displayed on the display 7340.

When the controller 7330 receives a user input for selecting one of a plurality of pieces of makeup guide information displayed on the display 7340 via the user input unit 7320, the controller 7330 may read detailed makeup guide information about the selected makeup guide information from the memory 7350 and may provide the detailed makeup guide information to the display 7340.

The controller 7330 may detect an area of interest from a face image of the user, based on the face image of the user which is obtained in real-time by using the camera 7310. When the area of interest is detected, the controller 7330 may automatically magnify the detected area of interest and may display the detected area of interest on the display 7340.

The controller 7330 may detect a cover-target area from a face image of the user, based on the face image of the user which is obtained in real-time by using the camera 7310. When the cover-target area is detected, the controller 7330 may display makeup guide information for the cover-target area on the face image of the user which is displayed on the display 7340.

The controller 7330 may detect an illuminance value, based on a face image of the user which is obtained by using the camera 7310 or based on an amount of light which is detected when the face image of the user is obtained. The controller 7330 may compare the detected illuminance value with a prestored reference illuminance value and may determine whether the detected illuminance value indicates a low illuminance. When the controller 7330 determines that the detected illuminance value indicates the low illuminance, the controller 7330 may display, as a white level, edge areas of the display 7340.

When the controller 7330 receives a user input of a comparison image request via the user input unit 7320, the controller 7330 may display a before-makeup face image of the user and a current face image of the user in the form of a comparison on the display 7340. The before-makeup face image of the user may be read from the memory 7350 but the present disclosure is not limited thereto.

When the controller 7330 receives a user input of a comparison image request via the user input unit 7320, the controller 7330 may display the current face image of the user and a virtual makeup image in the form of a comparison on the display 7340. The virtual makeup image may be read from the memory 7350 but the present disclosure is not limited thereto.

When the controller 7330 receives a user input of a skin analysis request via the user input unit 7320, the controller 7330 may analyze a skin based on the current face image of the user, may compare a skin analysis result based on the before-makeup face image of the user with a skin analysis result based on the current face image of the user, and may provide a comparison result via the display 7340.

The controller 7330 may periodically obtain a face image of the user by using the camera 7310 while the user of the device 100 is unaware of it. The controller 7330 may check a makeup state with respect to the obtained face image of the user, and may determine whether notification is required, according to a result of the check. When it is determined that the notification is required, the controller 7330 may provide the notification to the user via the display 7340. In the present disclosure, a method of providing the notification is not limited to the use of the display 7340.

When the controller 7330 receives a user input of a makeup history information request via the user input unit 7320, the controller 7330 may read makeup history information of the user stored in the memory 7350 and may provide the makeup history information via the display 7340. The controller 7330 may process the makeup history information of the user, which is read from the memory 7350, according to an information format (e.g., period-unit history information, a user's preference, and the like) to be provided to the user. Information about the information format to be provided to the user may be received via the user input unit 7320.

The controller 7330 may detect a makeup area from the face image of the user which is displayed on the display 7340, based on a user input received via the user input unit 7320 or the face image of the user which is obtained in real-time by using the camera 7310. When the makeup area is detected, the controller 7330 may display makeup guide information about the detected makeup area and makeup product information on the face image of the user which is displayed on the display 7340. The makeup product information may be read from the memory 7350, but in the present disclosure, the makeup product information may be received from at least one of external devices (e.g., the server 7202, the smart TV 7203, the smart watch 7204, and the like).

The controller 7330 may determine a makeup tool according to a user input received via the user input unit 7320. When the makeup tool is determined, the controller 7330 may display makeup guide information according to the determined makeup tool on the face image of the user which is displayed on the display 7340.

The controller 7330 may detect movement of a face of the user in a left direction or a right direction by using the face image of the user which is obtained in real-time by using the camera 7310 and preset angle information (the angle information described with reference to FIG. 53). When the movement of the face of the user in the left direction or the right direction is detected, the controller 7330 may display, on the display 7340, a profile face image of the user which is obtained by using the camera 7310. In this regard, the controller 7330 may store the obtained profile face image of the user in the memory 7350.

The controller 7330 may register a makeup product of the user, based on a user input received via the user input unit 7320. The registered makeup product of the user may be stored in the memory 7350. The controller 7330 may display makeup guide information based on the registered makeup product of the user on the face image of the user which is displayed on the display 7340.

The controller 7330 may provide an after-makeup face image of the user for a period, based on a user input received via the user input unit 7320. Information about the period may be received via the user input unit 7320, hut in the present disclosure, an input of the information about the period is not limited to the aforementioned descriptions. For example, the information about the period may be received from an external device.

According to a request for user skin condition care information which is received via the user input unit 7320, the controller 7330 may read user skin condition analysis information from the memory 7350 or an external device. When the user skin condition analysis information is read, the controller 7330 may display the read user skin condition analysis information on the display 7340.

When a user input indicating a blemish detection level is received via the user input unit 7320, the controller 7330 may control the display 7340 to emphasize and display blemishes detected from the face image of the user which is displayed on the display 7340, according to the received blemish detection level.

According to the blemish detection level set by the user, the device 100 may display blemishes having a small color difference with respect to a skin color of the user and other blemishes having a large color difference with respect to the skin color, based on the face image of the user which is provided via the display 7340. The device 100 may differently display the blemishes having the small color difference with respect to the skin color on the face image of the user from other blemishes having the large color difference. Therefore, the user may easily recognize the blemishes having the small color difference with respect to the skin color on the face image of the user, and other blemishes having the large color difference.

According to the blemish detection level set by the user, the device 100 may display thin wrinkles through thick wrinkles, based on the face image of the user which is provided via the display 7340. The device 100 may differently display the thin wrinkles from the thick wrinkles. For example, the device 100 may display the thin wrinkles by using a bright color, and may display the thick wrinkles by using a dark color. Accordingly, the user may easily recognize the thin wrinkles and the thick wrinkles.

When a user input indicating a beauty face level is received via the user input unit 7320, the controller 7330 may control the display 7340 to blur and display the blemishes detected from the face image of the user which is displayed on the display 7340, according to the received beauty face level.

According to the beauty face level set by the user, the device 100 may sequentially remove the blemishes having the small color difference with respect to the skin color of the user and other blemishes having the large color difference with respect to the skin color, based on the face image of the user which is provided via the display 7340. Accordingly, the user may check a procedure in which the blemishes are removed from the face image of the user, according to the beauty face level.

The controller 7330 may obtain at least one blur image with respect to the face image of the user so as to detect the blemishes from the face image of the user. The controller 7330 may obtain a difference value (or an absolute difference value) with respect to a difference between the face image of the user and the blur image. The controller 7330 may compare the difference value with a pixel-unit threshold value corresponding to the blemish detection level or the beauty face level and thus may detect the blemishes from the face image of the user.

When a plurality of blur images are obtained with respect to the face image of the user, the controller 7330 may detect a difference value with respect to a difference between the plurality of blur images. The controller 7330 may compare a threshold value with the difference value between the plurality of blur images and thus may detect the blemishes from the face image of the user. The threshold value may be preset. The threshold value may vary as described with reference to FIG. 34.

The controller 7330 may detect a pixel-unit image gradient value from the face image of the user by using an image gradient value detecting algorithm. The controller 7330 may detect an area where the image gradient value is large, as an area having the blemishes in the face image of the user. The controller 7330 may detect the area with the large image gradient value by using a preset reference value. The preset reference value may be changed by the user.

When a user input of a skin analysis request for an area of the face image of the user is received via the user input unit 7320, the controller 7330 may display the magnification window 6901 on the area via the display 7340. The controller 7330 may analyze a skin of the face image of the user which is included in the magnification window 6901. The controller 7330 may provide a result of the analysis via the magnification window 6901.

When a user input for requesting to magnify a size of the magnification window 6901, to reduce the size of the magnification window 6901, or to move a display position of the magnification window 6901 to another position is received, the controller 7330 may control the display 7340 to magnify the size of the magnification window 6901 displayed on the display 7340, to reduce the size of the magnification window 6901, or to move the display position of the magnification window 6901 to the other position.

As illustrated in FIG. 70, the controller 7330 may receive a touch-based input for specifying the area (or a skin analysis window) based on the face image of the user, via the user input unit 7320.

The controller 7330 may analyze a skin of an area included in the skin analysis window 7001 that is set according to the touch-based input. The controller 7330 may provide a result of the analysis via the skin analysis window 7001. The controller 7330 may provide the result of the analysis via a window or a page different from the skin analysis window 7001.

The controller 7330 may provide the result in an image or text form via the skin analysis window 7001 set according to the touch-based input.

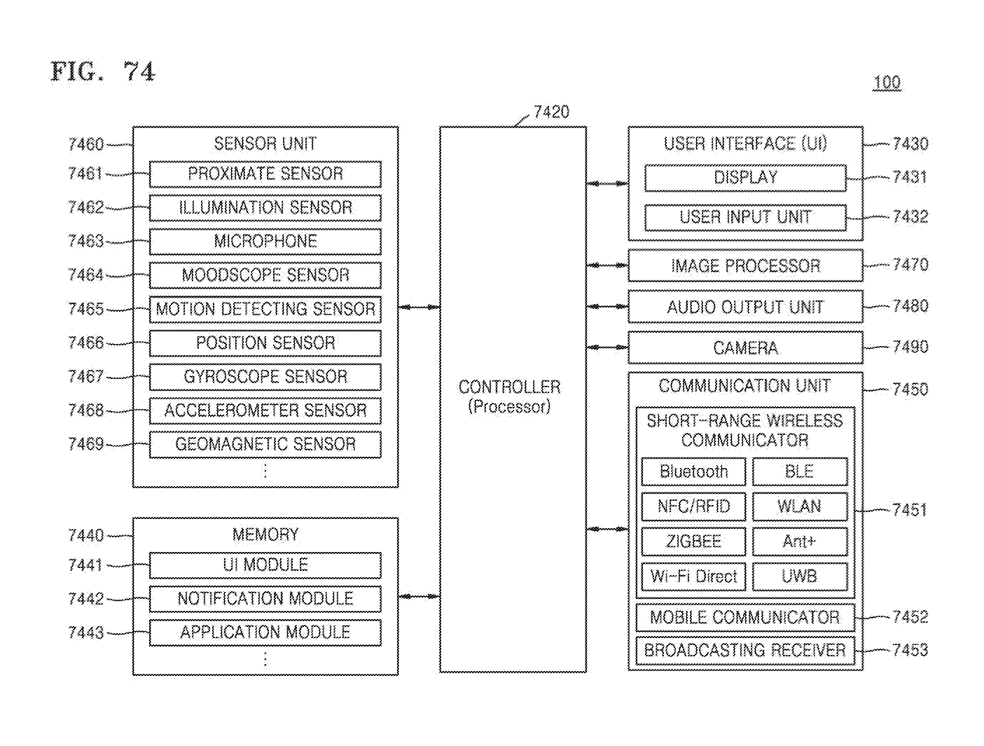

FIG. 74 illustrates a block diagram of a device according to an embodiment of the present disclosure. The device 100 of FIG. 74 may be the same (e.g., a portable device as that of FIG. 73.

Referring to FIG. 74, the device 100 includes a controller 7420, a UI 7430, a memory 7440, a communication unit 7450, a sensor unit 7460, an image processor 7470, an audio output unit 7480, and a camera 7490.

The device 100 may include a battery. The battery may be embedded in the device 100 or may be detachably included in the device 100. The battery may supply power to all elements included in the device 100. The device 100 may receive power from an external power supplier (not shown) via the communication unit 7450. The device 100 ma further include a connector that is connectable to the external power supplier.

The controller 7420, a display 7431 and a user input unit 7432 which are included in the UI 7430, the memory 7440, and the camera 7490 may be elements that are similar or equal to the camera 7310, the user input unit 7320, the controller 7330, the display 7340, and the memory 7350 which are shown in FIG. 73.

Programs stored in the memory 7440 may be classified into a plurality of modules, according to their functions. For example, the programs stored in the memory 7440 may be classified into a UT module 7441, a notification module 7442, and an application module 7443, but the present disclosure is not limited thereto. For example, the programs stored in the memory 7440 may be classified into a plurality of modules as described with reference to the memory 7350 of FIG. 73.

The UI module 7441 may provide the controller 7420 with graphical UI (GUI) information for displaying, on a face image of a user, makeup guide information described in various embodiments of the present disclosure, GUI information for displaying makeup guide information based on a virtual makeup image on the face image of the user, GUI information for providing various types of notification information, GUI information for providing the magnification window 6901. GUI information for providing the skin analysis window 7001, or GUI information for providing a blemish detection level or a beauty face level. The module 7441 may provide the controller 7420 with a UI and/or a GUI which is specialized each of zed for each of applications installed in the device 100.

The notification module 7442 may generate a notification occurring when the device 100 checks a makeup state, but a notification generated by the notification module 7442 is not limited thereto.

The notification module 7442 may output a notification signal in the form of a video signal via the display 7431 or may output a notification signal in the form of an audio signal via the audio output unit 7480, but the present disclosure is not limited thereto.

The application module 7443 may include various applications including the makeup mirror application described in the embodiments of the present disclosure.

The communication unit 7450 may include one or more elements for communication between the device 100 and at least one external device (e.g., the server 7202, the smart TV 7203, the smart watch 7204, the smart mirror 7205, and/or the IoT network-based device 7206). For example, the communication unit 7450 may include at least one of a short-range wireless communicator 7451, a mobile communicator 7452, and a broadcasting receiver 7453, but the elements included in the communication unit 7450 are not limited thereto.

The short-range wireless communicator 7451 may include, but is not limited to, a Bluetooth communication module, a Bluetooth low energy (BLE) communication module, a near field wireless communication module, a wireless local area network (WLAN) or Wi-Fi communication module, a ZigBee communication module, an Ant+ communication module, a Wi-Fi direct (WFD) communication module, a beacon communication module, or an ultra wideband (UWB) communication module. For example, the short-range wireless communicator 7451 may include an infrared data association (IrDA) communication module.

The mobile communicator 7452 may exchange a wireless signal with at least one of a base station, an external terminal, and a server on a mobile communication network. The wireless signal may include various types of data according to communication of a sound call signal, a video call signal, or a text/multimedia message.

The broadcasting receiver 7453 may receive a broadcast signal and/or information related to a broadcast from the outside through a broadcast channel. The broadcast channel may include, but is not limited to, a satellite channel, a ground wave channel, and a radio channel.

The communication unit 7450 may transmit at least one piece of information generated by the device 100 according to an embodiment of the present disclosure to at least one external device, or may receive information transmitted from the at least one external device.

The sensor unit 7460 may include a proximate sensor 7461 configured to detect an approach by a user, an illumination sensor 7462 (or a light sensor or an LED sensor) configured to detect lighting around the device 100, a microphone 7463 configured to recognize a voice of the user of the device 100, a moodscope sensor 7464 configured to detect a mood of the user of the device 100, a motion detecting sensor 7465 configured to detect an activity, a position sensor 7466 (e.g., a GPS receiver) configured to detect a position of the device 100, a gyroscope sensor 7467 configured to measure an azimuth angle of the device 100, an accelerometer sensor 7468 configured to measure a slope and acceleration of the device 100 with respect to a ground surface, and/or a geomagnetic sensor 7469 configured to determine orientation based on the Earth's magnetic field, but the present disclosure is not limited thereto.

For example, the sensor unit 7460 may include, but is not limited to, a temperature/humidity sensor, a gravity sensor, an altitude sensor, a chemical sensor (e.g., an odorant sensor, an air pressure sensor, a fine-dust measuring sensor, an ultraviolet sensor, an ozone-level sensor, a carbon dioxide (CO₂) sensor, and/or a network sensor (e.g., a network sensor based on Wi-Fi, Bluetooth, third-generation (3G), long term evolution (LTE), and/or near field communication (NFC)).

The sensor unit 7460 may include, but is not limited to, a pressure sensor (e.g., a touch sensor, a piezoelectric sensor, a physical sensor, and the like), a state sensor (e.g., an earphone terminal, a DMB antenna, a standard terminal (e.g., a terminal configured to detect whether charging is being processed, a terminal configured to detect whether a PC is connected, a terminal configured to detect whether a dock is connected, and the like)), a time sensor, and/or a health sensor (e.g., a biosensor, a heartbeat sensor, a blood flow sensor, a diabetes sensor, a pressure sensor, a stress sensor, and the like).

The microphone 7463 may receive an audio signal input from the outside of the device 100, may convert the received audio signal to an electric audio signal, and may transmit the electric audio signal to the controller 7420. The microphone 7463 may be configured to perform an operation based on various noise rejection algorithms so as to remove noise occurring while an external sound signal is input. The microphone 7463 may also be referred to as an audio input unit.

A result of detection by the sensor unit 7460 is transmitted to the controller 7420.

The controller 7420 may detect an illumination value based on a detection value received from the sensor unit 7460 (e.g., the illumination sensor 7462).

The controller 7420 may generally control all operations of the device 100. For example, the controller 7420 may control the sensor unit 7460, the memory 7440, the UI 7430, the image processor 7470, the audio output unit 7480, the camera 7490, and/or the communication unit 7450 by executing programs stored in the memory 7440.

The controller 7420 may operate in a same manner as the controller 7330 of FIG. 73. With respect to an operation of reading, by the controller 7330, data from the memory 7350, the controller 7420 may perform an operation of receiving data from an external device via the communication unit 7450. With respect to an operation of writing, by the controller 7330, data to the memory 7350, the controller 7420 may perform an operation of transmitting data to the external device via the communication unit 7450.

The controller 7420 may perform one or more operations described with reference to FIGS. 1A to 70. The controller 7420 may indicate a processor configured to perform the operations,

The image processor 7470 processes image data to be displayed on the display 7431, wherein the image data is received from the communication unit 7450 or is stored in the memory 7440.

The audio output unit 7480 may output audio data that is received from the communication unit 7450 or is stored in the memory 7440. The audio output unit 7480 may output a sound signal (e.g., notification sound) related to a function performed by the device 100. The audio output unit 7480 may output notification sound to notify the user about modification of makeup while the user is unaware of it.

The audio output unit 7480 may include, but is not limited to, a speaker, a buzzer, and the like.

The embodiments may be embodied as a recording medium, e.g., a program module to be executed in computers, which include computer-readable commands. The computer storage medium may include any usable medium that may be accessed by computers, volatile and non-volatile medium, and detachable and non-detachable medium. In addition, the computer storage medium includes all volatile and non-volatile media, and detachable and non-detachable media which are technically implemented to store information including computer readable commands, data structures, program modules or other data. The communication medium includes computer-readable commands, a data structure, a program module, other data as modulation-type data signals, such as carrier signals, or other transmission mechanism, and includes other information transmission mediums.

It should be understood that the embodiments described herein should be considered in a descriptive sense only and not for purposes of limitation. Descriptions of features or aspects within each embodiment should typically be considered as available for other similar features or aspects in other embodiments of the present disclosure. For example, configuring elements that are singular forms may be executed in a distributed fashion, and also, configuring elements that are distributed may be combined and then executed.

Certain aspects of the present disclosure can also be embodied as computer readable code on anon-transitory computer readable recording medium. A non-transitory computer readable recording medium is any data storage device that can store data which can be thereafter read by a computer system. Examples of the non-transitory computer readable recording medium include a Read-Only Memory (ROM), a Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A device providing a makeup mirror, the device comprising:
a display configured to display a face image of a user; and
a controller configured to:
display the face image of the user in real-time, and
execute the makeup mirror so as to display makeup guide information on the face image of the user, according to a makeup guide request.

2. The device of claim 1, wherein:
the display is further configured to display a plurality of virtual makeup images,
the device further comprises a user input unit configured to receive a user input for selecting one of the plurality of virtual makeup images,
the controller is further configured to display makeup guide information based on the selected virtual makeup image on the face image of the user, according to the user input, and
the plurality of virtual makeup images comprise at least one of color-based virtual makeup images and theme-based virtual makeup images.

3. The device of claim 1, wherein:
the display is further configured to display a plurality of pieces of theme information,
the device further comprises a user input unit configured to receive a user input for selecting one of the plurality of pieces of theme information, and
the controller is further configured to display makeup guide information based on the selected theme information on the face image of the user, according to the user input.

4. The device of claim 1, wherein:
the display is further configured to display bilateral-symmetry makeup guide information on the face image of the user, and
the controller is further configured to:
delete, when application of makeup to one side of a face of the user is started, makeup guide information displayed on the other side in the face image of the user,
detect, when the application of the makeup to the one side of the face of the user is completed, a makeup result with respect to the one side of the face of the user, and
display makeup guide information based on the makeup result on the other side in the face image of the user.

5. The device of claim 1, wherein the controller is further configured to:
detect an area of interest from the face image of the user, and
automatically magnify the area of interest and display the magnified area of interest on the display.

6. The device of claim 1, wherein the controller is further configured to:
detect a cover-target area from the face image of the user, and
display makeup guide information for the cover-target area on the face image of the user.

7. The device of claim 1, wherein the controller is further configured to:
detect an illuminance value, and
display, when the illuminance value is determined to be low illuminance, edge areas of the display, as a white level.

8. The device of claim 1, further comprising a user input unit configured to receive a comparison image request requesting comparison between a before-makeup face image of the user and a current face image of the user,
wherein the controller is further configured to display the before-makeup face image of the user and the current face image of the user in a comparison form on the display, according to the comparison image request.

9. The device of claim 1, further comprising a user input unit configured to receive a user input of a skin analysis request,
wherein the controller is further configured to:
analyze skin based on a current face image of the user, according to the user input,
compare a skin analysis result based on a before-makeup face image of the user with a skin analysis result based on the current face image of the user, and
display a result of the comparison on the display.

10. The device of claim 1, further comprising a camera configured to capture the face image of the user,
wherein the controller is further configured to:
periodically obtain a face image of the user by using the camera,
check a makeup state with respect to the obtained face image of the user, and
provide notification to the user via the display when the controller determines that the notification is required as a result of the checking.

11. The device of claim 1, further comprising a user input unit configured to receive a user input for selecting a makeup tool,
wherein the controller is further configured to:
determine the makeup tool, according to the user input, and
display, on the face image of the user, makeup guide information based on the makeup tool.

12. The device of claim 1, further comprising a user input unit configured to receive a user input indicating a blemish detection level or a beauty face level,
wherein, when the user input indicates the blemish detection level, the controller is further configured to emphasize and display, by controlling the display, blemishes detected from the face image of the user according to the blemish detection level, and
when the user input indicates the beauty face level, the controller is further configured to blur and display, by controlling the display, the blemishes detected from the face image of the user according to the beauty face level.

13. The device of claim 1,
wherein the display is further configured to be controlled by the controller so as to display a skin analysis window on an area of the face image of the user,
wherein the controller is further configured to:
control the display to display the skin analysis window on the area, according to a user input,
analyze the skin condition of the area comprised in the skin analysis window, and
display the result of the analysis on the skin analysis window, and wherein the skin analysis window comprises a magnification window.

14. A method, performed by a device, of providing a makeup mirror, the method comprising:
displaying in real-time a face image of a user on a display of the device;
receiving a user input for requesting a makeup guide; and
displaying makeup guide information on the face image of the user, according to the user input.

15. The method of claim 14, further comprising:
recommending a plurality of virtual makeup images based on the face image of the user;
receiving a user input for selecting one of the plurality of virtual makeup images; and
displaying, on the face image of the user, makeup guide information based on the selected virtual makeup image, according to the user input for selecting the virtual makeup image,
wherein the plurality of virtual makeup images comprise at least one of color-based virtual makeup images and theme-based virtual makeup images.

16. The method of claim 14, further comprising:
displaying a plurality of pieces of theme information on the device;
receiving a user input for selecting one of the plurality of pieces of theme information; and
displaying, on the face image of the user, makeup guide information based on the theme information selected according to the user input for selecting the theme information,

17. The method of claim 14, further comprising:
displaying bilateral-symmetry makeup guide information on the face image of the user;
deleting, when application of makeup to one side of a face of the user is started, makeup guide information displayed on the other side in the face image of the user;
detecting, when the application of the makeup to the one side of the face of the user is completed, a makeup result with respect to the one side of the face of the user; and
displaying makeup guide information based on the makeup result on the other side in the face image of the user,

18. The method of claim 14, further comprising:
detecting an area of interest from the face image of the user, and
automatically magnifying the area of interest and displaying the magnified area of interest on the display.

19. The method of claim 14, further comprising:
detecting a cover-target area from the face image of the user; and
displaying makeup guide information for the cover-target area on the face image of the user.

20. At least one non-transitory computer-readable recording medium having recorded thereon a program for executing the method of claim 14, by using a computer.
